(19) United States
(12) Patent Application Publication
(10) Pub. No.: US 2004/0002856 A1
(43) Pub. Date: Jan. 1, 2004

(54) Multi-rate frequency domain interpolative speech CODEC system

(76) Inventors: Udaya Bhaskar, North Potomac, MD (US); Kumar Swaminathan, North Potomac, MD (US)

Correspondence Address: Hughes Electronics Corporation, Patent Docket Administration, Bldg. 1, Mail Stop A109, P.O. Box 956, El Segundo, CA, 90245-0956, US

(21) Appl. No.: 10/382,202

(22) Filed: Mar. 5, 2003

Related U.S. Application Data
(60) Provisional application No. 60/362,706, filed on Mar. 8, 2002.

(51) Int. Cl. G10L 19/04

(52) U.S. Cl. 704/219

(57) ABSTRACT

A low bit rate voice codec based on Frequency Domain Interpolation (FDI) technology is designed to operate at multiple rates of 4.0, 2.4, and 1.2 Kbps. At 4 Kbps, the codec uses a 20 ms frame size and a 20 ms lookahead for purposes of voice activity detection (VAD), noise reduction, linear prediction (LP) analysis, and open loop pitch analysis. The LP parameters are encoded using backward predictive hybrid scalar-vector quantizers in the line spectral frequency (LSF) domain after adaptive bandwidth broadening to minimize excessive peakiness in the LP spectrum. Prototype Waveforms (PW) are extracted every subframe or 2.5 ms from the LP residual and subsequently aligned and normalized. The PW gains are encoded separately using a backward predictive vector quantizer (VQ). The normalized and aligned PWs are separated into a magnitude component and a phase component. The phase component is encoded implicitly using PW correlations and a voicing measure which are jointly quantized using a VQ. The magnitude component is encoded using a switched (based on voicing measure) backward predictive VQ. At the decoder, a phase model is used to synthesize the phase component from the received PW correlations and voicing measure. The phase component is generated based on a first order vector autoregressive model in which each PW vector is generated by summing the previous PW vector weighted by the decoded PW correlation coefficient with a weighted combination of a fixed and random phase components. The use of the PW correlations in this manner results in a sequence of PWs that exhibit the correlation characteristics measured at the encoder. The fixed phase component, obtained from a pitch pulse waveform, provides glottal pulse like characteristics to the resulting phase during voiced segments. Addition of the random phase component provides a means of inserting a controlled degree of variation in the PW sequence across frequency as well as across time. The phase of the resulting PW sequence is then combined with the decoded PW magnitude and scaled by the decoded PW gains to reconstruct the PWs at all the subframes. The LP residual is then synthesized from these PWs using an interpolative synthesis procedure. Speech is then obtained as the output of the decoded LP synthesis filter driven by the LP residual. The synthesized speech is postfiltered using a pole-zero filter followed by tilt correction and energy normalization. At 2.4 Kbps, the same frame size of 20 ms and a lookahead of 20 ms for VAD, noise reduction, LP analysis, and pitch estimation are utilized. However, the LP parameters are encoded using a 3-stage 21 bit VQ with backward prediction. Furthermore, for encoding the PW parameters an additional 20 ms of lookahead is employed to smooth the PW gains, correlations, voicing measure, and magnitude spectra so that they can be encoded using fewer bits. The 1.2 Kbps FDI codec is similar to the 2.4 Kbps FDI codec except that a 40 ms frame size is employed instead of the 20 ms frame size with the result that all parameters are updated half as often as the 2.4 Kbps FDI codec.

### PRIORITY

This application claims benefit under 35 U.S.C. §119(e) from U.S. Provisional Patent Application Serial No. 60/362,706, entitled “A 1.2/2.4 KBPs Voice CODEC Based On Frequency Domain Interpolation (FDI) Technology”, filed on Mar. 8, 2002, the entire contents of which is incorporated herein by reference.

Related material may also be found in U.S. NonProvisional patent application Ser. No. 10/073,128, entitled “Prototype Waveform Magnitude Quantization For A Frequency Domain Interpolative Speech CODEC”, filed on Aug. 23, 2002, the entire contents of which is incorporated herein by reference.

### BACKGROUND OF THE INVENTION

1. Field of the Invention

The present invention relates to a method and system for coding speech for a communications system at multiple low bit rates, e.g., 1.2 Kbps, 2.4 Kbps, and 4.0 Kbps. More particularly, the present invention relates to a method and apparatus for encoding perceptually important information about the evolving spectral characteristics of the speech prediction residual signal, known as prototype waveform (PW) representation. This invention proposes novel techniques for representing, the quantizing, encoding, and synthesizing of the information inherent in the prototype waveforms. These techniques are applicable to low bit rate speech codec systems operating in the range of 1.2 Kbps to 4.0 Kbps.

2. Description of the Related Art

Currently, there are various speech compression techniques used in low bit-rate speech codec systems. Descriptions of prior art techniques can be found, but are not limited to, in the following representative references e.g., L. R. Rabiner and R. W. Schafer, “Digital Processing of Speech Signals” Prentice-Hall 1978 (hereinafter known as reference 1), W. B. Klejin and J. Haagen, “Waveform Interpolation for Coding and Synthesis”, in Speech Coding and Synthesis, Edited by W. B. Klejin, K. K. Paliwal, Elsevier, 1995 (hereinafter known as reference 2); F. Iatakura, “Line Spectral Representation of Linear Predictive Coefficients of Speech Signals”, Journal of Acoustical Society of America, vol4. 57, no. 1, 1975 (hereinafter known as reference 3); P. Kabal and R. P. Ramachandran, “The Computation of Line Spectral Frequencies Using Chebyshev Polynomials”, IEEE Trans. On ASSP, vol. 34, no. 6, pp. 1419-1426, December 1986 (hereinafter known as reference 4); W. B. Klejin, “Encoding Speech Using Prototype Waveforms” IEEE Transactions on Speech and Audio Processing, Vol. 1, No. 4, 386-399, 1993 (hereinafter known as reference 5); W. B. Kleijn, Y. Shoman, D. Sen and R. Hagen, “A Low Complexity Waveform Interpolation Coder”, IEEE International Conference on Acoustics, Speech and Signal Processing, 1996 (hereinafter known as reference 6); J. Haagen and W. B. Kleijn, “Waveform Interpolation”, in Modern Methods of Speech Processing, Edited by R. P. Ramachandran and R. Mammone, Kluwer Academic Publishers, 1995 (hereinafter reference 7); Y. Shoham, “Very Low Complexity Interpolative Speech Coding at 1.2 to 2.4 kbps”, IEEE International Conference on Acoustics, Speech and Signal Processing, 1997 (hereinafter reference 8); Digital Signal Processing, A. V. Oppenheim and R. W. Schafer, Prentice-Hall 1975 (hereinafter reference 9); P. LeBlanc, B. Bhattacharya, S. A. Mahmoud, V. Cuperman, “Efficient Search and Design Procedures for Robust Multi-Stage VQ of LPC parameters for 4 kbit/s Speech Coding,” IEEE Transactions on Speech and Audio Processing, Vol. 1. No. 4, October 1993 (hereinafter reference 10); Digital Coding of Waveforms, N. S. Jayant and Peter Noll, Prentice-Hall 1984 (hereinafter reference 11); J. H. Chen and A. Gersho, “Adaptive Postfiltering for Quality Enhancement of Coded Speech”, IEEE Transactions on Speech and Audio Processing, Vol. 3, No. 1, pp. 59-71, January 1995 (hereinafter reference 12); F.Basbug, S.Nandkumar, and K.Swamianthan, “Robust Voice Activity Detection for DTX Operation of Speech Coders”, IEEE Speech Coding Workshop, Finland, June 1999 (hereinafter reference 13); TDMA Cellular/PCS Radio interface—Minimum Objective Standards for IS-136B, DTX/CNG Voice Activity Detection (hereinafter reference 14); B. S.Atal and M. R.Scroeder, “Stochastic Coding of Signals at very low bit rates”, Proc. ICC, pp. 1610-1613, 1984 (hereinafter reference 15); C.Laflamme, J. P. Adoul. H. Y.Su, and S.Morissette, “On reducing computational complexity of codebook search in CELP coder through the use of algebraic codes”, Proc. ICASSP, pp. 177-180, 1990 (hereinafter reference 16); W. B.Kleijn, R. P.Ramachanndran, and P.Kroon, “Generalized Analysis-by-Synthesis Coding and its application to pitch prediction”, Proc. ICASSP, pp. 1337-1340, 1992 (hereinafter reference 17); K.Swaminathan, S.Nandkumar, U.Bhaskar, N.Kowalski, S.Patel, G.Zakaria, J.Li and V.Prasad, “A Robust Low Rate Voice Codec for Wireless Communications,” Proc. IEEE Speech Coding Workshop, pp. 75-76, 1997 (hereinafter reference 18); R.McCaulay and T.Quateri, “Low Rate Speech Coding based on the Sinusoidal Model”, Advances in Speech Signal Processing, S.Furui and M. M.Sondhi, Eds. New York, Marcel Dekker, 1992, chapter 6, pp. 165-207 (hereinafter reference 19); D.Griffin and J.Lim, “Multiband Excitation Vocoder’, IEEE Transactions on Acoustics, Speech, Signal Processing, vol. ASSP-36, no. 8, pp. 1223, August 1988 (hereinafter reference 20). All of the references 1 through 20 are herein incorporated in their entirety by reference.

High quality compression of telephony speech at 4 kbps and lower rates remains a challenging problem. Codecs based on Code Excited Linear Prediction (CELP) (see reference 15) have been successful in achieving toll quality speech at rates near or above 8 kbps. Indeed many of the cellular/PCS speech coding standards today are based on a variation called ACELP (Algebraic Code Excited Linear Prediction) (described in reference 16) where the codebook employed to encode the LP residual after the pitch redundancies have been removed has a well-defined algebraic structure. The ITU-T G.729 standard at 8 kbps is also based on ACELP. In order to continue to achieve high quality of speech at rates lower than 8 kbps, several approaches have been reported in the literature. Generalized analysis by synthesis or RCELP (Relaxation Code Excited Linear Prediction) (reference 17), MM-CELP or Multi-mode CELP (reference 18) are examples of these approaches. Such approaches typically reduce the bit rate needed to encode the LP or pitch related parameters by advanced modeling, quantization, or dynamic bit allocation so that the LP residual after removing pitch redundancies can still be coded using a high bit rate. This permits a high quality of speech at bit rates as low as 4.8 kbps but at lower rates and in particular at 4 kbps and below, the performance of CELP based coders deteriorate. This deterioration is due to the bit rate that can be allocated to encoding the linear prediction (LP) residual signal after removing pitch redundancies shrinks to a point where a large sub-frame size or a small fixed codebook size becomes necessary. Either way, this proves to be inadequate to capture all the perceptually significant characteristics of the residual signal resulting in a poor speech quality. In particular, the quality of the speech suffers in the presence of background noise.

An alternative technique that positioned itself as a promising alternative to CELP below 4.8 kbps was the PWI (Prototype Waveform Interpolation) method (see references 2, 5, and 7). In this approach, a perceptually accurate speech signal is reconstructed by interpolating prototype pitch waveforms between updates. The prototype waveform (PW) is decomposed into a SEW (Slowly Evolving Waveform) and a REW (Rapidly Evolving Waveform). The SEW dominates during voiced speech while the REW dominates during unvoiced speech. Both have very different requirements for perceptually accurate quantization. The SEW requires more precision but a slower update while the REW requires a faster update but much coarser quantization. By exploiting these different requirements, the PWI based coder is able to encode the prototype waveform using few bits. Despite its ability to reproduce high quality speech at low bit rates, PWI based codecs have a high complexity as well as a high delay associated with them. The high delay is not only due to the look ahead needed for the linear prediction and open loop pitch analysis but also due to the linear phase FIR filtering needed for the separation of the PW into SEW and REW. The high complexity is a result of many factors such as the high-precision alignment of PWs that is needed prior to filtering as well as the filtering itself. Separate quantization and synthesis of the SEW and REW waveforms also contribute to the overall high complexity. Low complexity PWI based codecs have been reported in references 6 and 8 but typically these codecs aim for a very modest performance (close to US Federal Standard FS1016 quality).

Another approach that has been used extensively at low rates is based on Sinusoidal Transform Coding (STC) (described in reference 19), which represents the voice signal as a sum of a number of sinusoids with time-varying amplitudes, frequencies and phases. At low bit rates, the frequencies of the sinusoids are constrained to be harmonically related to a pitch frequency. Phases of the sinusoids are not coded explicitly, but are generated using a phase model at the decoder. The amplitudes of the sinusoids are encoded using a parametric approach (for e.g., melcepstral coefficients). The pitch frequency, amplitudes of the sinusoids, a voiced/unvoiced decision and signal power comprise the transmitted parameters in this approach. In contrast to PWI based techniques, the STC model does not directly address the frequency dependency of the periodicity of the signal or its time variations. Multiband excitation (MBE) technique (reference 20), which is a derivative of the STC, employs a multi-band voicing decision to achieve a degree of frequency dependent periodicity. However, this is also based on a binary voicing decision in multiple frequency bands. In contrast, PWI provides a framework for a non-binary description of periodicity across the frequency and its evolution across time.

However, the prior art approaches have several weaknesses. First, the decomposition into SEW and REW, requires filtering which increases both the delay and computational complexity. Second, in the case of PWI, the PW magnitude can be preserved only by encoding the magnitudes and phases of both SEW and REW accurately. Third, in the case of PWI the evolutionary and periodicity characteristics depend on the ratio of REW to SEW magnitude components but also on their phase coherence which makes it much harder to preserve them. None of the prior art have been able to achieve a scaleable compression technology that is capable of delivering high quality voice at low bit rates with areasonable complexity and delay.

### SUMMARY OF THE INVENTION

The present invention relates to an approach to achieving high voice quality at low bit rates referred to as Frequency Domain Interpolative or FDI method. As in PWI methods, a PW is extracted at regular intervals of time at the encoder. However, unlike PWI methods, there is no separation of PW's into SEW and REW. This computationally complex and delay intensive operation is avoided. Instead, the gain-normalized PW's are directly quantized in magnitude-phase form. The PW magnitude is quantized explicitly using a switched backward adaptive VQ of its mean-deviation approximation in multiple bands. The phase information is coded implicitly by a VQ of a composite vector of PW correlations in multiple bands and an overall voicing measure. The PW gains are encoded separately using a backward adaptive VQ while the spectral envelope is encoded using LP modeling and vector quantization in the LSF (line spectral frequency) domain. At the decoder, the PW's are reconstructed using a phase model that uses the received phase information to reproduce PW's with the correct periodicity and evolutionary characteristics. The LP residual is synthesized by interpolating the reconstructed and gain adjusted PW's between updates which is subsequently used to derive speech using the LP synthesis filter. Global pole-zero postfiltering with tilt correction and energy normalization is also employed.

One of the novel aspects of the present invention relates to the representation and quantization of the PW phase information at the encoder. At the FDI encoder, a sequence of aligned and normalized PW vectors for each frame is computed using a low complexity alignment process. The average correlation of each PW harmonic across this sequence is then computed which is then used to derive a 5-dimensional PW correlation vector across five subbands by averaging the correlation across all harmonics in each subband. High values of the correlation indicates that the adjacent PW vectors are quite similar to each other, corresponding to a predominantly periodic signal or stationary PW sequence. On the other hand, lower correlation values indicate that there is a significant amount of variation in adjacent vectors in the PW sequence, corresponding to a predominantly aperiodic signal or nonstationary PW sequence. Intermediate values indicate different degrees of stationarity or periodicity of the PW sequence. Thus this information in the form of the PW subband vector can be used at the FDI decoder to provide the correct degree of variation from one PW to the next, as a function of frequency and thereby realize the correct degree of periodicity in the signal. In addition to the PW correlation subband vector, a voicing measure that characterizes a degree of voicing and periodicity for that frame is used to supplement the PW phase representation. The composite 6-dimensional vector comprising of the 5-dimensional PW subband correlation vector and the voicing measure comprises the total representation of the PW phase information and is quantized using a spectrally weighted VQ method. The weights used in this quantization procedure for each of the subbands are drawn from the LP parameters while the weight used for the voicing measure is both a function of LP parameters as well as the voicing classification.

A related novel aspect of the present invention is the synthesis of PW phase at the decoder from the received phase information. A PW phase model is used for this purpose. The phase model comprises of a source model that drives a first-order autoregressive filter so as to synthesize the PW phase at every sub-frame using the received voicing measure, PW subband correlation vector, and pitch frequency contour information. The source model comprises of a weighted combination of a random phase vector and a fixed phase vector. The fixed phase vector is obtained by oversampling a phase spectrum of a voiced pitch pulse.

A second novel aspect of the present invention is the quantization of the PW magnitude information. The PW magnitude vector is quantized in a heirarchial fashion using a means-deviation approach. While this approach is common to both voiced and unvoiced frames, the specific quantization codebooks and search procedure do depend on the voicing classification. In this approach, the mean component of the PW magnitude vector is represented in multiple subbands and it is quantized using an adaptive VQ technique. A variable dimensional deviations vector is derived for all harmonics as the difference between the input PW magnitude vector and the full band representation of the quantized PW subband mean vector. From the variable dimensional deviations vector, a fixed dimensional deviations subvector is selected based on location of formant frequencies at that subframe. The fixed dimensional deviations subvector is subsequently quantized using adaptive VQ techniques. At the decoder, the PW magnitude vector is reconstructed as the sum of the full band representation of the received PW subband mean vector and the received fixed dimensional deviations subvector that represent deviations at the selected harmonics.

Extension of the operational range of the FDI codec to 2.4 and 1.2 Kbps by additional pre-processing of the PW parameters prior to quantization is another important novel aspect of the present invention. This pre-processing exploits the additional look-ahead made available at these lower bit rates to smooth the PW parameters so that they can be more effectively quantized using fewer bits.

Other novel aspects of the FDI codec include efficient quantization using adaptive VQ of the PW gains; adaptive bandwidth broadening of the LP parameters both at the encoder based on a peak-to-average ratio of the LP spectrum for purposes of eliminating tonal distortions; post-processing at the decoder that involves adaptive bandwidth broadening and adaptive out-of-band frequency attenuation using a measure of VAD likelihood for purposes of enhancement of background noise.

In summary, the present invention has several advantages compared to the prior art. All the weaknesses of the prior art are addressed. First, by avoiding the decomposition into SEW and REW, the necessity of filtering that increases both the delay and computational complexity is eliminated. Second, the PW magnitude is preserved accurately by quantizing and encoding it directly. In the case of PWI, the PW magnitude can be preserved only by by encoding the magnitudes and phases of both SEW and REW accurately. Third, the evolutionary and periodicity characteristics of the PW's is preserved directly using a phase model and the way the phase information is represented. In the PWI methods, these characteristics not only depend on the ratio of REW to SEW magnitude components but also on their phase coherence making it much harder to preserve them. For these reasons, the present invention delivers high quality speech at low bit-rates such as 4.0, 2.4, and 1.2 Kbps at reasonable cost and delay.

### BRIEF DESCRIPTION OF THE DRAWINGS

The various objects, advantages and novel features of the present invention will be more readily understood from the following detailed description when read in conjunction with the appended drawings, in which:

FIG. 1 is a high level block diagram of an example of a coder/decoder (CODEC) 100 in accordance with an embodiment of the present invention;

FIG. 2 is a detailed block diagram of an example of an encoder in accordance with an embodiment of the present invention;

FIG. 3 is a block diagram of frame structures for use with the CODEC of FIG. 1 operating at 4.0 Kbps in accordance with an embodiment of the present invention;

FIG. 4 is a flowchart illustrating an example of steps for performing scale factor updates in the noise reduction module in accordance with an embodiment of the present invention;

FIG. 5 is a flowchart illustrating an example of steps for performing tone detection in accordance with an embodiment of the present invention;

FIG. 6 is a flowchart illustrating an example of steps for enforcing monotonic PW correlation vector in accordance with an embodiment of the present invention;

FIG. 7 is a block diagram illustrating an example of a decoder operating in accordance with an embodiment of the present invention;

FIG. 8 is a flowchart illustrating an example of steps for computing gain averages in accordance with an embodiment of the present invention;

FIG. 9 is a diagram illustrating a diagram of an example of a model for construction of a PW Phase in accordance with an embodiment of the present invention;

FIG. 10 is a flowchart illustrating an example of steps for computing parameters for out of attenuation and bandwidth broadening in accordance with an embodiment of the present invention;

FIG. 11 is a diagram illustrating an example of a frame structure for various encoder functions for operation at 2.4 Kbps in accordance with an embodiment of the present invention; and

FIG. 12 is a diagram illustrating another example of a frame structure for various encoder functions for operation at 1.2 Kbps in accordance with an embodiment of the present invention.

Throughout the drawing figures, like reference numerals will be understood to refer to like parts and components.

### DETAILED DESCRIPTION OF THE PREFERRED EMBODIMENTS

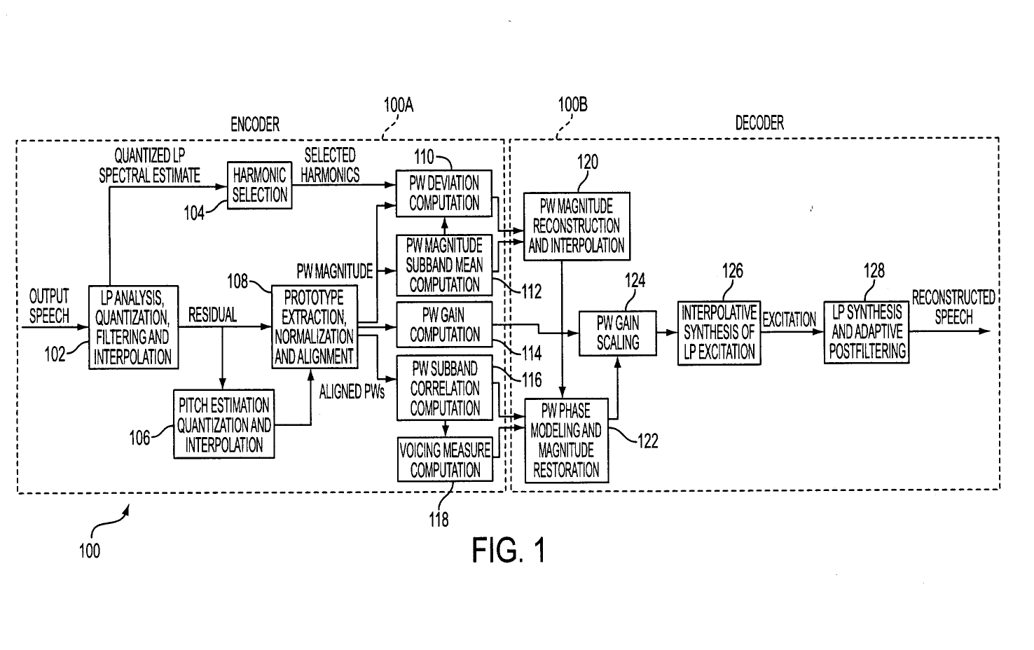

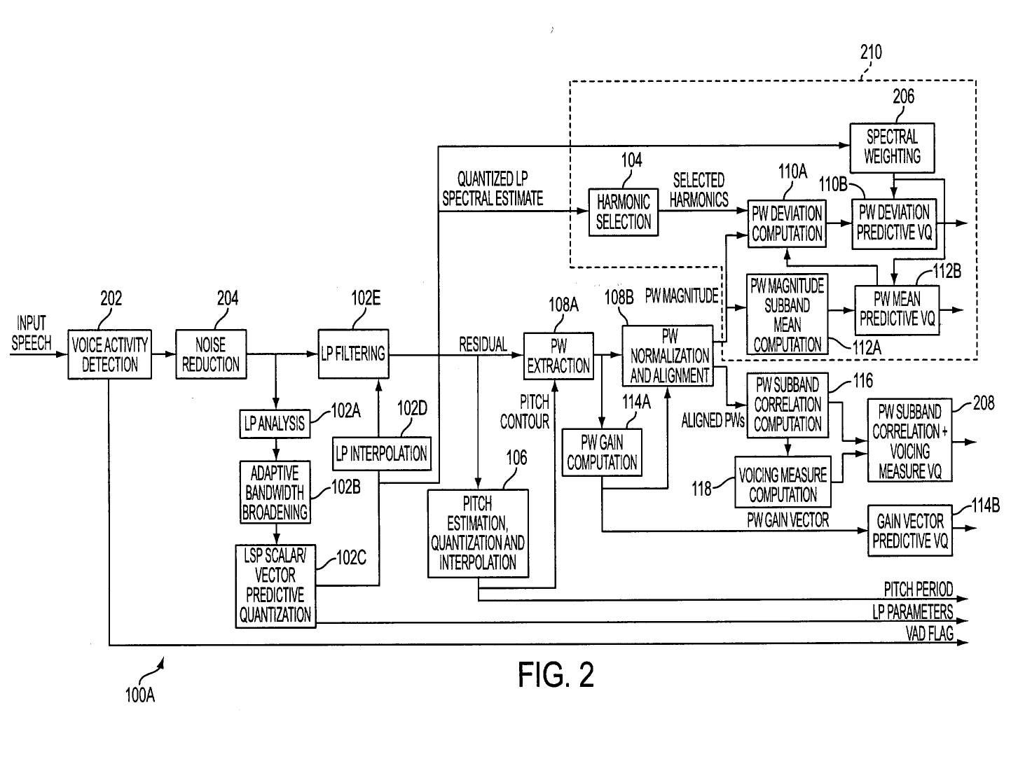

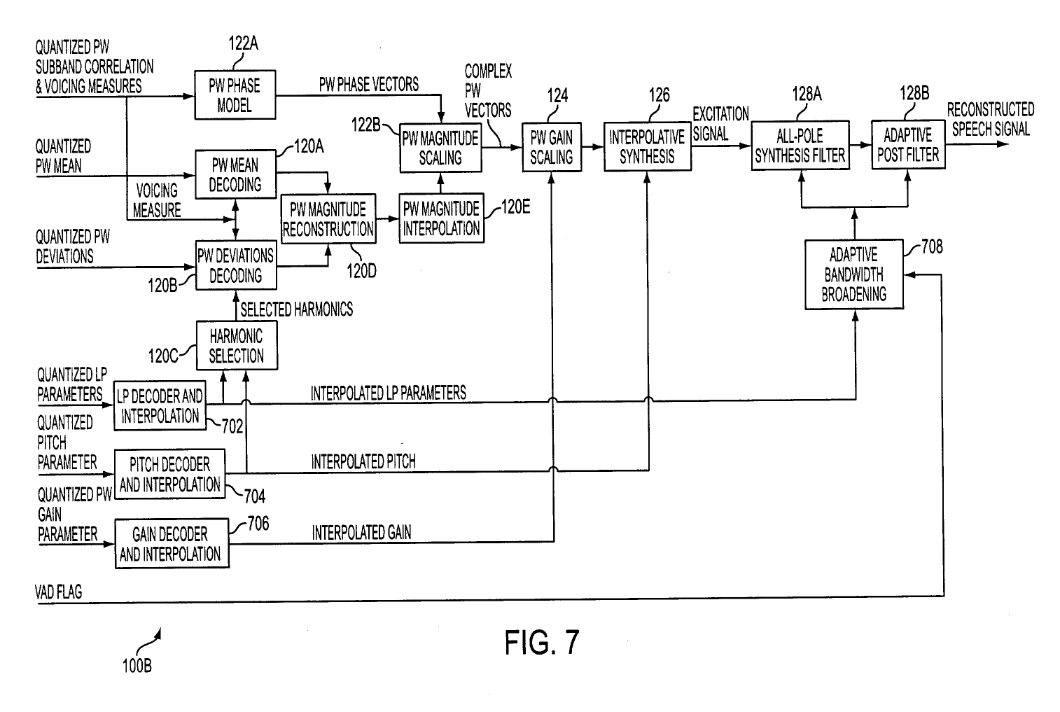

FIG. 1 is a high level block diagram of an example of a coder/decoder (CODEC) 100 in accordance with an embodiment of the present invention. The codec 100 is preferably a Frequency Domain Interpolative (FDI) codec and comprises an encoder portion 100A and a decoder portion 100B. In addition the codec 100 can operate at 4.0 kbps, 2.4 kbps and 1.2 kbps. Encoder portion 100A includes LP Analysis, Quantization, Filtering and Interpolation module 102, harmonic selection module 104, Pitch Estimation, Quantization and Interpolation module 106, Prototype Extraction, Normalization and Alignment module 108, PW Deviation Computation module 110, PW Magnitude Subband Mean Computation module 112, PW Gain computation module 114, PW Subband Correlation Computation module 116, Voicing Measure Computation module 118. Decoder portion 100B includes PW magnitude Reconstruction and Interpolation module 120, PW Phase Modeling and Magnitude Restoration module 122, PW Gain Scaling module 124, Interpolative Synthesis of LP Excitation module 126, LP Synthesis and Adaptive Postfiltering module 128. Codec 100 will be described in detail with reference to FIGS. 2 and 7.

The codec 100 uses a FDI speech compression coding algorithm technology that was developed to meet the telephony voice compression requirements of mobile satellite and VSAT telephony. It should be appreciated by those skilled in the art that the codec 100 is not limited to the fields of mobile satellite and VSAT telephony.

The codec 100 uses linear predictive (LP) analysis, robust pitch estimation and frequency domain encoding of the LP residual signal. The codec 100 preferably operates on a frame size of 20 ms. Every 20 ms, the speech encoder 100A produces 80 bits representing compressed speech. The speech decoder 100B receives the 80 compressed speech bits and reconstructs a 20 ms frame of speech signal. The encoder 100A uses a look ahead buffer of about 20 ms, which results in an algorithmic delay, e.g., buffering delay+look ahead delay, of about 40 ms.

The invention will now be discussed with reference to FIG. 2 which is a detailed block diagram of an example of an encoder 100A in accordance with an embodiment of the present invention. The encoder 100A comprises a voice activity detection module 202, a noise reduction module 204, a LP analysis module 102A, an adaptive bandwidth broadening module 102B, a LSP scalar/vector predictive quantization module 102C, a LP interpolation module 102D, a LP filtering module 102E, a pitch estimation, quantization and interpolation module 106, a PW extraction module 108A, a PW normalization and alignment module 108B, a PW gain computation module 114A, a gain vector predictive VQ module 114B, a PW subband correlation computation 116, a voicing measure computation module 118, a PW subband correlation+voicing measure vector quantizer (VQ) module 208, a magnitude quantizer 210 including a harmonic selection 104, PW deviation computation module 110A, PW deviation predictive VQ module 110B, PW magnitude subband mean computation 112A, PW mean predictive VQ 112B, and a spectral weighting module 206.

The input speech is initially processed by the voice activity detection module 202 to determine whether the input signal is active or not e.g., speech or silence/background noise. The voice activity detection module 202 accounts for pauses in speech and serves many functions, e.g., noise reduction and discontinuous mode transmission (DTX). In one embodiment of the invention, the noise reduction module 204 is in a powered mode of operation. When the noise reduction module 204 is powered, it reduces the noise floor of the detected speech signal and provides a speech signal that has a greatly reduced noise level which is required for enhanced speech clarity. The benefits of the noise reduction are minimal when the noise is very low or when the noise is very high. When the noise is very low, the speech signal has sufficient clarity and so the noise reduction provides little additional benefit. However, it can cause no harm either. When the noise is very high it is difficult to distinguish between the noise and the speech signal and this would cause the noise reduction to introduce many distortions in the speech. Thus, in this case, not only is there no benefit to employing noise reduction but significant harm can be caused by its use. In this case, an alternative embodiment of the invention, where the noise reduction module 204 is in a non-powered mode of operation, is more suitable. Therefore, the noise reduction module 204 is made adaptive to the noise level relative to the speech so as to be able to realize the benefits of the noise reduction while minimizing any damage by way of speech distortions.

The noise reduction module provides the noise reduced speech to the LP Analysis module 102A. The LP Analysis module 102A determines the spectrum analysis of a short segment of the noise reduced speech and provides the LP analyzed speech signal to the Adaptive Bandwidth Broadening module 102B. The Adaptive Bandwidth Broadening module 102B determines the peakiness of the short term speech spectrum. If the spectrum is very peaky in conventional systems, which employ a fixed degree of bandwidth broadening, there can be an underestimation in the bandwidth of the formants or vocal tract resonances in the spectrum. The greater the spectral peakiness of a signal, the more bandwidth broadening is required. The Adaptive Bandwidth Broadening module 102B determines the degree of peakiness by sampling the signal spectrum at a number of equally spaced frequencies. Previously, for example, bandwidth broadening is performed based on sampling at every pitch harmonic frequency. However, when the pitch frequency is high, the spectrum is not sampled enough. Therefore, in the present invention, when the pitch frequency is high, the spectrum is sampled a number of times for each pitch frequency. A mechanism is in place to ensure that the spectrum is never under-sampled for each pitch frequency. In an embodiment of the invention, the number of harmonics in a noise reduced speech signal is determined. If the number of harmonics is below a first threshold value, the number of harmonics available is doubled. If the number of harmonics is below a second threshold value, the number of available harmonics in the noise reduced speech is tripled. This insures that the number of samples taken to sample the full spectrum is adequate to provide an accurate representation of the peakiness of the spectrum.

The Adaptive Bandwidth Broadening module 102B provides the bandwidth broadened spectrum to the LSP Scalar/Vector Predictive Quantization module 102C, which quantizes the first six LSF's individually and the last four LSF's jointly. The quantized LSFs are interpolated with every subframe via the LP Interpolation module 102D. The interpolated LSFs are filtered via the LP Filtering module 102E. The LP Filtering module 102E provides a residual signal from the noise reduced and interpolated signal.

The residual signal is provided to the Pitch Estimation, Quantization and Interpolation module 106 and to the PW Extraction module 108A. The Pitch Estimation, Quantization and Interpolation module 106 provides a pitch estimate from the residual signal. The estimated pitch is quantized at the Pitch Estimation, Quantization and Interpolation module 106. The quantized pitch frequency estimate is then interpolated across the frame. For every sample, an interpolated pitch frequency is provided. The interpolated pitch estimate provides a pitch contour. The pitch contour represents the pitch frequency as a function of time across the frame. The Pitch Estimation, Quantization and Interpolation module 106 provides the pitch contour value to PW Extraction module 108A at several equal intervals within the frame, preferably every 2.5 ms. These sub-intervals within the frame are called sub-frames.

The PW Extraction module 108A extracts a prototype waveform from the residual signal and the pitch contour signal for every sub-frame. The extracted PW signal is transformed into the frequency domain by a DFT operation. The extracted frequency domain PW signal is provided to the PW Normalization and Alignment module 108B and the PW Gain Computation module 114A. The PW Gain Computation module 114 computes a PW gain from the extracted PW signal and provides the computed PW gain to the PW Normalization and Alignment module 108B. The PW Normalization and Alignment module 108B normalizes the PW signal using the computed PW gain signal and subsequently aligns the normalized PW signal against the aligned PW signal of the preceding sub-frame. The alignment is necessary for deriving a PW correlation between successive PW waveforms, averaged over time across the frame.

The normalized and aligned PW provides a PW magnitude portion which is represented as a mean plus harmonic deviations from the mean in multiple subbands. The PW subband means are quantized using a predictive vector quantizer. The harmonic deviations from the mean are quantized in a selective fashion. This is because not all harmonic deviations are of equal perceptual importance. The selection of the perceptually most important harmonics is the function of the Harmonic Selection module 104.

The Harmonic Selection module 104 selects a subset of pitch harmonic frequencies based on the quantized LP spectral estimate provided by the LSP Scalar/Vector Predictive Quantization module 102C. Rather than using simplistic approaches e.g., selecting the first ten harmonics of the signal, the harmonics are instead selected based on the linear prediction frequency response of the noise reduced speech signal. The harmonics are preferably selected from the area where the high energy of the noise reduced signal is located, e.g. from speech formant regions within the 0-3 kHz band. The PW harmonic deviations for the selected harmonics for the PW magnitude signal are computed via the PW Deviation Computation module 110A. These deviations are computed at the selected harmonics by subtracting the quantized PW Magnitude Subband Mean Approximation available from 112B from the PW Magnitude signal available from the PW Normalization and Alignment Module 108B. The PW Deviation Predictive VQ module 110B is used to quantize the PW deviations. The VQ search is performed using a distortion metric which requires spectral weighting which is provided by Spectral Weighting module 206. The PW Mean Predictive VQ module 112B receives a spectral weighting signal from Spectral Weighting module 206 and a PW magnitude subband mean value from the Magnitude Subband Mean Computation module 112A. The PW Mean Predictive VQ module 112B provides a predictively quantized PW mean signal.

The PW Subband Correlation Computation module 116, receives the aligned PWs from the PW Normalization and Alignment module 108B. The average correlation of the successive aligned PWs is computed for each PW harmonic across the entire frequency band. This is then averaged across multiple subbands to result in a vector of subband correlations The vector is preferably a five dimensional vector corresponding to the 5 bands 0-400 Hz, 400-800 Hz, 800-1200 Hz, 1200-2000 Hz, and 2000-3000 Hz.

The Voicing Measure Computation module 118 computes an overall voicing measure for the whole frame. The voicing measure is a measure of periodicity in a frame. For example, the voicing measure can be a number between zero and one where zero means the signal is extremely periodic and one means the signal does not contain much periodicity. The voicing measure is based on several signal parameters such as the pitch gain, PW correlation, the LP spectral tilt, signal energy, and the like. The voicing measure also provides an indication of how much the vocal chords are involved in producing speech. The greater the involvement of the vocal cords, the greater the periodicity of the signal.

The voicing measure concatenated with the five dimensional PW subband correlation vector results in a six dimensional vector which is provided to the PW Subband Correlation+Voicing Measure VQ module 208 which vector quantizes the six dimensional vector.

The Gain Vector Predictive VQ module 114B vector quantizes the PW gain vector received from the PW Gain Computation module 114A. The PW gain is decimated by a factor of two, e.g. only PW gains from subframes 2, 4, 6, 8 are selected in a frame with 8 subframes. Predictive quantization is used to predict the average value of the PW gains based on previous actual quantized gain values. That is, the previous frame's quantized four dimensional gain vector is used to predict what the average PW gain value is for the current frame. The difference between the actual and predicted values are then subjected to VQ.

FIG. 2 will now be discussed in greater detail. As discussed earlier, the speech encoder 100A includes built-in voice activity detector (VAD) 202 and can operate in a continuous transmission (CTX) mode or in a discontinuous transmission (DTX) mode. In the DTX mode, comfort noise information (CNI) is encoded as part of the compressed bit stream during silence intervals. At the decoder 100B, the CNI packets are used by a comfort noise generation (CNG) algorithm to regenerate a close approximation of the ambient noise. The VAD information is also used by an integrated front end noise reduction module to provide varying degrees of background noise level attenuation and speech signal enhancement.

A single parity check bit is included in the 80 compressed speech bits of each frame to detect channel errors in perceptually important compressed speech bits. This allows the codec 100 to operate satisfactorily in links having a random bit error rate up to 10⁻³. In addition, the decoder 100B uses bad frame concealment and recovery techniques to extend the signal processing during frame erasures.

In addition to the speech coding functions, the codec 100 also has the ability to transparently pass Dual Tone Multi-Frequency (DTMF) and signaling tones. It accomplishes this by detecting DTMF signaling tones and encoding the DTMF signaling tones by special bit-patterns at the encoder 100A, and detecting the bit-patterns and regenerating the signaling tones at the decoder 100B.

The codec 100 uses linear predictive (LP) analysis to model the short term Fourier spectral envelope of an input speech signal. Subsequently, a pitch frequency estimate is used to perform a frequency domain prototype waveform (PW) analysis of the LP residual signal. The PW analysis provides a characterization of the harmonic or fine structure of the speech spectrum. The PW magnitude spectrum provides the correction necessary to refine the short term LP spectral estimate to obtain a more accurate fit to the speech spectrum at the pitch harmonic frequencies. Information about the phase of the signal is implicitly represented by the degree of periodicity of the signal measured across a set of subbands.

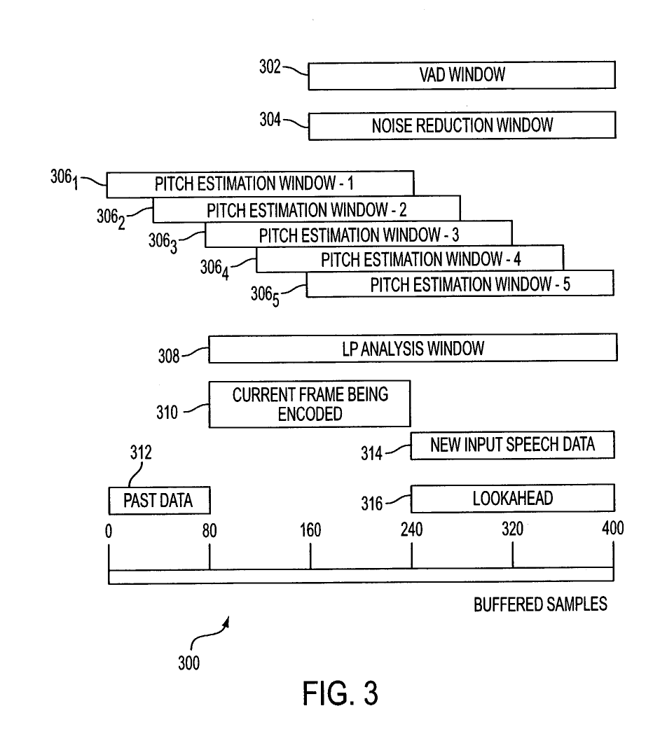

The input speech signal is processed in consecutive non-overlapping frames of preferably 20 ms duration, which corresponds to 160 samples at the sampling frequency of 8000 samples/sec. The encoder's 100A parameters are quantized and transmitted once for each 20 ms frame. A look-ahead of 20 ms is used for voice activity detection, noise reduction, LP analysis and pitch estimation. This results in an algorithmic delay, e.g., buffering delay+look-ahead delay, of 40 ms. In an embodiment of the invention, encoder 100A processes an input speech signal using the samples buffered as shown in FIG. 3.

FIG. 3 is a timing diagram illustrating the time line and sizes of various signal buffers used by the CODEC of FIG. 1 in accordance with an embodiment of the present invention. Specifically, 300 is a buffer of 400 speech samples which corresponds to about 50 ms duration. This buffer is sub-divided into a past data buffer 312, a current frame buffer 310, and the new input speech data buffer 314. The last 160 samples or 20 ms corresponds to the new input speech data 314. The current frame being encoded 310 comprises the speech samples currently being encoded and ranges from 80 to 240 samples which is also 20 ms in duration. The encoder 100A encodes the current frame being encoded by looking at the past data 312 which is from 0 to 80 samples in duration, about 10 ms, and also the lookahead data 316 which is from 240 to 400 samples in duration, about 20 ms.

Speech signals are processed in 20 ms increments of time. Therefore, the last 20 ms corresponds to the new input speech data 314. To encode the current frame being encoded, an LP analysis, voice activity detection, noise reduction, and pitch estimation are performed by LP analysis window 308, VAD window 302, noise reduction window 304, and pitch estimation windows 306₁ to 306₅, respectively. LP analysis is performed on a 320 sample buffer, e.g. from 80 to 400 samples, which is 40 ms in duration.

The pitch is performed using multiple windows e.g. pitch estimation window-1 306₁, pitch estimation window-2 306₂, pitch estimation window-3 306₃, pitch estimation window-4 306₄, and pitch estimation window-5 306₅. Each pitch estimation window is about 240 samples in duration, e.g. about 30 ms and slide about 5 ms so that adjacent pitch estimation windows overlap. Specifically, each pitch estimation window derives a pitch estimate for different points of time. It should be noted that since there is an overlap in the pitch estimation windows, for the next frame the pitch estimation does not have to be repeated for all the windows. For instance, pitch estimation window-2 306₅ becomes pitch window-1 306₁ for the next frame. A pitch track, which is a collection of individual pitch estimates at 5 ms intervals, is used to derive an overall pitch period for each frame. From the overall pitch, the pitch contour is derived.

An embodiment of the invention will now be discussed with reference to front end processing. The new input speech samples are preprocessed and first scaled down by 0.5 to prevent overflow in fixed point implementation of the coder 100. In another embodiment of the invention, the scaled speech samples can be high-pass filtered using an Infinite Impulse Response (IIR) filter with a cut-off frequency of about 60 Hz, to eliminate undesired low frequency components. The transfer function of the 2nd order high pass filter is given by

$${H}_{hpf1} ( z ) = \frac{\begin{matrix}0.939819335 - \\ 1.879638672 {z}^{- 1} + 0.939819335 {z}^{- 2}\end{matrix}}{1 - 1.933195469 {z}^{- 1} + 0.935913085 {z}^{- 2}} . \qquad \text{(2.2.2-1)}$$

The preprocessed signal is analyzed to detect the presence of speech activity. This comprises the following operations of scaling the signal via an automatic gain control (AGC) mechanism to improve VAD performance for low level signals; windowing the AGC scaled speech and computation of a set of autocorrelation lags; performing a 10^{th} order autocorrelation LP analysis of the AGC scaled speech to determine a set of LP parameters; preliminary pitch estimation based on the pitch candidates at the edge of the current frame. Voice activity detection is based on the autocorrelation lags and pitch estimate and the tone detection flag that is generated by examining the distance between adjacent LSFs as described below with reference to converting to line spectral frequencies. This series of operations result in a VAD_FLAG and a VID_FLAG that take on the following values depending on the detected voice activity:

$$VAD\_FLAG = \{ \begin{matrix}1 & \text{if voice activity is present,} \\ 0 & \text{if voice activity is absent.}\end{matrix} \\ VID\_FLAG = \{ \begin{matrix}0 & \text{if voice activity is present,} \\ 1 & \text{if voice activity is absent.}\end{matrix} \qquad \text{(2.2.2.-1)}$$

It should be noted that the VAD_FLAG and the VID_FLAG represent the voice activity status of the look-ahead part of the buffer. A delayed VAD flag, VAD_FLAG_DL1 is also maintained to reflect the voice activity status of the current frame. The AGC front-end for the VAD is described in reference 13, which itself is a variation of the voice activity detection algorithms used in cellular standards which is reference 14. One of the useful by-products of the AGC front-end is the global signal-to-noise ratio which is used to control the degree of noise reduction. This is described in detail with respect to the noise reduction module 204.

The VAD flag is encoded explicitly only for unvoiced frames as indicated by the voicing measure flag which will be described in detail with respect to determining the measure of the degree of voicing by the voicing measure and a spectral weighting function. Voiced frames are assumed to be active speech. This assumption has been found to be valid for all the databases tested, e.g., IS-686 database, NTT database, etc. In this case, the VAD flag is not coded explicitly. The decoder 100B sets the VAD flag to 1 for all voiced frames.

The preprocessed speech signal is processed by the noise reduction module 204 using a noise reduction algorithm to provide a noise reduced speech signal. The following is an exemplary series of steps that comprise the noise reduction algorithm: trapezoidal windowing and the computation of the complex discrete Fourier transform (DFT) of the signal. FIG. 3 illustrates the part of the buffer that undergoes the DFT operation. A 256-point DFT e.g., 240 windowed samples+16 padded zeros is used.; the magnitude DFT is smoothed along the frequency axis across a variable window preferably having a width of about 187.5 Hz in the first 1 KHz, 250 Hz in the range of 1-2 KHz, and 500 Hz in the range of 2-4 KHz. regions. These values reflect a compromise between the conflicting objectives of preserving the formant structure and having sufficient smoothness; If the VVAD_FLAG e.g., the VAD output prior to hangover, is 1 which indicates voice activity, the smoothed magnitude square of the DFT is taken to be the smoothed power spectrum of noisy speech S(k). Else, if the VVAD_FLAG is 0 indicating voice inactivity, the smoothed DFT power spectrum is then used to update a recursive estimate of the average noise power spectrum Nₐᵥ(k) as follows:

Nₐᵥ(k)=0.9·Nₐᵥ(k)+0.1·S(k) if VAD_FLAG=0 (2.2.3-1)

A spectral gain function is computed based on the average noise power spectrum and the smoothed power spectrum of the noisy speech. The gain function Gₙᵣ(k) takes the following form:

$${G}_{nr} ( k ) = \frac{S ( k )}{{F}_{nr} {N}_{av} ( k ) + S ( k )} \qquad \text{(2.2.3-2)}$$

where, the factor Fₙᵣ depends on the global signal-to-noise ratio SNR_{global} that is generated by the AGC front-end for the VAD. The factor Fₙᵣ can be expressed as an empirically derived piecewise linear function of SNR_{global} that is monotonically non-decreasing. The gain function is close to unity when the smoothed power spectrum S(k)is much larger than the average noise power spectrum Nₐᵥ(k). Conversely, the gain function becomes small when S(k) is comparable to or much smaller than Nₐᵥ(k). The factor Fₙᵣ controls the degree of noise reduction by providing a higher degree of noise reduction when the global signal-to-noise ratio is high i.e., risk of spectral distortion is low since VAD and the average noise estimate are fairly accurate. Conversely, the Fₙᵣ factor restricts the amount of noise reduction when the global signal-to-noise ratio is low i.e., risk of spectral distortion is high due to increased VAD inaccuracies and less accurate average noise power spectral estimate.

The spectral amplitude gain function is further clamped to a floor which is a monotonically non-increasing function of the global signal-to-noise ratio. The clamping reduces the fluctuations in the residual background noise after noise reduction is performed making it sound smoother. The clamping action is expressed as:

$${G}_{nr}^{′} ( k ) = MAX ( {G}_{nr} ( k ) , {T}_{global} ( {SNR}_{global} ) ) \qquad \text{(2.2.3-4)}$$

Thus, at high global signal-to-noise ratios, the spectral gain functions is clamped to a lower floor since there is less risk of spectral distortion due to inaccuracies in the VAD or the average noise power spectral estimate Nₐᵥ(k). But at lower global signal-to-noise ratio, the risks of spectral distortion outweigh the benefits of reduced noise and therefore a higher floor would be appropriate.

In order to reduce the frame-to-frame variation in the spectral amplitude gain function, a gain limiting device that limits the gain between a range that depends on the previous frame's gain for the same frequency is applied. The limiting action can be expressed as follows:

$${G}_{nr}^{new} ( k ) = MAX ( \{ {S}_{nr}^{L} \cdot {G}_{nr}^{old} ( k ) \} , \\ MIN ( \{ {S}_{nr}^{H} \cdot {G}_{nr}^{old} ( k ) \} , {G}_{nr}^{′} ( k ) ) ) \qquad \text{(2.2.3-5)}$$

The scale factors

$${S}_{nr}^{L} and {S}_{nr}^{H}$$

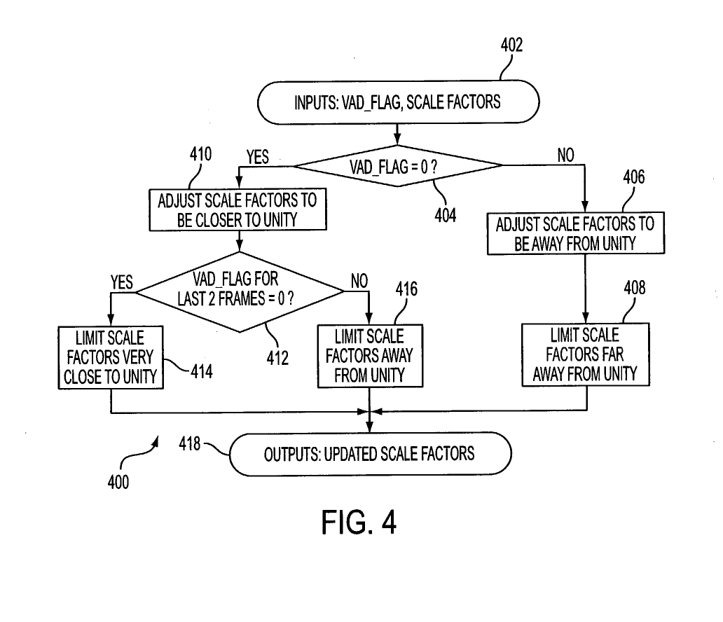

are updated using a state machine whose actions depend on whether the frame is active, inactive or transient. The flowchart 400 of FIG. 4 describes the operation of the state machine.

FIG. 4 is a flowchart illustrating an example of steps for performing scale factor updates in accordance with an embodiment of the present invention. The process 400 occurs in noise reduction module 204 and is initiated at step 402 where input values VAD_FLAG and scale factors are received. The method 400 then proceeds to step 404 where a determination is made as to whether the VAD_FLAG is zero which indicates voice activity is absent. If the determination is affirmative the method 400 proceeds to step 410 where the scale factors are adjusted to be closer to unity. The method 400 then proceeds to step 412.

At step 412 a determination is made as to whether the VAD_FLAG was zero for the last two frames. If the determination is affirmative the method proceeds to step 414 where the scale factors are limited to be very close to unity. However, if the determination was negative, the method 400 then proceeds to step 416 where the scale factors are limited to be away from unity.

If the determination at step 404 was negative, the method 400 then proceeds to step 406 where the scale factors are adjusted to be away from unity. The method 400 then proceeds to step 408 where the scale factors are limited to be far away from unity.

The steps 414, 416 and 408 proceed to step 418 where the updated scale factors are outputted.

The final spectral gain function Gₙᵣ^{new}(k) is multiplied with the complex DFT of the preprocessed speech, attenuating the noise dominant frequencies and preserving signal dominant frequencies.

An overlap-and-add inverse DFT is performed on the spectral gain scaled DFT to compute a noise reduced speech signal over the interval of the noise reduction window 304 shown in FIG. 3.

Since the noise reduction is carried out in the frequency domain, the availability of the complex DFT of the preprocessed speech is used to carry out DTMF and Signaling tone detection.

The detection schemes are based on examination of the strength of the power spectra at the tone frequencies, the out-of-band energy, the signal strength, and validity of the bit duration pattern. It should be noted that the incremental cost of having such detection schemes to facilitate transparent transmission of these signals is negligible since the power spectrum of the preprocessed speech is already available.

The noise reduced speech signal is subjected to a 10^{th} order autocorrelation method of LP analysis Where {sₙᵣ(n),0≦n<400} denotes the noise reduced speech buffer, and where {sₙᵣ(n),80≦n<240} is the current frame being encoded and {sₙᵣ(n),240≦n<400} is the look-ahead buffer 316 as shown in FIG. 3.

In performing LP analysis of speech, via the LP analysis module 102A, the magnitude spectrum of short segments of speech is modeled by the magnitude frequency response of an all-pole minimum phase filter, whose transfer function is represented by

$${H}_{lp} ( z ) = \frac{1}{{\sum }_{m = 0}^{M} {a}_{m} {z}^{- m}} . \qquad \text{(2.2.4-1)}$$

where {αₘ,0≦m≦M} are the LP parameters for the current frame and M=10 is the LP order. LP analysis is performed using the autocorrelation method with a modified Hanning window of size 40 ms e.g., 320 samples, which includes the 20 ms currentframe 310 and the 20 ms lookahead frame 316 as shown in FIG. 3.

The noise reduced speech signal over the LP analysis window 308 {sₙᵣ(n),80≦n<400} is windowed using a modified Hanning window function {wₗₚ(n),0≦n<320} defined as follows:

$${w}_{lp} ( n ) = \{ \begin{matrix}0.5 - 0.5 cos ( \frac{2 π n}{319} ) , & 0 \leq n < 240 , \\ \frac{( 0.5 - 0.5 cos ( \frac{2 π n}{319} ) )}{{cos}^{2} ( \frac{2 π ( n - 240 )}{320} )} , & 240 \leq n < 320\end{matrix} . \qquad \text{(2.2.5-1)}$$

The windowed speech buffer 308 is computed by multiplying the noise reduced speech buffer with the window function as follows:

s_{w}(n)=sₙᵣ(80+n)wₗₚ(n) 0≦n<320. (2.2.5-2)

Normalized autocorrelation lags are computed from the windowed speech by

$${r}_{lp} ( m ) = \frac{{\sum }_{n = 0}^{319 - m} {s}_{w} ( n ) {s}_{w} ( n + m )}{{\sum }_{n = 0}^{319} {s}_{w}^{2} ( n )} 0 \leq m \leq 10 , \qquad \text{(2.2.5-3)}$$

The autocorrelation lags are windowed by a binomial window with a bandwidth expansion of 60 Hz as shown in reference 1 and reference 2. The binomial window is given by the following recursive rule:

$${l}_{w} ( m ) = \{ \begin{matrix} 1 & m = 0 \\ {l}_{w} ( m - 1 ) \frac{4995 - m}{4994 + m} & 1 \leq m \leq 10.\end{matrix} \qquad \text{(2.2.5-4)}$$

Lag windowing is performed by multiplying the autocorrelation lags by the binomial window:

r_{lpw}(m)=rₗₚ(m)l_{w}(m) 1≦m≦10. (2.2.5-5a)

The zeroth windowed lag r_{lpw}(0) is obtained by multiplying by a white noise correction factor 1.0001, which is equivalent to adding a noise floor at −40 dB:

r_{lpw}(0)=1.0001rₗₚ(0) (2.2.5-5b)

Lag windowing and white noise correction are used to address problems that arise in the case of periodic or nearly periodic signals. For periodic or nearly periodic signals, the all-pole LP filter is marginally stable, with its poles very close to the unit circle. It is necessary to prevent such a condition to ensure that the LP quantization and signal synthesis at the decoder 100B can be performed satisfactorily.

The LP parameters that define a minimum phase spectral model to the short term spectrum of the current frame are determined by applying Levinson-Durbin recursions to the windowed autocorrelation lags {r_{lpw}(m),0≦m≦10}. The Levinson-Durbin recursions are well documented in the literature with respect to references 1,2 and 9 and will not be described here. The resulting 10^{th} order LP parameters for the current frame are {α′ₘ,0≦m≦10}, with α′₀=1. Since the LP analysis window is centered around the sample index 240 in the buffer, the LP parameters represent the spectral characteristics of the signal in the vicinity of this point.

During highly periodic signals, the spectral fit provided by the LP model tends to be excessively peaky in the low formant regions, resulting in audible distortions. To overcome this problem, a bandwidth broadening scheme is provided by adaptive bandwidth broadening module 102B, where the formant bandwidth of the model is broadened adaptively, depending on the degree of peakiness of the spectral model. The LP model spectrum is given by

$$S ( {ⅇ}^{j w} ) = \frac{1}{{\sum }_{m = 0}^{M} {a}_{m}^{′} {ⅇ}^{- j w m}} - π \leq w \leq π . \qquad \text{(2.2.7-1)}$$

Let ω₈ denote the pitch frequency estimate of the 8^{th} subframe of the current frame, measured in radians/sample. Given this pitch frequency, the index of the highest frequency pitch harmonic that falls within the frequency band of the signal (0-4000 Hz or 0-π radians) is given by

$${K}_{8} = ⌊ \frac{π}{{ω}_{8}} ⌋ , \qquad \text{(2.2.7-2)}$$

where, └x┘ denotes the largest integer less than or equal to x. Note that ω₈ corresponding to the 8^{th} subframe of the frame has been used here since the LP parameters have been evaluated for a window centered around sample 240, which is the right edge of the 8^{th} subframe of FIG. 3. The bandwidth broadening scheme samples the model power spectrum at pitch harmonic frequencies to determine its peakiness. If the pitch frequency is large as is the case for female speakers for example, the spectrum tends to be under sampled, and the measure of peakiness is less accurate. To compensate for this effect, the frequency used for sampling, ωₛ, is derived from the pitch frequency ω₈ as follows:

$${ω}_{s} = \{ \begin{matrix}\frac{{ω}_{8}}{3} & {K}_{8} \leq 20 , \\ \frac{{ω}_{8}}{2} & 21 \leq {K}_{8} \leq 30 , \\ {ω}_{8} & 31 \leq {K}_{8} . \end{matrix} \qquad \text{(2.2.7-3)}$$

The corresponding number of sampled frequencies, Kₛ, is obtained as follows:

$${K}_{s} = \{ \begin{matrix}3 {K}_{8} & {K}_{8} \leq 20 , \\ 2 {K}_{8} & 21 \leq {K}_{8} \leq 30 , \\ {K}_{8} & 31 \leq {K}_{8} .\end{matrix} \qquad \text{(2.2.7-4)}$$

Thus, the frequency used for sampling is an integer submultiple of the pitch frequency at higher pitch frequencies, ensuring adequate sampling of the LPC spectrum. The magnitude of the LPC spectrum is evaluated at integer multiples of ωₛ as follows:

$$\vert S ( k ) \vert = \vert S ( {ⅇ}^{j {ω}_{s} k} ) \vert = \frac{1}{\vert {\sum }_{m = 0}^{M} {a}_{m}^{′} {ⅇ}^{- {jω}_{s} k m} \vert} 0 \leq k \leq {K}_{s} . \qquad \text{(2.2.7-5)}$$

A logarithmic peak-to-average ratio of the harmonic spectral magnitudes is computed as

$$PAR = 10 {log}_{10} \{ \frac{{MAX}_{1 \leq k \leq {K}_{s}} \vert S ( k ) \vert}{\frac{1}{( {K}_{s} - 1 )} \{ [ {\sum }_{k = 1}^{{K}_{s}} \vert S ( k ) \vert ] - {MAX}_{1 \leq k \leq {K}_{s}} \vert S ( k ) \vert \}} \} . \qquad \text{(2.2.7-6)}$$

The peak-to-average ratio ranges from 0 dB for flat spectra to values exceeding 20 dB for highly peaky spectra. The expansion in formant bandwidth expressed in Hz is then determined based on the log peak-to-average ratio according to a piecewise linear characteristic:

$${dw}_{lp} = \{ \begin{matrix}10 , & PAR \leq 5 , \\ 10 + 10 ( PAR - 5 ) , & PAR \leq 10 , \\ 60 + 6 ( PAR - 10 ) , & PAR \leq 20 , \\ 120 & PAR > 20.\end{matrix} \qquad \text{(2.2.7-7)}$$

The expansion in bandwidth ranges from a minimum of 10 Hz for flat spectra to a maximum of 120 Hz for highly peaky spectra. Thus, the bandwidth expansion is adapted to the degree of peakiness of the spectra. The above piecewise linear characteristic has been experimentally optimized to provide the right degree of bandwidth expansion for a range of spectral characteristics. A bandwidth expansion factor α_{bw} to apply this bandwidth expansion to the LP spectrum is obtained by

$${α}_{bw} = {ⅇ}^{- \frac{π {dw}_{lp}}{8000}} . \qquad \text{(2.2.7-8)}$$

The LP parameters representing the bandwidth expanded LP spectrum are determined by

$${a}_{m} = {a}_{m}^{′} {α}_{bw}^{m} 0 \leq m \leq 10 \qquad ( 2.2 .7 \text{-} 9 )$$

At the LSP scalor vector predictive quantization module 102C, the bandwidth expanded LP filter coefficients are converted to line spectral frequencies (LSFs) for quantization and interpolation purposes. The theory and properties of LSF representation and their advantages for LP parameter quantization are well documented in reference 3 and will not be described here. An efficient approach to computing LSFs from LP parameters using Chebychev polynomials is described in reference 4 and is used here. The resulting LSFs for the current frame are denoted by {λ(m),0≦m≦10}.

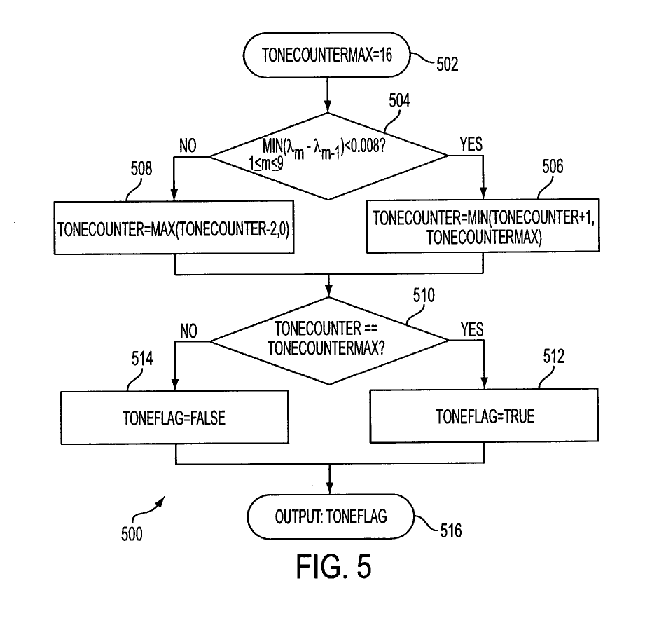

The LSF domain also lends itself to detection of highly periodic or resonant inputs. For such signals, the LSFs located near the signal frequency have very small separations. If the minimum difference between adjacent LSF values falls below a threshold for a number of consecutive frames, it is highly probable that the input signal is a tone. The flowchart 500 of FIG. 5 outlines the procedure for tone detection.

FIG. 5 is a flowchart illustrating an example of steps for performing tone detection in accordance with an embodiment of the present invention. The method 500 is performed in LP Analysis module 102A and is initiated at step 502 where a tone counter is set illustratively for a maximum of 16. The method 500 then proceeds to step 504 where a determination is made as to whether the difference in adjacent LSF values falls below a minimum threshold of, for example, 0.008. If the determination is answered negatively, the method 500 then proceeds to step 508 where the tone counter is decremented by a value set illustratively for 2 and subsequently clamped to 0.

If the method at step 504 is answered affirmatively, the tone counter is incremented by one and subsequently clamped to its maximum value of TONECOUNTERMAX at step 506. The methods 508 and 506 proceed to step 510.

At step 510, a determination is made as to whether the tone counter is at its maximum value. If the method at step 510 is answered negatively, the method 500 proceeds to step 514 where a tone flag equals false indication is provided. If the method at step 510 is answered affirmatively, the method 500 then proceeds to step 512 where a tone flag equals true indication is provided.

The method at steps 514 and 512 proceed to step 516 where the method 500 puts out a tone flag indication which is a one if a tone has been detected and a zero if a tone has not been detected. This flag is also used in voice activity detection by voice activity detection module 202.

The result of this procedure is TONEFLAG which is 1 if a tone has been detected and 0 otherwise. This flag is also used in voice activity detection.

Pitch estimation is performed at the pitch estimation quantization and interpolation module 106 based on an autocorrelation analysis of spectrally flattened low pass filtered speech signal. Spectral flattening is accomplished by filtering the AGC scaled speech signal by a pole-zero filter, constructed using the LP parameters of AGC scaled speech signal as discussed with respect to voice activity detection. If

$$\{ {a}_{m}^{agc} , 0 \leq m \leq 10 \}$$

are the LP parameters of AGC scaled speech signal, the pole-zero filter is given by

$${H}_{sf} ( z ) = \frac{{\sum }_{m = 0}^{M} {a}_{m}^{agc} {z}^{- m}}{{\sum }_{m = 0}^{M} {{a}_{m}^{agc} ( 0.8 )}^{m} {z}^{- m}} . \qquad ( 2.2 .9 \text{-} 1 )$$

The spectrally flattened signal is low-pass filtered by a 2^{nd} order IIR filter with a 3 dB cutoff frequency of 1000 Hz. The transfer function of this filter is

$${H}_{lpf1} ( z ) = \frac{0.06745527 - 0.134910548 {z}^{- 1} + 0.06745527 {z}^{- 2}}{1 - 1.14298050 {z}^{- 1} + 0.41280159 {z}^{- 2}} . \qquad ( 2.2 .9 \text{-} 2 )$$

The resulting signal is subjected to an autocorrelation analysis in two stages. In the first stage, a set of four raw normalized autocorrelation functions (ACF) are computed over the current frame. The windows for the raw ACFs are staggered by 40 samples as shown in FIG. 3 The raw ACF for the i^{th} window is computed by

$${r}_{raw} ( i , l ) = \frac{{\sum }_{n = 40 ( i - 1 )}^{40 ( i - 1 ) + 239 - l} {s}_{sf} ( n ) {s}_{sf} ( n + l )}{{\sum }_{n = 40 ( i - 1 )}^{40 ( i - 1 ) + 239} {s}_{sf}^{2} ( n )} 15 \leq l \leq 125 , 2 \leq i \leq 5. \qquad ( 2.2 .9 \text{-} 3 )$$

In each frame, raw ACFs corresponding to windows 2, 3, 4 and 5 306 of FIG. 3 are computed. In addition, raw ACF for window 1 306₁ is preserved from the previous frame. For each raw ACF, the location of the peak within the lag range 20≦l≦120 is determined.

In the second stage, each raw ACF is reinforced by the preceding and the succeeding raw ACF, resulting in a composite ACF. For each lag l in the raw ACF in the range 20≦l≦120, peak values within a small range of lags [(l−w_{c}(l)),(l+w_{c}(l))] are determined in the preceding and the succeeding raw ACFs. These peak values reinforce the raw ACF at each lag l, via a weighted combination

$${r}_{comp} ( i , l ) = \frac{{w}_{c} ( l ) + 1 - 0.1 {m}_{peak} ( l )}{( {w}_{c} ( l ) + 1 )} [ {MAX}_{l - {w}_{c} ( l ) \leq m \leq l + {w}_{c} ( l )} {r}_{raw} ( i - 1 , m ) ] + {r}_{raw} ( i , l ) + \frac{{w}_{c} ( l ) + 1 - 0.1 {n}_{peak} ( l )}{( {w}_{c} ( l ) + 1 )} [ {MAX}_{l - {w}_{c} ( l ) \leq n \leq l + {w}_{c} ( l )} {r}_{raw} ( i + 1 , n ) ] 20 \leq l \leq 120 , 2 \leq i \leq 5. \qquad ( 2.2 .9 \text{-} 4 )$$

Here, w_{c}(l) determines the window length based on the lag index l:

$${w}_{c} ( l ) = \{ \begin{matrix}2 & l < 30 \\ ⌊ 0.05 l + 0.5 ⌋ & 30 \leq l \leq 70 \\ 4 & l > 70\end{matrix} \qquad ( 2.2 .9 \text{-} 5 )$$

where, mₚₑₐₖ(l) and nₚₑₐₖ(l) are the locations of the peaks within the window around l for the preceding and succeeding raw ACF respectively.

The weighting attached to the peak values from the adjacent ACFs ensures that the reinforcement diminishes with increasing difference between the peak location and the lag l. The reinforcement boosts a peak value if peaks also occur at nearby lags in the adjacent raw ACFs. This increases the probability that such a peak location is selected as the pitch period. ACF peaks locations due to an underlying periodicity do not change significantly across a frame. Consequently, such peaks are strengthened by the above process. On the other hand, spurious peaks are unlikely to have such a property and consequently are diminished. This improves the accuracy of pitch estimation.

Within each composite ACF the locations of the two strongest peaks are obtained. These locations are the candidate pitch lags for the corresponding pitch window, and take values in the range 20-120 inclusive. Two strongest peaks of the raw ACF corresponding to Pitch Estimation window 5 306₅ of FIG. 3 are also determined. These peaks are used to provide some degree of look-ahead in pitch determination of frames with voicing onset. The two peaks from the last composite ACF of the previous frame i.e., for window 5 in the previous frame, the peaks from the 4 composite ACFs of the current frame and the peaks of the raw ACF provide a set of 6 peak pairs, leading to 64 possible pitch tracks through the current frame. A pitch metric is used to maximize the continuity of the pitch track as well as the value of the ACF peaks along the pitch track to select one of these pitch tracks. The metric for each of the 64 possible pitch tracks is computed by:

metric(i)=MAX(metric1(i),metric2(i)), 1≦i≦64, (2.2.9-1a)

where,

$$\begin{matrix}metric1 ( i ) = {\sum }_{j = 1}^{6} {w}_{m} ( j ) \{ [ 1 - \frac{\vert pf ( j ) - {pf}_{ref1} ( j ) \vert}{( {pf}_{MAX} - {pf}_{MIN} )} ] + {w}_{r} {r}_{max} ( j ) \} & ( 2.2 .9 \text{-} 1 b ) \\ metric2 ( i ) = {\sum }_{j = 1}^{6} {w}_{m} ( j ) \{ [ 1 - \frac{\vert pf ( j ) - {pf}_{ref2} ( j ) \vert}{( {pf}_{MAX} - {pf}_{MIN} )} ] + {w}_{r} {r}_{max} ( j ) \} & ( 2.2 .9 \text{-} 1 c )\end{matrix}$$

In the above equations, {pf(j),1≦j≦6} are the 6 pitch frequencies on the pitch track whose metric is being computed. pf_{MAX} and pf_{MIN} are the maximum and minimum possible pitch frequencies respectively. {rₘₐₓ(j),1≦j≦6} are the ACF peaks for the corresponding pitch lags. wᵣ is a weighting constant used to control the emphasis of the ACF peak over the deviation from the reference contour. It is preferably set to 3.0. {wₘ(j),1≦j≦6} are weights obtained by averaging the raw ACFs at zero lag, which is representative of signal energy. This serves to emphasize the role of signal regions with higher energy levels in determining the pitch track. The metric is determined by maximizing the proximity of the pitch frequency contour to a reference contour and the values of ACF peaks. {pf_{ref1}(j),1≦j≦6} and {pf_{ref2}(j),1≦j≦6} represent the two continuous reference pitch contours across the frame. Computing the metric based on the deviations from the reference contours serves to emphasize the continuity of the pitch contour. If the peaks of the raw ACF of window 5 are weaker and those of the composite ACF are stronger (as in the case of voicing offsets), the locations of the two peaks of the last composite ACF of the previous frame (one of which became the pitch lag) define the two reference contours that are constant across the frame. Conversely, if the raw ACF of window 5 has stronger peaks relative to the composite ACFs e.g., as in the case of voicing onsets, the reference pitch contours are constructed by linerly interpolating between the two peak locations of the last composite ACF of the previous frame and the two peak locations of the raw ACF of window 5 306₅. The peak locations are paired so that the two reference contours do not cross each other.

The optimal pitch track is the one that maximizes the metric among the 64 possible pitch tracks. The end point of the optimal pitch track determines the pitch period p₈ and a pitch gain β_{pitch} for the current frame. Note that due to the position of the pitch windows, the pitch period and pitch gain are aligned with the right edge of the current frame. The pitch period is integer valued and takes on values in the range 20-120. It is mapped to a 7-bit pitch index l*ₚ in the range 0-100.

The pitch gain β_{pitch} is estimated as the value of the composite autocorrelation function corresponding to window 3 306₃ i.e., the center of the frame, at its optimal pitch lag as determined by the selected pitch track. However, frames during onsets and offsets may not be periodic near the center of the frame, and this pitch gain may not represent the degree of periodicity of such frames. This may also result in classifying such frames as unvoiced. To overcome this problem, if the frame displays a minimal degree of periodicity, the pitch gain is selected to be the largest value of the peaks of the 5 raw autocorrelation functions evaluated across the current frame.

At the pitch estimation, quantization and interpolation module 106, the pitch period is converted to the radian pitch frequency corresponding to the right edge of the frame by

$${ω}_{8} = \frac{2 π}{{p}_{8}} . \qquad ( 2.2 .10 \text{-} 1 )$$

A subframe pitch frequency contour is created by linearly interpolating between the pitch frequency of the left edge ω₀ and the pitch frequency of the right edge ω₈:

$${ω}_{m} = \frac{( 8 - m ) {ω}_{0} + m {ω}_{8}}{8} , 1 \leq m \leq 8. \qquad ( 2.2 .10 \text{-} 2 )$$

If there are abrupt discontinuities between the left edge and the right edge pitch frequencies, the above interpolation is modified to make a switch from the pitch frequency to its integer multiple or submultiple at one of the subframe boundaries. Note that the left edge pitch frequency ωₒ is the right edge pitch frequency of the previous frame.

The index of the highest pitch harmonic within the 4000 Hz band is computed for each subframe by

$${K}_{m} = ⌊ \frac{π}{{ω}_{m}} ⌋ , 1 \leq m \leq 8. \qquad ( 2.2 .10 \text{-} 3 )$$

The LSFs are quantized by a hybrid scalar-vector quantization scheme. The first 6 LSFs are scalar quantized using a combination of intraframe and interframe prediction using 4 bits/LSF. The last 4 LSFs are vector quantized using 8 bits. Thus, a total of 32 bits are used for the quantization of the 10-dimensional LSF vector.

The 16 level scalar quantizers for the first 6 LSFs were designed using the Linde-Buzo-Gray algorithm. An LSF estimate is obtained by adding each quantizer level to a weighted combination of the previous quantized LSF of the current frame and the adjacent quantized LSFs of the previous frame:

$$\tilde{λ} ( l , m ) = \{ \begin{matrix}{S}_{L , m} ( l ) + 0.375 {\hat{λ}}_{prev} ( m + 1 ) , & m = 0 , \\ {S}_{L , m} ( l ) + 0.375 {\hat{( λ}}_{prev} ( m + 1 ) - {\hat{λ}}_{prev} ( m - 1 ) ) + \hat{λ} ( m - 1 ) , & 1 \leq m \leq 5 ,\end{matrix} \} , 0 \leq l \leq 15. \qquad ( 2.2 .11 \text{-} 1 )$$

Here, {\hat{λ}(m),0≦m<6} are the first 6 quantized LSFs of the current frame and {\hat{λ}ₚᵣₑᵥ(m),0≦m≦10} are the quantized LSFs of the previous frame. {S_{L,m}(l),0≦m<6,0≦l≦15} are the 16 level scalar quantizer tables for the first 6 LSFs. The squared distortion between the LSF and its estimate is minimized to determine the optimal quantizer level:

$${{MIN}_{0 \leq l \leq 15} ( λ ( m ) - \tilde{λ} ( l , m ) )}^{2} 0 \leq m \leq 5. \qquad ( 2.2 .11 \text{-} 2 )$$

If

$${l}_{L\_S \_m}^{*}$$

is the value of l that minimizes the above distortion, the quantized LSFs are given by:

$$\tilde{λ} ( m ) = \{ \begin{matrix}{S}_{L , m} ( {l}_{L\_S \_m}^{*} ) + 0.375 {\hat{λ}}_{prev} ( m + 1 ) , & m = 0 \\ {S}_{L , m} ( {l}_{L\_S \_m}^{*} ) + 0.375 {\hat{( λ}}_{prev} ( m + 1 ) - {\hat{λ}}_{prev} ( m - 1 ) ) + \hat{λ} ( m - 1 ) , & 1 \leq m \leq 5\end{matrix} \qquad ( 2.2 .11 \text{-} 3 )$$

The last 4 LSFs are vector quantized using a weighted mean squared error (WMSE) distortion measure. The weight vector {W_{L}(m),6≦m≦9} is computed by the following procedure:

$$\begin{matrix}p1 ( m ) = {\prod }_{i = 0 , 2 , 4 , 6 , 8}^{} \{ 4 + {cos}^{2} ( 2 π λ ( m ) ) + {cos}^{2} ( 2 π λ ( i ) ) - 8 cos ( 2 π λ ( m ) ) cos ( 2 π λ ( i ) ) \} , 6 \leq m \leq 9. & ( 2.2 .11 \text{-} 4 ) \\ p2 ( m ) = {\prod }_{i = 1 , 3 , 5 , 7 , 9}^{} \{ 4 + {cos}^{2} ( 2 π λ ( m ) ) + {cos}^{2} ( 2 π λ ( i ) ) - 8 cos ( 2 π λ ( m ) ) cos ( 2 π λ ( i ) ) \} , 6 \leq m \leq 9. & ( 2.2 .11 \text{-} 5 ) \\ {W}_{L} ( m ) = {[ \frac{1.09 - 0.6 cos ( 2 π λ ( m ) )}{( 0.5 + 0.5 cos ( 2 π λ ( m ) ) p1 ( m ) + ( 0.5 - 0.5 cos ( 2 π λ ( m ) ) p2 ( m )} ]}^{0.25} , 6 \leq m \leq 9. & ( 2.2 .11 \text{-} 6 )\end{matrix}$$

A set of predetermined mean values {λ_{dc}(m),6≦m<9} are used to remove the DC bias in the last 4 LSFs prior to quantization. These LSFs are estimated based on the mean removed quantized LSFs of the previous frame:

\tilde{λ}(l,m)=V_{L}(l,m−6)+λ_{dc}(m)+0.5(\tilde{λ}ₚᵣₑᵥ(m)−λ_{dc}(m)), 0≦l≦255, 6≦m≦9. (2.2.11-8)

Here {V_{L}(l,m),0≦l≦255,0≦m<3} is the 256 level, 4-dimensional codebook for the last 4 LSFs. The optimal codevector is determined by minimizing the WMSE between the estimated and the original LSF vectors:

$${MIN}_{0 \leq l \leq 255} {\sum }_{m = 6}^{9} {W}_{L} ( m ) {( λ ( m ) - \tilde{λ} ( l , m ) )}^{2} . \qquad ( 2.2 .11 \text{-} 9 )$$

If

$${l}_{L\_V}^{*}$$

is the value of l that minimizes the above distortion, the quantized LSF subvector is given by:

$$\hat{λ} ( m ) = {V}_{L} ( {l}_{L\_V}^{*} , m - 6 ) + {λ}_{d c} ( m ) + 0.5 ( {\hat{λ}}_{prev} ( m ) - {λ}_{d c} ( m ) ) , 6 \leq m \leq 9. \qquad ( 2.2 .11 \text{-} 10 )$$

The stability of the quantized LSFs is checked by ensuring that the LSFs are monotonically increasing and are separated by a minimum value of 0.005. If this property is not satisfied, stability is enforced by reordering the LSFs in a monotonically increasing order. If a minimum separation is not achieved, the most recent stable quantized LSF vector from a previous frame is substituted for the unstable LSF vector. The 6 4-bit SQ indices

$$\{ {l}_{L\_S \_m}^{*} ,$$

0≦m≦5} and the 8-bit VQ index

$${l}_{L\_V}^{*}$$

are transmitted to the decoder. Thus the LSFs are encoded using a total of 32 bits.

The inverse quantized LSFs are interpolated each subframe by linear interpolation between the current LSFs {\hat{λ}(m),0≦m≦10} and the previous LSFs {\hat{λ}ₚᵣₑᵥ(m),0≦m≦10}. The interpolated LSFs at each subframe are converted to LP parameters {\hat{α}ₘ(l),0≦m≦10,1≦l≦8}.

The prediction residual signal for the current frame is computed using the noise reduced speech signal {sₙᵣ(n)} and the interpolated LP parameters. Residual is computed from the midpoint of a subframe to the midpoint of the next subframe, using the interpolated LP parameters corresponding to the center of this interval. This ensures that the residual is computed using locally optimal LP parameters. The residual for the past data 312 of FIG. 3 is preserved from the previous frame and is also used for PW extraction. Further, residual computation extends 93 samples into the look-ahead part of the buffer to facilitate PW extraction. LP parameters of the last subframe are used computing the look-ahead part of the residual. By denoting the interpolated LP parameters for the j^{th} subframe (0≦j≦8) of the current frame by {\hat{α}ₘ(j),0≦m≦10}, residual computation can be represented by:

$${e}_{lp} ( n ) = \{ \begin{matrix}{\sum }_{m = 0}^{M} {s}_{nr} ( n - m ) {\hat{a}}_{m} ( 0 ) & 80 \leq n < 90 , & \\ {\sum }_{m = 0}^{M} {s}_{nr} ( n - m ) {\hat{a}}_{m} ( j ) & 1 \leq j \leq 7 & 20 j + 70 \leq n < 20 j + 90 , \\ {\sum }_{m = 0}^{M} {s}_{nr} ( n - m ) {\hat{a}}_{m} ( 8 ) & 230 \leq n \leq 332. & \end{matrix} \qquad ( 2.3 .1 \text{-} 1 )$$

The residual for past data, {eₗₚ(n),0≦n<80} is preserved from the previous frame.

A prototype waveform (PW) in the time domain is essentially the waveform of a single pitch cycle, which contains information about the characteristics of the glottal excitation. A sequence of PWs contains information about the manner in which the excitation is changing across the frame. A time-domain PW is obtained for each subframe by extracting a pitch period long segment approximately centered at each subframe boundary at the PW extraction module 108A. The segment is centered with an offset of up to ±10 samples relative to the subframe boundary, so that the segment edges occur at low energy regions of the pitch cycle. This minimizes discontinuities between adjacent PWs. For the m^{th} subframe, the following region of the residual waveform is considered to extract the PW:

$$\{ {e}_{lp} ( 80 + 20 m + n ) , - \frac{{p}_{m}}{2} - 12 \leq n \leq \frac{{p}_{m}}{2} + 12 \} \qquad ( 2.3 .2 \text{-} 1 )$$

where pₘ is the interpolated pitch period in samples for the m^{th} subframe. The PW is selected from within the above region of the residual, so as to minimize the sum of the energies at the beginning and at the end of the PW. The energies are computed as sums of squares within a 5-point window centered at each end point of the PW, as the center of the PW ranges over the center offset of ±10 samples:

$$\begin{matrix}{E}_{end} ( i ) = {\sum }_{j = - 2}^{2} {e}_{lp}^{2} ( 80 + 20 m - \frac{{p}_{m}}{2} + i + j ) + {\sum }_{j = - 2}^{2} {e}_{lp}^{2} ( 80 + 20 m + \frac{{p}_{m}}{2} + i + j ) & - 10 \leq i \leq 10.\end{matrix} \qquad ( 2.3 .2 \text{-} 2 )$$

The center offset resulting in the smallest energy sum determines the PW. If iₘᵢₙ(m) is the center offset at which the segment end energy is minimized, i.e.,

E_{end}(iₘᵢₙ(m))≦E_{end}(i)−10≦i≦10, (2.3.2-3)

the time-domain PW vector for the m^{th} subframe is

$$\{ {e}_{lp} ( 80 + 20 m - \frac{{p}_{m}}{2} + {i}_{min} ( m ) + n ) , \qquad 0 \leq n < {p}_{m} \} .$$

0≦n<pₘ}. This is transformed by a pₘ-point discrete Fourier transform (DFT) into a complex valued frequency-domain PW vector:

$$\begin{matrix}{P}_{m}^{′} ( k ) = {\sum }_{n = 0}^{{p}_{m} - 1} {e}_{lp} ( 80 + 20 m - \frac{{p}_{m}}{2} + {i}_{min} ( m ) + n ) {ⅇ}^{- j {ω}_{m} kn} & 0 \leq k \leq {K}_{m} .\end{matrix} \qquad ( 2.3 .2 \text{-} 4 )$$

Here ωₘ is the radian pitch frequency and Kₘ is the highest in-band harmonic index for the m^{th} subframe (see eqn 2.2.10-3). The frequency domain PW is used in all subsequent operations in the encoder. The above PW extraction process is carried out for each of the 8 subframes within the current frame, so that the residual signal in the current frame is characterized by the complex PW vector sequence {P′ₘ(k),0≦k≦Kₘ,1≦m≦8}. In addition, an approximate PW is computed for subframe 1 of the look ahead frame, to facilitate a 3-point smoothing of PW gain and magnitude described later with respect to PW gain smoothing and PW magnitude vector smoothing Since pitch period is not available for the look-ahead 316 part of the buffer, the pitch period at the end of the current frame 310, i.e., p₈, is used in extracting this PW. The region of the residual used to extract this extra PW is

$$\{ {e}_{lp} ( 260 + n ) , - \frac{{p}_{8}}{2} - 12 \leq n \leq \frac{{p}_{8}}{2} + 12 \} . \qquad ( 2.3 .2 \text{-} 5 )$$

By minimizing the end energy sum as before, the time-domain PW vector is obtained as

$$\{ {e}_{lp} ( 260 - \frac{{p}_{8}}{2} + {i}_{min} ( 9 ) + n ) , \qquad 0 \leq n < {p}_{8} \} .$$

0≦n<p₈}. The frequency-domain PW vector is designated by P′₉ and is computed by the following DFT:

$$\begin{matrix}{P}_{9}^{′} ( k ) = {\sum }_{n = 0}^{{p}_{g} - 1} {e}_{lp} ( 260 - \frac{{p}_{8}}{2} + {i}_{min} ( 9 ) + n ) {ⅇ}^{- j {ω}_{g} kn} & 0 \leq k \leq {K}_{8} .\end{matrix} \qquad ( 2.3 .2 \text{-} 6 )$$

It should be noted that the approximate PW is only used for smoothing operations and not as the PW for subframe 1 during the encoding of the next frame. However, it is replaced by the exact PW computed during the next frame.

Each complex PW vector can be further decomposed into scalar gain component representing the level of the PW vector and a normalized complex PW vector representing the shape of the PW vector at the output of the PW normalization and alignment module 108B. Decomposition into scalar gain components permits computation and storage efficient vector quantization of PW with minimal degradation in quantization performance. The PW gain is the root-mean square (RMS) value of the complex PW vector. It is obtained by

$$\begin{matrix}{g}_{pw} ( m ) = \sqrt{\frac{1}{2 {K}_{m} + 2} {\sum }_{k = 0}^{{K}_{m}} {\vert {P}_{m}^{′} ( k ) \vert}^{2}} & 1 \leq m \leq 8.\end{matrix} \qquad ( 2.3 .3 \text{-} 1 )$$

PW gain is also computed for the extra PW by

$${g}_{pw} ( 9 ) = \sqrt{\frac{1}{2 {K}_{8} + 2} {\sum }_{k = 0}^{{K}_{8}} {\vert {P}_{9}^{′} ( k ) \vert}^{2}} . \qquad ( 2.3 .3 \text{-} 2 )$$

A normalized PW vector sequence is obtained by dividing the PW vectors by the corresponding gains:

$$\begin{matrix}{P}_{m} ( k ) = \frac{{P}_{m}^{′} ( k )}{{g}_{pw} ( m )} & 0 \leq k \leq {K}_{m} , 1 \leq m \leq 8.\end{matrix} \qquad ( 2.3 .3 \text{-} 3 )$$

And for the extra PW:

$$\begin{matrix}{P}_{9} ( k ) = \frac{{P}_{9}^{′} ( k )}{{g}_{pw} ( 9 )} & 0 \leq k \leq {K}_{8} .\end{matrix} \qquad ( 2.3 .3 \text{-} 4 )$$

For a majority of frames, especially during stationary intervals, gain values change slowly from one subframe to the next. This makes it possible to decimate the gain sequence by a factor of 2, thereby reducing the number of values that need to be quantized. Prior to decimation, the gain sequence is smoothed by a 3-point window, to eliminate excessive variations across the frame. The smoothing operation is in the logarithmic gain domain and is represented by

$$\begin{matrix}{g}_{pw}^{′} ( m ) = 0.3 {log}_{10} {g}_{pw} ( m - 1 ) + 0.4 {log}_{10} {g}_{pw} ( m ) + \\ 0.3 {log}_{10} {g}_{pw} ( m + 1 )\end{matrix} \\ 1 \leq m \leq 8. \qquad ( 2.3 .4 \text{-} 1 )$$

Conversion to logarithmic domain is advantageous since it corresponds to the scale of loudness of sound perceived by the human ear.

The gain values are limited to the range 0.0 dB-4.5 dB by the following operations:

$$\begin{matrix}{g}_{pw}^{″} ( m ) = \{ \begin{matrix}MAX ( {g}_{pw}^{′} ( m ) , 0.0 ) \\ MIN ( {g}_{pw}^{′} ( m ) , 4.5 )\end{matrix} & 1 \leq m \leq 8.\end{matrix} \qquad ( 2.3 .4 \text{-} 2 )$$

The smoothed gains are decimated by a factor of 2, requiring that only the even indexed values, i.e.,

$$\{ {g}_{pw}^{″} ( 2 ) , {g}_{pw}^{″} ( 4 ) , {g}_{pw}^{″} ( 6 ) , {g}_{pw}^{″} ( 8 ) \} ,$$

are quantized. At the decoder, the odd indexed values are obtained by linearly interpolating between the inverse quantized even indexed values.

A 256 level, 4-dimensional predictive vector quantizer is used to quantize the above gain vector. The design of the predictive vector quantizer is one of the novel aspects of the present invention. Prediction takes place by means of a predicted average gain value for the frame, computed based on the quantized gain vector of the preceding frame,

$$\{ {\hat{g}}_{pw , prev}^{″} ( m ) , m = 2 , 4 , 6 , 8 \} ,$$

as follows:

$${g}_{dc} = \frac{1}{4} {\sum }_{i = 1}^{4} {\hat{g}}_{pw , prev}^{″} ( 2 i ) . \qquad ( 2.3 .4 \text{-} 3 )$$

Computation of

$${\hat{g}}_{pw}^{″}$$

is described with respect to gain decoding in the decoder 100B. Gain prediction serves to take advantage of considerable interframe correlation that exists for gain vectors.

The quantizer uses a mean squared error (MSE) distortion metric

$${D}_{g} ( l ) = {\sum }_{m = 1}^{4} {[ {g}_{pw}^{″} ( 2 m ) - {α}_{g} {g}_{dc} - {V}_{g} ( l , m ) ]}^{2} 0 \leq l \leq 255 , \qquad ( 2.3 .4 \text{-} 4 )$$

where, {V_{g}(l,m), 0≦l≦255,1≦m≦4} is the 256 level, 4-dimensional gain codebook and D_{g}(l) is the MSE distortion for the l^{th} codevector. α_{g} is the gain prediction coefficient, whose typical value is 0.75. The optimal codevector {V_{g}(l*_{g},m), 1≦m≦4} is the one which minimizes the distortion measure over the entire codebook, i.e.,

D_{g}(l*_{g})≦D_{g}(l) 0≦l≦255. (2.3.4-5)

The 8-bit index of the optimal codevector l*_{g} is transmitted to the decoder as the gain index.

In the FDI algorithm, only the PW magnitude information is explicitly encoded. PW Phase is not encoded explicitly since the replication of phase spectrum is not necessary for achieving natural quality in reconstructed speech. However, this does not imply that an arbitrary phase spectrum can be employed at the decoder 100B. One important requirement on the phase spectrum used at the decoder 100B is that it produces the correct degree of periodicity i.e., pitch cycle stationarity, across the frequency band. Achieving the correct degree of periodicity is extremely important to reproduce natural sounding speech.

The generation of the phase spectrum at the decoder is facilitated by measuring pitch cycle stationarity in the form of the correlation between successive complex PW vectors. A time-averaged correlation vector is computed for each harmonic component. Subsequently, this correlation vector is averaged across frequency, over 5 subbands, resulting in a 5-dimensional correlation vector for each frame at the PW subband correlation computation module 116. This vector is quantized and transmitted to the decoder 100B, where it is used to generate phase spectra that lead to the correct degree of periodicity across the band. The first step in measuring the PW correlation vector is to align the PW sequence.

In order to measure the correlation of the PW sequence, it is necessary to align each PW to the preceding PW. The alignment process applies a circular shift to the pitch cycle to remove apparent differences in adjacent PWs that are due to temporal shifts or variations in pitch frequency. Let \tilde{P}ₘ₋₁ denote the aligned PW corresponding to subframe m−1 and let \tilde{θ}ₘ₋₁ be the phase shift that was applied to Pₘ₋₁ to derive \tilde{P}ₘ₋₁. In other words,

\tilde{P}ₘ₋₁(k)=Pₘ₋₁(k)e^{j\tilde{θ}}^{ₘ₋₁}^{k} 0≦k≦Kₘ₋₁. (2.3.5-1)

Consider the alignment of Pₘ to \tilde{P}ₘ₋₁. If the residual signal is perfectly periodic with pitch period an integer number of samples, Pₘ and Pₘ₋₁ are identical except for a circular shift. In this case, the pitch cycle for the m^{th} subframe is identical to the pitch cycle for the m−1^{th} subframe, except that the starting point for the former is at a later point in the pitch cycle compared to the latter. The difference in starting point arises due to the advance by a subframe interval and differences in center offsets at subframes m and m−1. With the subframe interval of 20 samples and with center offsets of iₘᵢₙ(m) and iₘᵢₙ(m−1), it can be seen that the m^{th} pitch cycle is ahead of the m−1^{th} pitch cycle by 20+iₘᵢₙ(m)−iₘᵢₙ(m−1) samples. If the pitch frequency is ωₘ, a phase shift of −ωₘ(20+iₘᵢₙ(m)−iₘᵢₙ(m−1)) is necessary to correct for this phase difference and align Pₘ with Pₘ₋₁. In addition since Pₘ₋₁ has been circularly shifted by \tilde{θ}ₘ₋₁ to derive \tilde{P}ₘ₋₁, it follows that the phase shift needed to align Pₘ with \tilde{P}ₘ₋₁ is a sum of these two phase shifts and is given by

\tilde{θ}ₘ₋₁−ωₘ(20+iₘᵢₙ(m)−iₘᵢₙ(m−1)). (2.3.5-2)

In practice, the residual signal is not perfectly periodic and the pitch period can be non-integer valued. In such a case, the above cannot be used as the phase shift for optimal alignment. However, for quasi-periodic signals, the above phase angle can be used as a nominal shift and a small range of angles around this nominal shift angle are evaluated to find a locally optimal shift angle. Satisfactory results have been obtained with an angle range of ±0.2π centered around the nominal shift angle, searched in steps of

$$\frac{π}{128} .$$

In principle, the approach is equivalent to correlating the shifted version of Pₘ against \tilde{P}ₘ₋₁ to find the shift angle maximizing the correlation. This correlation maximization can be represented by

$${MAX}_{- 25 \leq i \leq 25} {\sum }_{k = 0}^{{K}_{m}} Re [ {\tilde{P}}_{m - 1} ( k ) {P}_{m}^{*} ( k ) {ⅇ}^{- j ( {\tilde{θ}}_{m - 1} - {ω}_{m} ( 20 + {i}_{min} ( m ) - {i}_{min} ( m - 1 ) ) + \frac{π}{128} i ) k} ] \qquad \text{(2.3.5-3)}$$

where * represents complex conjugation and Re[ ] is the real part of a complex vector. If i=iₘₐₓ maximizes the above correlation, then the locally optimal shift angle is

$${\tilde{θ}}_{m} = {\tilde{θ}}_{m - 1} - {ω}_{m} ( 20 + {i}_{min} ( m ) - {i}_{min} ( m - 1 ) ) + \frac{π}{128} {i}_{max} \qquad \text{(2.3.5-4)}$$

and the aligned PW for the m^{th} subframe is obtained from

\tilde{P}ₘ(k)=Pₘ(k)e^{j\tilde{θ}}^{ₘ}^{k} 0≦k≦Kₘ. (2.3.5-5)

In practice, direct evaluation of the equation 2.3.5-3 is extremely computation intensive. In an embodiment of the invention Fourier transform and Cubic Spline interpolation techniques are employed to efficiently evaluate the correlation in equation 2.3.5-3.

The process of alignment results in a sequence of aligned PWs from which any apparent dissimilarities due to shifts in the PW extraction window, pitch period etc. have been removed. Only dissimilarities due to the shape of the pitch cycle or equivalently the residual spectral characteristics are preserved. Thus, the sequence of aligned PWs provides a means of measuring the degree of change taking place in the residual spectral characteristics i.e., the degree of stationarity of the residual spectral characteristics. The basic premise of the FDI algorithm is that it is important to encode and reproduce the degree of stationarity of the residual in order to produce natural sounding speech at the decoder. Consider the temporal sequence of aligned PWs along the k^{th} harmonic track, i.e.,

{\tilde{P}ₘ(k),1≦m≦8}. (2.3.5-6)

A compact description of the evolutionary spectral energy distribution of the PW sequence can be obtained by computing the correlation coefficient of the PW sequence along each harmonic track. It should be noted that the correlation coefficient essentially is a 1^{st} order all-pole model for the power spectral density of the harmonic sequence. If the signal is relatively periodic, with its energy concentrated at low evolutionary frequencies, this would result in the single real pole i.e., correlation coeffient, close to unity. As the signal periodicity becomes reduced, and the evolutionary spectrum becomes flatter, the pole moves towards the origin, and the correlation coefficient reduces towards zero. Thus the correlation coefficient can be used to provide an efficient, albeit approximate, description of the shape of the evolutionary spectral energy distribution of the PW sequence. In general, the correlation coefficient vector can be computed as a complex measure as follows:

$${r}_{pw} ( k ) = \frac{{\sum }_{m = 1}^{8} {P}_{m} ( k ) {P}_{m - 1}^{*} ( k )}{{\sum }_{m = 1}^{8} {\vert {P}_{m} ( k ) \vert}^{2}} 0 \leq k \leq {K}_{max} . \qquad \text{(2.3.5-7)}$$

A computationally simpler approach is based on computing it as a real measure, by measuring the correlation between the real parts of the PW sequence:

$${r}_{pw} ( k ) = \frac{{\sum }_{m = 1}^{8} Re [ {P}_{m} ( k ) ] Re [ {P}_{m - 1} ( k ) ]}{{\sum }_{m = 1}^{8} {Re [ {P}_{m} ( k ) ]}^{2}} 0 \leq k \leq {K}_{max} . \qquad \text{(2.3.5-8)}$$

The latter approach has been employed in our implementation for computational reasons. In principle, it is possible to extend the above approach by employing higher order all-pole models to achieve more accurate modeling. However, a first order model is perhaps adequate since the PW evolutionary spectra tend to range from low pass to flat. Further, since averaging is only across the current frame, preferably 8 subframes, at higher orders, the model accuracy is limited by the length of the averaging window.

The PW Subband correlation computation module 116 groups the harmonic components of the correlation coefficient vector into preferably 5 subbands spanning the frequency band of interest. Let the band edges which are in Hz be defined by the array

B_{pwr}=[1 400 800 1200 2000 3000]. (2.3.5-9)

The subband edges in Hz can be translated to subband edges in terms of harmonic indices such that the i^{th} subband contains harmonics with indices {η(i−1)≦k<η(i), 1≦i≦5} follows:

$$η ( i ) = \{ \begin{matrix}2 + ⌊ \frac{{B}_{pwr} ( i ) {K}_{8}}{4000} ⌋ & \{ 1 + ⌊ \frac{{B}_{pwr} ( i ) {K}_{8}}{4000} ⌋ \} < \frac{{B}_{pwr} ( i ) π}{4000 {ω}_{8}} , \\ ⌊ \frac{{B}_{pwr} ( i ) {K}_{8}}{4000} ⌋ & ⌊ \frac{{B}_{pwr} ( i ) {K}_{8}}{4000} ⌋ > \frac{{B}_{pwr} ( i ) π}{4000 {ω}_{8}} , \\ 1 + ⌊ \frac{{B}_{pwr} ( i ) π}{4000 {ω}_{8}} ⌋ & otherwise .\end{matrix} \} , 0 \leq i \leq 5. \qquad \text{(2.3.5-10)}$$

The subband correlation vector { (l),1≦l≦5} is computed by averaging the correlation vector components within each of the subbands:

$$ℛ ( l ) = \frac{1}{η ( l ) - η ( l - 1 )} {\sum }_{k = η ( l - 1 )}^{η ( l ) - 1} {r}_{pw} ( k ) 1 \leq l \leq 5. \qquad \text{(2.3.5-11)}$$

Relatively high values of the correlation indicates that the adjacent PW vectors are quite similar to each other, corresponding to a predominantly periodic signal or stationary PW sequence. On the other hand, lower correlation values indicate that there is a significant amount of variation in adjacent vectors in the PW sequence, corresponding to a predominantly aperiodic signal or nonstationary PW sequence. Intermediate values indicate different degrees of stationarity or periodicity of the PW sequence. This information can be used at the decoder 100B to provide the correct degree of variation from one PW to the next, as a function of frequency and thereby realize the correct degree of periodicity in the signal.

At the voicing measure computation module 118, for nonstationary voiced signals, where the pitch cycle is hanging rapidly across the frame, the subband PW correlation may have low values even in low frequency bands. This is usually a characteristic of unvoiced signals and usually translates to a noise-like excitation at the decoder. However, it is important that non-stationary voiced frames are reconstructed at the decoder 100B with glottal pulse-like excitation rather than with noise-like excitation. This information is conveyed by a scalar parameter called voicing measure, which is a measure of the degree of voicing of the frame. During stationary voiced and unvoiced frames, there is some correlation between the subband PW correlation and the voicing measure. However, while the voicing measure indicates if the excitation pulse should be a glottal pulse or a noiselike waveform, the subband PW correlation indicates how much this excitation pulse should change from subframe to subframe. The correlation between the voicing measure and the subband PW correlation is exploited by vector quantizing these parameters jointly.

The voicing measure is estimated for each frame based on certain characteristics correlated with the voiced/unvoiced nature of the frame. It is a heuristic measure that assigns a degree of voicing to each frame in the range 0-1, with 0 indicating a perfectly voiced frame and 1 indicating a completely unvoiced frame. The voicing measure is determined based on six measured characteristics of the current frame. The six characteristics are, the average correlation between adjacent aligned PW; a PW nonstationarity measure; the pitch gain; the variance of the candidate pitch lags computed during pitch estimation; a relative signal power, computed as the difference between the signal power of the current frame and a long term average signal power; and the 1^{st} reflection coefficient obtained during LP Analysis. The normalized correlation coefficient γₘ between the aligned PW of the m^{th} and m−1^{th} frames is obtained as a byproduct of the alignment process, described in reference to aligning the PW. This subframe correlation is averaged across the frame to obtain an average PW correlation:

$${γ}_{avg} = \frac{1}{8} {\sum }_{m = 1}^{8} {γ}_{m} . \qquad \text{(2.3.5-12)}$$

The average PW correlation is a measure of pitch cycle to pitch cycle correlation after variations due to signal level, pitch period and PW extraction offset have been removed. The average PW correlation exhibits a strong correlation to the nature of excitation and is typically higher when the glottal component of the excitation is stronger.

It is important to distinguish this correlation coefficient with the PW subband correlation described in reference to correlation computation. The average PW correlation coefficient is obtained by averaging across the frequency axis using the alignment summation of eqn. 2.3.5-3, followed by the time averaging in eqn. 2.3.5-12. In contrast, the PW subband correlation described in reference to correlation computation is initially computed for each harmonic by time averaging across the frame, followed by frequency averaging across subbands. Consequently, it can discriminate between correlation in different frequency bands, by providing a correlation value to each subband depending on the degree of stationarity of harmonic components within that subband.

As discussed earlier, PW subband correlation, especially in the low frequency subbands, has a strong correlation to the voicing of the frame. In order to use this in the determination of the voicing measure, the subband correlation is converted to a subband nonstationarity measure. The nonstationarity measure is representative of the ratio of the energy in the high evolutionary frequency band, 18 Hz-200 Hz, to that in the low evolutionary frequency band, 0 Hz-35 Hz. The mapping from correlation to nonstationarity measure is deterministic and can be performed by a table look-up operation Let {ₗ,1≦l≦5} represent the nonstationary measure for the 5 subbands, obtained by table look-up. The subband nonstationarity measure averaged for the 3 lowest subbands provides a useful parameter for use in inferring the nature of the glottal excitation. This average is computed as

$${ℏ}_{avg} = \frac{1}{3} {\sum }_{l = 1}^{3} {ℏ}_{l} . \qquad \text{(2.3.5-13)}$$

The pitch gain is a parameter that is computed as part of the pitch analysis function of 106. It is essentially the value of the peak of the autocorrelation function (ACF) of the residual signal at the pitch lag. To avoid spurious peaks, the ACF used here is a composite autocorrelation function, computed as a weighted average of adjacent residual raw autocorrelation functions. The details of the computation of the autocorrelation functions were discussed with reference to performing pitch estimation The pitch gain, denoted by β_{pitch}, is the value of the peak of a composite autocorrelation function.

The composite ACF are evaluated once every 40 samples within each frame preferably at 80, 120, 160, 200 and 240 samples as shown in FIG. 3. For each of the 5 ACF, the location of the peak ACF is selected as a candidate pitch period. The details of this analysis were discussed with reference to performing pitch estimation. The variation among these 5 candidate pitch lags is also a measure of the voicing of the frame. For unvoiced frames, these values exhibit a higher variance than for voiced frames. The mean of the candidate pitch period is computed as

$${p\_cand}_{avg} = \frac{1}{5} {\sum }_{l = 0}^{4} {p\_cand}_{l} . \qquad \text{(2.3.5-14)}$$

The variation is computed by the average of the absolute deviations from this mean:

$${p}_{v ar} = \frac{1}{5} {\sum }_{l = 0}^{4} \vert {p\_cand}_{avg} - {p\_cand}_{l} \vert . \qquad ( 2.3 .5 \text{-} 15 )$$

This parameter exhibits a moderate degree of correlation to the voicing of the signal.

The signal power also exhibits a moderate degree of correlation to the voicing of the signal. However, it is important to use a relative signal power rather than an absolute signal power, to achieve robustness to input signal level deviations from nominal values. The signal power in dB is defined as

$${E}_{sig} = 10 {log}_{10} [ \frac{1}{160} {\sum }_{n = 80}^{239} {s}^{2} ( n ) ] . \qquad ( 2.3 .5 \text{-} 16 )$$

An average signal power can be obtained by exponentially averaging the signal power during active frames. Such an average can be computed recursively using the following equation:

E_{sigavg}=0.99E_{sigavg}+0.01E_{sig}. (2.3.5-17)

A relative signal power can be obtained as the difference between the signal power and the average signal power:

E_{sigrel}=E_{sig}−E_{sigavg}. (2.3.5-18)

The relative signal power measures the signal power of the frame relative a long term average. Voiced frames exhibit moderate to high values of relative signal power, whereas unvoiced frames exhibit low values.

The 1^{st} reflection coeffient ρ₁ or equivalently the normalized autocorrelation coefficient at lag l of the noise reduced speech is a good indicator of voicing. During voiced speech segments, the speech spectrum tends to have a low pass characteristic, which results in a ρ₁ being close to 1. During unvoiced frames, the speech spectrum tends to have a flatter or high pass characteristic, resulting in much smaller or even negative values for ρ₁. It is computed by

$${ρ}_{1} = \frac{{\sum }_{n = 1}^{159} s ( n ) s ( n - 1 )}{{\sum }_{n = 0}^{159} {s}^{2} ( n )} . \qquad ( 2.3 .5 \text{-} 19 )$$

To derive the voicing measure, these six parameters are nonlinearly transformed using sigmoidal functions such that they map to the range 0-1, close to 0 for voiced frames and close to 1 for unvoiced frames. The parameters for the sigmoidal transformation have been selected based on an analysis of the distribution of these parameters. The following are the transformations for each of these parameters:

$$\begin{matrix}{n}_{pg} = 1 - \frac{1}{( 1 + {ⅇ}^{- 12 ( {β}_{pitch} - 0.48 )} )} & ( 2.3 .5 \text{-} 20 ) \\ {n}_{pw} = \{ \begin{matrix}1 - \frac{1}{( 1 + {ⅇ}^{- 10 ( {γ}_{avg} - 0.72 )} )} {γ}_{avg} \leq 0.72 \\ 1 - \frac{1}{( 1 + {ⅇ}^{- 13 ( {γ}_{avg} - 0.72 )} )} {γ}_{avg} > 0.72\end{matrix} & ( 2.3 .5 \text{-} 21 ) \\ {n}_{ℏ} = \{ \begin{matrix}\frac{1}{( 1 + {ⅇ}^{- 7 ( {ℏ}_{avg} - 0.85 )} )} {ℏ}_{avg} \leq 0.85 \\ \frac{1}{( 1 + {ⅇ}^{- 3 ( {ℏ}_{avg} - 0.85 )} )} {ℏ}_{avg} > 0.85\end{matrix} & ( 2.3 .5 \text{-} 22 ) \\ {n}_{E} = 1 - \frac{1}{( 1 + {ⅇ}^{- 1.25 ( {E}_{signel} - 2 )} )} & ( 2.3 .5 \text{-} 23 ) \\ \begin{matrix}{n}_{pv} = \{ \begin{matrix}0.5 - 12.5 ( {p}_{v ar} - 0.02 ) & {p}_{v ar} < 0.02 \\ 10 ( 0.07 - {p}_{v ar} ) & {p}_{v ar} < 0.07 \\ 1 & {p}_{v ar} \geq 0.07\end{matrix} \\ {n}_{p} = \{ \begin{matrix}1 - \frac{1}{( 1 + {ⅇ}^{- 5 ( {ρ}_{1} - 0.85 )} )} {ρ}_{1} \leq 0.85 \\ 1 - \frac{1}{( 1 + {ⅇ}^{- 13 ( {ρ}_{1} - 0.85 )} )} {ρ}_{1} > 0.85\end{matrix}\end{matrix} & ( 2.3 .5 \text{-} 24 )\end{matrix}$$

The voicing measure of the previous frame vₚᵣₑᵥ determines the weighted sum of the transformed parameters which results in the voicing measure:

$$v = \{ \begin{matrix}0.35 {n}_{pg} + 0.225 {n}_{pw} + 0.15 {n}_{} + 0.085 {n}_{E} + 0.07 {n}_{pv} + 0.12 {n}_{ρ} & {v}_{prev} < 0.3 \\ 0.35 {n}_{pg} + 0.2 {n}_{pw} + 0.1 {n}_{} + 0.1 {n}_{E} + 0.05 {n}_{pv} + 0.2 {n}_{ρ} & {v}_{prev} \geq 0.3\end{matrix} . \qquad ( 2.3 .5 \text{-} 25 )$$

The weights used in the above sum are in accordance with the degree of correlation of the parameter to the voicing of the signal. Thus, the pitch gain receives the highest weight since it is most strongly correlated, followed by the PW correlation. The 1^{st} reflection coefficient and low-band nonstationarity measure receive moderate weights. The weights also depend on whether the previous frame was strongly voiced, in which case more weight is given to the low-band nonstationarity measure. The pitch variation and relative signal power receive smaller weights since they are only moderately correlated to voicing.

If the resulting voicing measure ν is clearly in the voiced region (ν<0.45) or clearly in the unvoiced region e.g., (ν>0.6), it is not modified further. However, if it lies outside the clearly voiced or unvoiced regions, the parameters are examined to determine if there is a moderate bias towards a voiced frame. In such a case, the voicing measure is modified so that its value lies in the voiced region.

The resulting voicing measure ν takes on values in the range 0-1, with lower values for more voiced signals. In addition, a binary voicing measure flag is derived from the voicing measure as follows:

$${v}_{flag} = \{ \begin{matrix}1 & v > 0.45 or ( VAD\_FLAG \_DL1 = 0 and v > 0.30 ) , \\ 0 & otherwise .\end{matrix} \qquad ( 2.3 .5 \text{-} 26 )$$

Thus, frames with ν>0.45 or inactive frames which are weakly periodic i.e., a small ν, are forced to be classified as unvoiced with a voicing measure flag ν_{flag}=1. Otherwise, the frame is classified as voiced with ν_{flag}=0. This flag is used in selecting the quantization mode for PW magnitude and the subband nonstationarity vector. The voicing measure ν is concatenated to the PW subband correlation vector and the resulting 6-dimensional vector is vector quantized.

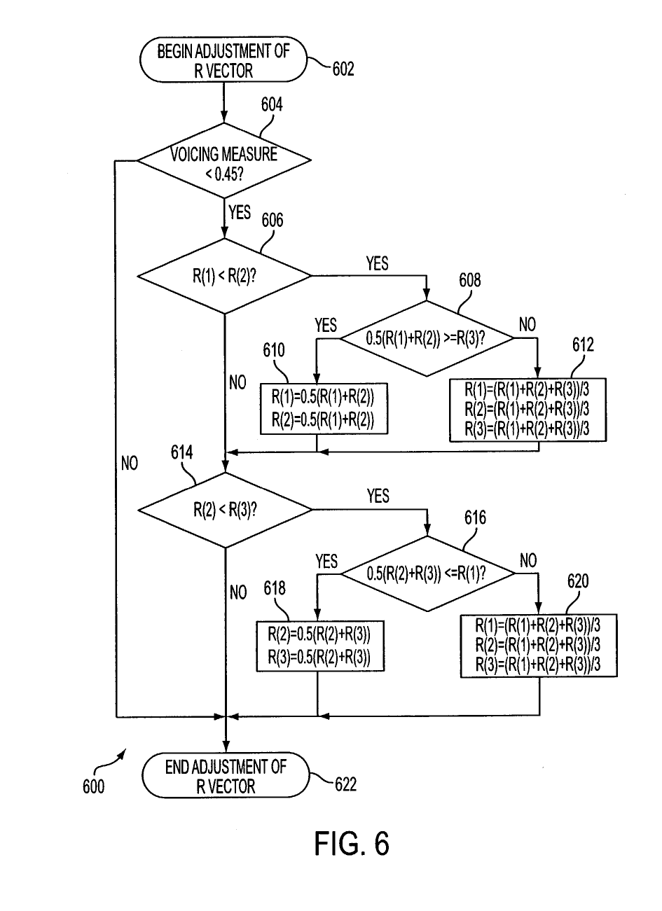

For voiced frames, it is necessary to ensure that the values of the subband PW correlation in the low frequency subbands are in a monotonically nondecreasing order. This condition is enforced for the 3 lower subbands according to the flow chart 600 in FIG. 6.

FIG. 6 is a flowchart illustrating an example of steps for enforcing decreasing monotonicity of the first 3 PW correlations for voiced frames in accordance with an embodiment of the present invention. Specifically, the method 600 ensures that the subband correlations decrease monotonically for the first 3 bands for voiced frames. Ideally, the PW correlation in band 1, which comprises a frequency range of 0-400 Hz, should be higher than or equal to the correlation in band 2, which comprises a frequency range of 400-800 Hz. Similarly, the PW correlation of band 2 should be higher than or equal to the correlation of band 3. If this decreasing monotonicity is not present for the first 3 bands for voiced frames, method 600 will ensure it by adjusting the PW correlations in the first 3 bands.

The method 600 is initiated at step 602. At step 604, a determination is made as to whether the voicing measure is less than 0.45. If the determination is answered negatively, the frame is unvoiced and no adjustment is needed. Therefore, the method 600 proceeds to the terminating step 622. If the determination is answered affirmatively, the frame is voiced. The method 600 proceeds to step 606.

At step 606, a determination is made as to whether the correlation in band 1 is less than the correlation in band 2. If the determination is answered negatively, the PW correlation in band 1 is greater than that in band 2. The method 600 proceeds to step 614. If the determination is answered affirmatively, the correlation in band 1 is less than band 2, which implies a correction is needed. The method 600 proceeds to step 608.

At step 608, a determination is made as to whether the average correlation of band 1 and band 2 is greater than or equal to the correlation of band 3. If the determination is answered affirmatively, the method 600 proceeds to step 610 where the correlations of band 1 and band 2 are replaced concurrently with their average correlation. If the determination is answered negatively, the method 600 proceeds to step 612 where each band is replaced concurrently by the average correlation of bands 1, 2 and 3. Steps 606, 610 and 612 proceed to step 614.

At step 614, a determination is made as to whether the correlation in band 2 is less than that of band 3. If the determination is answered negatively, the method 600 proceeds to the terminating step 622. If the determination is answered affirmatively, the method 600 proceeds to step 616 since a correction is needed.

At step 616, a determination is made as to whether the average correlation of bands 2 and 3 is greater than the correlation of band 1. If the determination is answered affirmatively, the method 600 proceeds to step 618 where the correlation of bands 2 and 3 are replaced concurrently with an average correlation of bands 2 and 3. If the determination is answered negatively, the method 600 proceeds to step 620 where the correlation of bands 1, 2 and 3 are replaced concurrently with the average correlation of bands 1, 2 and 3. Steps 614, 618 and 620 proceed to step 622.

At step 622, the adjustment of the correlation of the bands is completed and the bands are monotonically decreasing.

It should be noted that the steps performed in each block for steps 610, 612, 618 and 620 are performed simultaneously or concurrently. For example, for step 610, the average correlation is computed for bands 1 and 2 at the same time.

Referring to FIG. 2, at the PW subband correlation+voicing measure VQ module 208, the PW correlation vector is vector quantized using a spectrally weighted quantization. The spectral weights are derived from the LPC parameters. First, the LPC spectral estimate corresponding to the end point of the current frame is estimated at the pitch harmonic frequencies. This estimate employs tilt correction and a slight degree of bandwidth broadening. These measures are needed to ensure that the quantization of formant valleys or high frequencies are not compromised by attaching excessive weight to formant regions or low frequencies.

$${W}_{8} ( k ) = \frac{\vert {\sum }_{m = 0}^{10} {a}_{m}^{′} ( 8 ) {0.4}^{m} {ⅇ}^{- j {w}_{8} k m} {\vert}^{2}}{\vert {\sum }_{m = 0}^{10} {a}_{m}^{′} ( 8 ) {0.98}^{m} {ⅇ}^{- j {w}_{8} k m} {\vert}^{2}} 0 \leq k \leq {K}_{8} . \qquad ( 2.3 .6 \text{-} 1 )$$

This harmonic spectrum is converted to a subband spectrum by averaging across the 5 subbands used for the computation of the PW subband correlation vector.

$${\overline{W}}_{8} ( l ) = \frac{1}{( η ( l ) - η ( l - 1 ) )} {\sum }_{k = η ( l - 1 )}^{η ( l ) - 1} {W}_{8} ( k ) 1 \leq l \leq 5. \qquad ( 2.3 .6 \text{-} 2 )$$

This is averaged with the subband spectrum at the end of the previous frame to derive a subband spectrum that corresponding to the center of the current frame. This average serves as the spectral weight vector for the quantization of the PW subband correlation vector.

\overline{W}₄(l)=0.5(\overline{W}₀(l)+\overline{W}₈(l) 1≦l≦5. (2.3.6-3)

The voicing measure is concatenated to the end of the PW subband correlation vector, resulting in a 6-dimensional composite vector. This permits the exploitation of the considerable correlation that exists between these quantities. The composite vector is denoted by

_{c}={ (1) (2) (3) (4) (5) ν}. (2.3.6-4)

The spectral weight for the voicing measure is derived from the spectral weight for the PW subband correlation vector depending on the voicing measure flag. If the frame is voiced (ν_{flag}=0), the weight is computed as

$${\overline{W}}_{4} ( 6 ) = \frac{0.33}{5} {\sum }_{l = 1}^{5} {\overline{W}}_{4} ( l ) if {v}_{flag} = 0. \qquad ( 2.3 .6 \text{-} 5 )$$

In other words, it is lower than the average weight for the PW subband correlation vector. This ensures that that the PW subband correlation vector is quantized more accurately than the voicing measure. This is desirable since for voiced frames, it is important to preserve the correlation in the various bands to achieve the right degree of periodicty. On the other hand, for unvoiced frames, voicing measure is more important. In this case, its weight is larger than the maximum weight for the PW subband correlation vector.

$${\overline{W}}_{4} ( 6 ) = 1.5 { MAX}_{1 \leq l \leq 5} {\overline{W}}_{4} ( l ) if {v}_{flag} = 1. \qquad ( 2.3 .6 \text{-} 6 )$$

In an embodiment of the invention, a 32 level, 6-dimensional vector quantizer is used to quantize the composite PW subband correlation-voicing measure vector. The first 8 code vectors, e.g., indices 0-7, assigned to represent unvoiced frames and the remaining 24 code vectors e.g., indices 8-31, are assigned to respresent voiced frames. The voiced/unvoiced decision is made based on the voicing measure flag. The following weighted MSE distortion measure is employed:

$${D}_{R} ( l ) = {\sum }_{m = 1}^{6} {{\overline{W}}_{4} ( m ) [ {ℜ}_{c} ( m ) - {V}_{R} ( l , m ) ]}^{2} 0 \leq l \leq 31 , \qquad \text{(2.3.6-7)}$$

where, {V_{R}(l,m), 0≦l≦31,1≦m≦6} is the 32 level, 6-dimensional composite PW subband correlation-voicing measure codebook and D_{R}(l) is the weighted MSE distortion for the l^{th} codevector. If the frame is unvoiced e.g., (ν_{flag}=1), this distortion is minimized over the indices 0-7. If the frame is voiced e.g., (ν_{flag}=0), the distortion is minimized over the indices 8-31. Thus,

$${D}_{R}^{min} = \{ \begin{matrix}{MIN}_{0 \leq l \leq 7} {D}_{R} ( l ) & if {v}_{flag} = 1 \\ {MIN}_{8 \leq l \leq 63} {D}_{R} ( l ) & if {v}_{flag} = 0\end{matrix} \qquad \text{(2.3.6-8)}$$

This partitioning of the codebook reflects the higher importance given to the representation of the PW subband correlation during voiced frames. The 5-bit index of the optimal codevector l*_{R} is transmitted to the decoder as the PW subband correlation index. It should be noted that the voicing measure flag, which is used in the decoder 100B for the inverse quantization of the PW magnitude vector, can be detected by examining the value of the index.

Up to this point, the PW vectors are processed in Cartesian i.e., real-imaginary form. The FDI codec 100 at 4.0 kbit/s encodes only the PW magnitude information to make the most efficient use of the available bits. PW phase spectra are not encoded explicitly. Further, in order to avoid the computation intensive square-root operation in computing the magnitude of a complex number, the PW magnitude-squared vector is used during the quantization process.

At the PW magnitude subband mean computation module 112A, the PW magnitude vector is quantized using a hierarchical approach which allows the use of fixed dimension VQ with a moderate number of levels and precise quantization of perceptually important components of the magnitude spectrum. In this approach, the PW magnitude is viewed as the sum of two components: (1) a PW mean component, which is obtained by averaging of the PW magnitude across frequency within a 7 band sub-band structure, and (2) a PW deviation component, which is the difference between the PW magnitude and the PW mean. The PW mean component captures the average level of the PW magnitude across frequency, which is important to preserve during encoding. The PW deviation contains the finer structure of the PW magnitude spectrum and is not important at all frequencies. It is only necessary to preserve the PW deviation at a small set of perceptually important frequencies. The remaining elements of PW deviation can be discarded, leading to a small, fixed dimensionality of the PW deviation component.

The PW magnitude vector is quantized differently for voiced and unvoiced frames as determined by the voicing measure flag. Since the quantization index of the PW subband correlation vector is determined by the voicing measure flag, the PW magnitude quantization mode information is conveyed without any additional overhead.

During voiced frames, the spectral characteristics of the residual are relatively stationary. Since the PW mean component is almost constant across the frame, it is adequate to transmit it once per frame. The PW deviation is transmitted twice per frame, at the 4^{th} and 8^{th} subframes. Further, a significant degree of interframe prediction can be used in the voiced mode. On the other hand, unvoiced frames tend to be nonstationary. To track the variations in PW spectra, both mean and deviation components are transmitted twice per frame, at the 4^{th} and 8^{th} subframes. A lower degree of interframe prediction is employed in the unvoiced mode.

The PW magnitude vectors at subframes 4 and 8 are smoothed by a 3-point window. This smoothing can be viewed as an approximate form of decimation filtering to down sample the PW vector from 8 vectors/frame to 2 vectors/frame.

P′ₘ(k)=0.3Pₘ₋₁(k)+0.4Pₘ(k)+0.3Pₘ₊₁(k), 0≦k≦Kₘ,m=4,8. (2.3.7-1)

The subband mean vector is computed by averaging the PW magnitude vector across 7 subbands. The subband edges in Hz are

B_{pw}=[1 400 800 1200 1600 2000 2400 3000]. (2.3.7-2)

To average the PW vector across frequency, it is necessary to translate the subband edges in Hz to subband edges in terms of harmonic indices. The bandedges in terms of harmonic indices for subframes 4 and 8 can be computed by

$${κ}_{m} ( i ) = \{ \begin{matrix}2 + ⌊ \frac{{B}_{pw} ( i ) {K}_{m}}{4000} ⌋ & \{ 1 + ⌊ \frac{{B}_{pw} ( i ) {K}_{m}}{4000} ⌋ \} < \frac{{B}_{pw} ( i ) π}{4000 {ω}_{m}} , \\ ⌊ \frac{{B}_{pw} ( i ) {K}_{m}}{4000} ⌋ & ⌊ \frac{{B}_{pw} ( i ) {K}_{m}}{4000} ⌋ > \frac{{B}_{pw} ( i ) π}{4000 {ω}_{m}} , \\ 1 + ⌊ \frac{{B}_{pw} ( i ) {K}_{m}}{4000} ⌋ & otherwise .\end{matrix} \} , 0 \leq i \leq 7 , m = \text{4,8} . \qquad \text{(2.3.7-3)}$$

The mean vectors are computed at subframes 4 and 8 by averaging over the harmonic indices of each subband. Note that, as mentioned earlier, since the PW vector is available in magnitude-squared form, the mean vector is in reality a RMS vector. This is reflected by the following equation.

$${\overline{P}}_{m} ( i ) = \sqrt{\frac{1}{{κ}_{m} ( i + 1 ) - {κ}_{m} ( i )} {\sum }_{k = {κ}_{m} ( i )}^{{κ}_{m} ( i + 1 ) - 1} \vert {{P}_{m}^{′} ( k )}^{2} \vert ,} 0 \leq i \leq 6 , m = \text{4,8} . \qquad \text{(2.3.7-4)}$$

The PW mean and deviation vector quantizations are spectrally weighted. The spectral weight vector is computed for subframe 8 from LP parameters as follows:

$${W}_{8} ( k ) = \frac{{\vert {\sum }_{l = 0}^{10} {\hat{a}}_{l} ( 8 ) {( 0.4 )}^{l} {ⅇ}^{- {jω}_{8} kl} \vert}^{2}}{{\vert {\sum }_{l = 0}^{10} {\hat{a}}_{l} ( 8 ) {( 0.98 )}^{l} {ⅇ}^{- {jω}_{8} kl} \vert}^{2}} \qquad \text{(2.3.7-5)}$$

The spectral weight vector is attenuated outside the band of interest, so that out-of-band PW components do not influence the selection of the optimal code vector.

W₈(k) W₈(k)10⁻¹⁰, 0≦k<κ₈(0) or κ₈(7)≦k≦K₈. (2.3.7-6)

The spectral weight vectors at subframes 4 and 8 are averaged over subbands to serve as spectral weights for quantizing the subband mean vectors:

$${\overline{W}}_{m} ( i ) = \frac{1}{{κ}_{m} ( i + 1 ) - {κ}_{m} ( i )} {\sum }_{k = {κ}_{m} ( i )}^{{κ}_{m} ( i + 1 ) - 1} {W}_{m} ( k ) , 0 \leq i \leq 6 , m = \text{4,8} . \qquad \text{(2.3.7-8)}$$

The mean vectors at subframes 4 and 8 are predicted based on the quantized mean vectors at subframes 0 and 4 respectively. A precomputed DC vector {P_{DC}_{_{—}}_{UV}(i),0≦i≦6}, specified by

P_{DC}_{_{—}}_{UV}={1.51, 1.40, 1.35, 1.38, 1.38, 1.40, 1.42}. (2.3.7-9)

is subtracted from the mean vectors prior to prediction. The resulting prediction error vectors are vector quantized using preferably a 7 bit codebook. The prediction error vectors are matched against the codebook using a spectrally weighted MSE distortion measure. The distortion measure is computed as

$$\begin{matrix}{D}_{PWM\_UV} ( m , l ) = {\sum }_{i = 0}^{6} {\overline{W}}_{m} ( i ) [ {V}_{PWM\_UV} ( l , i ) - \\ {\{ {\overline{P}}_{m} ( i ) - {P}_{DC\_UV} ( i ) - {α}_{uv} ( i ) ( {\overline{P}}_{( m - 4 ) q} ( i ) - {P}_{DC\_UV} ( i ) ) \} ]}^{2} 0 \leq l \leq 127 , m = \text{4,8.}\end{matrix} \qquad \text{(2.3.7-10)}$$

Here, {V_{PWM}_{_{—}}_{UV}(l,i),0≦l≦127,0≦i≦6} is the 7-dimensional, 128 level unvoiced mean codebook and {αᵤᵥ(i),0≦i≦6} are the prediction coefficients for the 7 subbands. The prediction coefficients are fixed at:

αᵤᵥ={0.191, 0.092, 0.163, 0.059, 0.049, 0.067, 0.083}. (2.3.7-11)

Let

$${l}_{PWM\_UV \_ 4}^{*} and {l}_{PWM\_UV \_ 8}^{*}$$

be the codebook indices that minimize the above distortion for subframes 4 and 8 respectively, i.e.,

$${D}_{PWM\_UV} ( m , {l}_{PWM\_UV \_m}^{*} ) = {MIN}_{0 \leq l \leq 127} {D}_{PWM\_UV} ( m , l ) , m = \text{4,8.} \qquad \text{(2.3.7-12)}$$

The quantized subband mean vectors are given by a summation of the optimal code vectors to the DC vector and the predicted component:

$${\overline{P}}_{m} ( i ) = MAX ( 0.1 , {α}_{uv} ( i ) ( {\overline{P}}_{( m - 4 ) q} ( i ) - {P}_{DC\_UV} ( i ) ) + {P}_{DC\_UV} ( i ) + {V}_{PWM\_UV} ( {l}_{PWM\_UV \_m}^{*} , i ) ) 0 \leq i \leq 6 , m = \text{4,8} . \qquad \text{(2.3.7-13)}$$

Since the mean vector is an average of PW magnitudes, it should be nonnegative. This is enforced by the maximization operation in the above equation.

The quantized subband mean vectors are used to derive the PW deviations vectors. This provides compensation for the quantization error in the mean vectors during the quantization of the deviations vectors. Deviations vectors are computed for subframes 4 and 8 by subtracting fullband vectors constructed using quantized mean vectors from original PW magnitude vectors. The fullband vectors are obtained by piecewise-constant approximation across each subband:

$${S}_{m} ( k ) = \{ \begin{matrix} 0 & k < {κ}_{m} ( i ) , & \\ {\overline{ P}}_{mq} ( i ) , & {κ}_{m} ( i ) \leq k < {κ}_{m} ( i + 1 ) , 0 \leq i \leq 6 , & m = 4 , 8 , \\ {\overline{ P}}_{mq} ( 6 ) & {κ}_{m} ( 7 ) \leq k \leq {K}_{m} . & \end{matrix} \qquad \text{(2.3.7-14)}$$

The PW deviation vector for the m^{th} subframe has a dimension of Kₘ+1, which lies in the range 11-61, depending on the pitch frequency. In order to quantize this vector, it is desirable to convert it into a fixed dimension vector with a small dimension. This is possible if the elements of this vector can be prioritized in some sense, i.e., if more important elements can be distinguished from less important elements. In such a case, a certain number of important elements can be retained and the rest can be discarded. A criterion that can be used to prioritize these elements can be derived by noting that in general, the spectral components that lie in the vicinity of speech formant peaks are more important than those that lie in regions of lower spectral amplitude or valleys. However, the input speech power spectrum cannot be used directly, since this information is not available to the decoder 100B. Note that the decoder100B should also be able to map the selected elements to their correct locations in the full dimension vector. To permit this, the power spectrum provided by the quantized LPC parameters, which is an approximation to the speech power spectrum to within a scale constant is used. Since the quantized LPC parameters are identical at the encoder 100A and the decoder 100B in the absence of channel errors, the locations of the selected elements can be deduced at the decoder 100B.

The power spectrum estimate provided by the quantized LPC parameters, evaluated at pitch harmonic frequencies, is given by

$${W}_{m}^{′} ( k ) = \frac{1}{\vert {\sum }_{l = 0}^{10} {\hat{a}}_{l} ( m ) {ⅇ}^{- {jω}_{m} kl} {\vert}^{2}} 0 \leq k \leq {K}_{m} . \qquad \text{(2.3.7-15)}$$

However, it is desirable to modify this estimate so that the formant bandwidths are broadened. Otherwise, the weights for low frequency components can be excessive, resulting in poor quantization of mid and high frequency components. A bandwidth broadened spectral weight function was computed for the PW mean quantization. This function is also well suited to serve as a power spectrum estimate for the selection and spectral weighting of the PW deviations. Since the deviation vectors are preferably quantized for subframes 4 and 8, the power spectrum estimates W₄ and W₈, computed earlier using equations 2.3.7-5, -6 and -7, are used.

The formant peak regions are identified by sorting the elements of the power spectrum estimate based on the spectral amplitudes. The selection is biased toward low and mid frequencies by restricting it to the lower K′ₘ+1 of the possible Kₘ+1 harmonics, where K′ₘ is computed by

$${K}_{m}^{′} = \{ \begin{matrix}MIN ( {K}_{m} , {κ}_{m} ( 4 ) + 7 ) & {N}_{sel} \leq {κ}_{m} ( 4 ) , & \\ MIN ( {K}_{m} , {κ}_{m} ( 5 ) + 7 ) & {κ}_{m} ( 4 ) < {N}_{sel} \leq {κ}_{m} ( 5 ) , & \\ MIN ( {K}_{m} , {κ}_{m} ( 6 ) + 7 ) & {κ}_{m} ( 5 ) < {N}_{sel} \leq {κ}_{m} ( 6 ) , & m = 4 , 8. \\ MIN ( {K}_{m} , {κ}_{m} ( 7 ) + 7 ) & {κ}_{m} ( 6 ) < {N}_{sel} \leq {κ}_{m} ( 7 ) , & \\ {K}_{m } & {κ}_{m} ( 7 ) < {N}_{sel} . & \end{matrix} \qquad \text{(2.3.7-16)}$$

The K′ₘ+1 elements of Wₘ are sorted in an ascending order of amplitude. Let

$$\{ {μ}_{m}^{″} ( k ) , 0 \leq k \leq {K}_{m}^{′} , m = 4 , 8 \}$$

define a mapping from the natural order to the ascending order, such that

$${W}_{m} ( {μ}_{m}^{″} ( {k}_{2} ) ) \geq {W}_{m} ( {μ}_{m}^{″} ( {k}_{1} ) ) if 0 \leq {k}_{1} \leq {k}_{2} \leq {K}_{m}^{′} . \qquad \text{(2.3.7-17)}$$

Then, the set of Nₛₑₗ highest valued elements of Wₘ can be indexed as shown below:

$$\{ {W}_{m} ( {μ}_{m}^{″} ( k ) ) , {K}_{m}^{′} - {N}_{sel} < k \leq {K}_{m}^{′} \} . \qquad \text{(2.3.7-18)}$$

When the pitch frequency is large, some of the PW mean subbands may contain a single harmonic. In this case, this harmonic is entirely represented by the PW mean and the PW deviation is guaranteed to be zero valued. It is inefficient to select such components of PW deviation for encoding. To eliminate this possibility, the sorted order vector μ″ is modified by examining the highest Nₛₑₗ elements. If any of these elements correspond to single harmonics in the subband which they occupy, these elements are unselected and replaced by a previously unselected element which is not a single harmonic in its band with the next highest Wₘ value. Let {μ′ₘ(k),0≦k≦K′ₘ,m=4,8} denote the modified sorted order. The highest Nₛₑₗ indices of μ′ indicate the selected elements of PW deviations for encoding.

A second reordering is performed to improve the performance of predictive encoding of PW deviation vector. For predictive quantization, it is advantageous to order the last Nₛₑₗ elements of μ′ (i.e., the indices of the Nₛₑₗ selected elements of PW deviations vector) based on index values. In an embodiment of the invention, descending order has been used. In another embodiment of the invention, ascending order is used. Let {μₘ(k),1≦k≦Nₛₑₗ} denote the last Nₛₑₗ elements of μ′ i.e, {μ′ₘ(k),K′ₘ−Nₛₑₗ<k≦K′ₘ}, reordered and reindexed in this manner. Then μₘ(k) satisfies

{μₘ(k₁)>μₘ(k₂)), 1≦k₁<k₂≦Nₛₑₗ}. (2.3.7-19)

This reordering ensures that a lower (higher) frequency components are predicted using lower (higher) frequency components as long as the pitch frequency variations are not large. It should be noted that since this reordering is within the subset of selected indices, it does not alter the set of selected elements, but merely the order in which they are arranged in the quantizer input vector. This set of elements in the PW deviation vector is selected as the Nₛₑₗ most important elements for encoding. The fullband PW deviation vector is determined by subtracting the fullband reconstruction of the quantized PW mean vector from the PW magnitude vector, for subframes 4 and 8:

Fₘ(k)=\sqrt{P′ₘ(k)}−Sₘ(k), 0≦k≦Kₘ,m=4,8. (2.3.7-20)

Only the Nₛₑₗ selected harmonics of the PW deviation vector, i.e., {Fₘ(μₘ(k)),1≦k≦Nₛₑₗ,m=4,8} are quantized. A typical value of Nₛₑₗ, which has been used in—a preferred embodiment of this invention, is Nₛₑₗ=10. In subsequent discussions, it will be assumed that the dimension of the deviations vector is 10.

At the PW deviation predictive VQ module 110B, the PW deviations vector is encoded by a predictive vector quantizer. A first order scalar predictor with a prediction coefficient βᵤᵥ=0.10 is employed. Prediction is based on the preceding quantized PW deviation vector. It should be further noted that, since the selected harmonics may be different in succeeding deviations vectors, prediction has to be performed using fullband deviation vectors. Further, since the dimension of the vector is also varying, it is necessary to equalize the dimensions of the preceding and current deviation vectors, before prediction can be performed. If there is no pitch multiplicity between the preceding and current vectors, the shorter vector is padded with zeros to bring it up to the dimension of the longer vector. If there is a pitch multiplicity, i.e., the pitch frequency of the shorter vector is roughly n-times, n being an integer, the pitch frequency of the longer vector, it also becomes necessary to interlace elements of the shorter vector by n zeros to equalize the dimensions. Since only the selected elements of PW deviations are being encoded, it is necessary to compute the prediction error only for the selected elements. The quantization of deviations vectors is carried out by a 6-bit vector quantizer using spectrally weighted MSE distortion measure.

$${D}_{PWD\_UV} ( m , l ) = {\sum }_{k = 1}^{10} {{W}_{m} ( {μ}_{m} ( k ) ) [ {V}_{PWD\_UV} ( l , k ) - \{ {F}_{m} ( {μ}_{m} ( k ) ) - {β}_{uv} {\tilde{F}}_{m - 4} ( {μ}_{m} ( k ) ) \} ]}^{2} 0 \leq l \leq 63 , m = 4 , 8. \qquad \text{(2.3.7-21)}$$

Here, {V_{PWD}_{_{—}}_{UV}(l,k),0≦l≦63,1≦k≦10} is the 10-dimensional, 64 level unvoiced deviations codebook. Let

$${l}_{PWD\_UV \_ 4}^{*} and {l}_{PWD\_UV \_ 8}^{*}$$

be the codebook indices that minimize the above distortion for subframes 4 and 8 respectively, i.e.,

$${D}_{PWD\_UV} ( m , {l}_{PWD\_UV \_m}^{*} ) = {MIN}_{0 \leq l \leq 63} {D}_{PWD\_UV} ( m , l ) , m = 4 , 8. \qquad \text{(2.3.7-22)}$$

The quantized deviations vectors are obtained by a summation of the optimal codevectors and the prediction using the preceding quantized deviations vector \tilde{F}ₘ₋₄:

$${\tilde{F}}_{m} ( {μ}_{m} ( k ) ) = {β}_{uv} {\tilde{F}}_{m - 4} ( {μ}_{m} ( k ) ) + {V}_{PWD\_UV} ( {l}_{PWD\_UV \_m}^{*} , k ) 1 \leq k \leq 10 , m = 4 , 8. \qquad \text{(2.3.7-23)}$$

The two 7-bit mean quantization indices

$${l}_{PWM\_UV \_ 4}^{*} , {l}_{PWM\_UV \_ 8}^{*}$$

and the two 6-bit deviation indices

$${l}_{PWM\_UV \_ 4}^{*} , {l}_{PWM\_UV \_ 8}^{*}$$

represent the PW magnitude information for unvoiced frames using a total of 26 bits.

For voiced frames, the PW subband mean vector is quantized preferably only for subframe 8. This is due to the higher degree of stationarity encountered during voiced frames. The PW magnitude vector smoothing, the computation of harmonic subband edges and the PW subband mean vector at subframe 8 take place in a manner identical to the case of unvoiced frames. A predictive VQ approach is used where the quantized PW subband mean vector at subframe 0 i.e., subframe 8 of previous frame, is used to predict the PW subband mean vector at subframe 8. A vector prediction with prediction coefficients for the 7 subbands specified by

α_{ν}={0.497, 0.410, 0.618, 0.394, 0.409, 0.409, 0.400}. (2.3.7-24)

is used. It should be noted that these prediction coefficients are significantly higher than those used for the unvoiced frames. This is indicative of the higher degree of correlation across 8 subframes of voiced frames than unvoiced frames across 4 subframes, supporting the assumption of stationarity during voiced frames. A predetermined DC vector specified by

P_{DC}_{_{—}}_{V}={1.93, 1.54, 1.26, 1.40, 1.39, 1.34, 1.38}. (2.3.7-25)

is subtracted prior to prediction. The resulting prediction error vectors are quantized by preferably a 7-bit codebook using a spectrally weighted MSE distortion measure. The subband spectral weight vector is computed for subframe 8 as in the case of unvoiced frames. The prediction error vectors are matched against the codebook using a spectrally weighted MSE distortion measure. The distortion measure is computed as

$${D}_{{}_{PWM\_V}} ( l ) = {\sum }_{i = 0}^{6} {\overline{W}}_{8} ( i ) [ {V}_{{}_{PWM\_V}} ( l , i ) - {\{ {\overline{P}}_{8} ( i ) - {P}_{DC\_V} ( i ) - {β}_{v} ( i ) ( {\overline{P}}_{0 q} ( i ) - {P}_{DC\_V} ( i ) \} ]}^{2} 0 \leq l \leq 127. \qquad \text{(2.3.7-26)}$$

where, {V_{PWM}_{_{—}}_{V}(l,i),0≦l≦127,0≦i≦6} is the 7-dimensional, 128 level voiced mean codebook, {P_{DC}_{_{—}}_{V}(i),0≦i≦6} is the voiced DC vector. {\overline{P}_{0q}(i),0≦i≦6} is the predictor state vector which is same as the quantized PW subband mean vector at subframe 8 (i.e., {\overline{P}_{8q}(i),0≦i≦6}) of the previous frame. Let

$${l}_{PWM\_V}^{*}$$

be the codebook index that minimizes the above distortion, i.e.,

$${D}_{{}_{PWM\_V}} ( {l}_{PWM\_V}^{*} ) = {MIN}_{0 \leq l \leq 127} {D}_{{}_{PWM\_V}} ( l ) . \qquad \text{(2.3.7-27)}$$

The quantized subband mean vector at subframe 8 is given by adding the optimal codevector to the predicted vector and the DC vector:

$${\overline{P}}_{8 q} ( i ) = MAX ( 0.1 , {P}_{DC\_V} ( i ) + {β}_{v} ( i ) ( {\overline{P}}_{0 q} ( i ) - {P}_{DC\_V} ( i ) ) + {V}_{{}_{PWM\_V}} ( {l}_{PWM\_V}^{*} , i ) ) 0 \leq i \leq 6.$$

(2.3.7-28)

Since the mean vector is an average of PW magnitudes, it should be nonnegative. This is enforced by the maximization operation in the above equation.

A fullband mean vector {S₈(k),0≦k≦K₈} is constructed at subframe 8 using the quantized subband mean vector, as in the unvoiced mode. A subband mean vector is constructed for subframe 4 by linearly interpolating between the quantized subband mean vectors of subframes 0 and 8:

\overline{P}₄(i)=0.5(\overline{P}_{0q}(i)+\overline{P}_{8q}(i)) 0≦i≦6. (2.3.7-29)

A fullband mean vector {S₄(k),0≦k≦K₄} is constructed at subframe 4 using this interpolated subband mean vector. By subtracting these fullband mean vectors from the corresponding magnitude vectors, deviations vectors {F₄(μ₄(k)),1≦k≦10} and {F₈(μ₄(k)),1≦k≦10} are computed at subframes 4 and 8. It should be noted that these deviations vectors are computed only for selected harmonics, as given by {μₘ(k),1≦k≦10,m=4,8}. The selection of harmonics is also substantially identical to the case of unvoiced frames. The deviations vectors are predictively quantized based on prediction from the preceding quantized deviation vector i.e, subframe 4 is predicted using subframe 0, and subframe 8 using subframe 4. A prediction coefficient of β_{ν}=0.56 is used. Note that this prediction coefficient is significantly higher than the prediction coefficient of 0.10 used for the unvoiced case. This reflects the increased degree of correlation present for voiced frames.

The deviations prediction error vectors are quantized using a multi-stage vector quantizer with 2 stages. The 1^{st} stage uses preferably a 64-level codebook and the 2^{nd} stage uses preferably a 16-level codebook. A sub-optimal search which considers only the 8 best candidates from the 1^{st} codebook in searching the 2^{nd} codebook is used to reduce complexity. The distortion measures are spectrally weighted. The spectral weight vectors {W₄(k)}, and {W₈(k)} are computed as in the unvoiced case. The 1^{st} codebook uses the following distortion to find the 8 code vectors with the smallest distortion:

$${D}_{{}_{PWD\_V1}} ( m , l ) = {\sum }_{k = 1}^{10} {{W}_{m} ( {μ}_{m} ( k ) ) [ {V}_{{}_{PWD\_V1}} ( l , k ) - \{ {F}_{m} ( {μ}_{m} ( k ) ) - {β}_{v} {\tilde{F}}_{m - 4} ( {μ}_{m} ( k ) ) \} ]}^{2} 0 \leq l \leq 63 , m = \text{4,8} . \qquad \text{(2.3.7-30)}$$

where {j_{PWD}_{_{—}}_{V}_{_{—}}ₘ(i),0≦i≦7} is the 8 indices associated with the 8 best code words. The entire 2^{nd} codebook is searched for each of the 8 code vectors from the 1^{st} codebook, so as to minimize the distortion between the input vector and the sum of the 1^{st} and 2^{nd} codebook vectors:

$${MIN}_{{{1}_{i} ∈ {j}_{PWD\_V \_m}}_{0 \leq {l}_{2} \leq 15}} {D}_{{}_{PWD\_V}} ( m , l ) = {\sum }_{k = 1}^{10} {{W}_{m} ( {μ}_{m} ( k ) ) [ {V}_{{}_{PWD\_V1}} ( {l}_{1} , k ) + {V}_{{}_{PWD\_V2}} ( {l}_{2} , k ) - \{ {F}_{m} ( {μ}_{m} ( k ) ) - {β}_{v} {\tilde{F}}_{m - 4} ( {μ}_{m} ( k ) ) \} ]}^{2} m = \text{4,8} . \qquad \text{(2.3.7-31)}$$

where

$${l}_{1} = {l}_{PWD\_V1 \_ 4}^{*} and {l}_{2} = {l}_{PWD\_V2 \_ 4}^{*}$$

minimize the above distortion for subframe 4 and

$${l}_{1} = {l}_{PWD\_V1 \_ 8}^{*} and {l}_{2} = {l}_{PWD\_V2 \_ 8}^{*}$$

minimize the above distortion for subframe 8. The quantized deviations vectors are obtained by a summation of the optimal code vectors and the prediction using the preceding quantized deviations vector \tilde{F}ₘ₋₄:

$${\tilde{F}}_{m} ( {μ}_{m} ( k ) ) = {β}_{v} {\tilde{F}}_{m - 4} ( {μ}_{m} ( k ) ) + {V}_{PWD\_V1} ( {l}_{PWD\_V1 \_m}^{*} , k ) + {V}_{PWD\_V2} ( {l}_{PWD\_V2 \_m}^{*} , k ) 1 \leq k \leq 10 , m = 4 , 8. \qquad \text{(2.3.7-32)}$$

The 7-bit mean quantization index

$${l}_{PWM\_V}^{*} ,$$

the 6-bit index

$${l}_{PWD\_V1 \_ 4}^{*} ,$$

the 4-bit index

$${l}_{PWD\_V1 \_ 4}^{*} ,$$

the 6-bit index

$${l}_{PWD\_V1 \_ 8}^{*}$$

and the 4-bit index

$${l}_{PWD\_V1 \_ 8}^{*}$$

together represent the 27 bits of PW magnitude information for voiced frames.

In the unvoiced mode, the VAD flag is explicitly encoded using a binary index

$${l}_{VAD\_UV}^{*} :$$

$${l}_{VAD\_UV}^{*} = VAD\_FLAG . \qquad \text{(2.3.7-33)}$$

In the voiced mode, it is implicitly assumed that the frame is active speech. Consequently, it is not necessary to explicitly encode the VAD information.

The Table 1 summarizes the bits allocated to the quantization of the encoder parameters under voiced and unvoiced modes. As indicated in Table 1, a single parity bit is included as part of the 80 bit compressed speech packet. This bit is intended to detect channel errors in a set of 24 critical, Class 1 bits. Class 1 bits consist of the 6 most significant bits (MSB) of the PW gain bits, 3 MSBs of 1^{st} LSF, 3 MSBs of 2^{nd} LSF, 3 MSBs of 3^{rd} LSF, 2 MSBs of 4^{th} LSF, 2 MSBs of 5^{th} LSF, MSB of 6^{th} LSF, 3 MSBs of the pitch index and MSB of the nonstationarity measure index. The single parity bit is obtained by performing an exclusive OR operation of the Class 1 bit sequence.

TABLE 1

| | Voiced Mode | Unvoiced Mode |
|---|---|---|
| Pitch | 7 | 7 |
| LSF Parameters | 32 | 32 |
| PW Gain | 8 | 8 |
| PW Correlation & voicing Measure | 5 | 5 |
| PW Magnitude | | |
| Mean | 7 | 14 |
| Deviations | 20 | 12 |
| VAD Flag | 0 | 1 |
| Parity Bit | 1 | 1 |
| Total/20 ms Frame | 80 | 80 |

FIG. 7 is a block diagram illustrating an example of a decoder 100B operating in accordance with an embodiment of the present invention. Specifically, the decoder 100B comprises a LP Decoder and Interpolation module 702, a Pitch Decoder and Interpolation module 704, a Gain Decoder and Interpolation module 706, an Adaptive Bandwidth Broadening module 708, a PW Mean Decoding module 120A, a PW Deviations Decoding module 120B, a Harmonic Selection module 120C, a PW Magnitude Reconstruction module 120D, a PW magnitude Interpolation module 120E, a PW Phase Model module 122A, a PW Magnitude Scaling module 122B, a PW Gain Scaling module 124, an Interpolative Synthesis module 126, an All-Pole Synthesis Filter module 128A and Adaptive Post Filter module 128B.

FIG. 7 will now be described in general. The decoder 100B receives the quantized LP parameters from the encoder 100A. The quantized LP parameters are processed by the LP Decoder and Interpolation module 702. The LP Decoder Interpolation module 702 performs inverse quantization where the bits are mapped to the LP parameters. The LP parameters are interpolated to each one of preferably 8 subframes. A frame is preferably 160 samples which is about 20 ms. A subframe is preferably 20 samples which is about 2.5 ms.

The Pitch Decoder and Interpolation module 704 performs inverse quantization on pitch parameters received from the encoder 100A. A table lookup is used to provide a 7 bit index which is a pitch lag value and converted to a pitch frequency. Pitch interpolation is performed linearly on a sample by sample basis which provides for an interpolated pitch contour for each sample within the frame.

The Gain Decoder and Interpolation module 706 performs inverse quantization on the PW gain parameters received from the encoder 100A. The gains are transmitted from the encoder 100A wherein the 8 PW subframe gains are decimated by a factor of 2 and then encoded using 8 bits. After inverse quantization, the decimated gain parameters at subframes 2, 4, 6 and 8 are obtained. The intermediate PW gain parameters are then obtained by interpolation.

The LP parameters are provided to the Harmonic Selection module 120C. The LP Parameters provide the Harmonic Selection module 120C with the formant structure. From the formant structure it can be determined where the perceptually most significant harmonics are, which allows the PW Deviations Decoding module 120B to determine the harmonics that were selected by the encoder 100A.

The PW Deviations Decoding module 120B uses the selected harmonics to decode the quantized PW deviations for subframes 4 and 8, received from the encoder 100A. That is, the quantized PW deviations are inverse quantized to yield the deviations from the appropriate subband mean at the selected harmonics. The predictors and codebooks required in the inverse quantization depends on the voicing measure.

The quantized PW mean is received by the PW Mean Decoding module 120A from the encoder 100A. The quantized PW mean is a 7 band vector and is inverse quantized using predictors and codebooks that depend on the voicing measure. The voicing measure is provided to the PW Mean Decoding module 120A and the PW Deviations Decoding module 120B.

The PW Mean Decoding module 120A and the PW Deviations Decoding module 120B provide a PW mean and a PW deviation, respectively, to the PW Magnitude Reconstruction module 120D where the PW magnitude is reconstructed. The reconstructed PW magnitude is interpolated at the PW Magnitude Interpolation module 120E and mapped to each of the 8 subframes.

The quantized PW subband correlation and voicing measure is received at the PW Phase Model module 122A and constructed into PW phase vectors. The PW phase vectors are provided to the PW Magnitude Scaling module 122B which combines the PW magnitude and phase vectors into complex PW vectors. The complex PW vectors are multiplied by a corresponding gain at the PW Gain Scaling module 124. The excitation or residual signal level has now been restored to the level it was at the encoder 100A.

The Interpolative Synthesis module 126 provides a residual signal which is an inverse DFT. The All-Pole Synthesis Filter 128A removes the formant structure. It uses the interpolated LP parameters to determine the parameters of the filter to generate a speech signal.

The Adaptive Bandwidth Broadening module 708 reduces the spectral peakiness of the to noise signals in the absence of a voice signal. This makes the background noise sound softer and less objectionable. When speech is detected, adaptive bandwidth broadening is not performed on the interpolated LP parameters. The Adaptive Post Filter module 128B amplifies the format regions and suppress the non-format regions. That is, the regions where the SNR is poor is suppressed. Therefore, the overall coding distortion is suppressed.

FIG. 7 will now be described in detail. The decoder 100B receives the 80 bit packet of compressed speech produced by the encoder 100A and reconstructs a 20 ms segment of speech. The received bits are unpacked to obtain quantization indices for LSF parameter vector, pitch period, PW gain vector, PW subband correlation vector and the PW magnitude vector. A cyclic redundancy check (CRC) flag is set if the frame is marked as a bad frame due to frame erasures or if the parity bit which is part of the 80 bit compressed speech packet is not consistent with the class 1 bits comprising the gain, LSF, pitch and PW subband correlation bits. Otherwise, the CRC flag is cleared. If the CRC flag is set, the received information is discarded and bad frame masking techniques are employed to approximate the missing information.

Based on the quantization indices, LSF parameters, pitch, PW gain vector, PW subband correlation vector and the PW magnitude vector are decoded. The LSF vector is converted to LPC parameters and linearly interpolated for each subframe. The pitch frequency is interpolated linearly for each sample. The decoded PW gain vector is linearly interpolated for odd indexed subframes. The PW magnitude vector is reconstructed depending on the voicing measure flag, obtained from the nonstationarity measure index. The PW magnitude vector is interpolated linearly across the frame at each subframe. For unvoiced frames i.e., voicing measure flag=1, the VAD flag corresponding to the look-ahead frame is decoded from the PW magnitude index. For voiced frames, the VAD flag is set to 1 to represent active speech.

Based on the voicing measure and the nonstationarity measure, a phase model is used to derive a PW phase vector for each subframe. The interpolated PW magnitude vector at each subframe is combined with a phase vector from the phase model to obtain a complex PW vector for each subframe.

Out-of-band components of the PW vector are attenuated. The level of the PW vector is restored to the RMS value represented by the PW gain vector. The PW vector, which is a frequency domain representation of the pitch cycle waveform of the residual, is transformed to the time domain by an interpolative sample-by-sample pitch cycle inverse DFT operation. The resulting signal is the excitation that drives the LP synthesis filter 128A, constructed using the interpolated LP parameters.

Prior to synthesis, the LP parameters are bandwidth broadened to eliminate sharp spectral resonances during background noise conditions. The excitation signal is filtered by the all-pole LP synthesis filter to produce reconstructed speech. Adaptive postfiltering with tilt correction is used to mask coding noise and improve the peceptual quality of speech.

The pitch period is inverse quantized by a simple table lookup operation using the pitch index. The decoded pitch period is converted to the radian pitch frequency corresponding to the right edge of the frame by

$$\hat{ω} ( 160 ) = \frac{2 π}{\hat{p}} . \qquad \text{(3.2-1)}$$

where \hat{p} is the decoded pitch period. A sample by sample pitch frequency contour is created by interpolating between the pitch frequency of the left edge \hat{ω}(0) and the pitch frequency of the right edge \hat{ω}(160):

$$\hat{ω} ( n ) = \frac{( 160 - n ) \hat{ω} ( 0 ) + n \hat{ω} ( 160 )}{160} , 0 \leq n \leq 160. \qquad ( \text{3.2-2)}$$

If there are abrupt discontinuities between the left edge and the right edge pitch frequencies, the above interpolation is modified as in the case of the encoder. Note that the left edge pitch frequency \hat{ω}(0) is the right edge pitch frequency of the previous frame.

The index of the highest pitch harmonic within the 4000 Hz band is computed for each subframe by

$${\hat{K}}_{m} = ⌊ \frac{π}{\hat{ω} ( 20 m )} ⌋ , 1 \leq m \leq 8. \qquad ( \text{3.2-3)}$$

In the case of frames that are either lost or contain errors, the decoded pitch period of the previous frame is used.

The LSFs are quantized by a hybrid scalar-vector quantization scheme. The first 6 LSFs are scalar quantized using a combination of intraframe and interframe prediction using 4 bits/LSF. The last 4 LSFs are vector quantized using 8 bits.

The inverse quantization of the first 6 LSFs can be described by the following equations:

$$\hat{λ} ( m ) = \{ \begin{matrix} {S}_{L , m} ( {l}_{L\_S \_m}^{*} ) + 0.375 {\hat{λ}}_{prev} ( m + 1 ) , m = 0 \\ {S}_{L , m} ( {l}_{L\_S \_m}^{*} ) + 0.375 ( {\hat{λ}}_{prev} ( m + 1 ) - {\hat{λ}}_{prev} ( m - 1 ) ) + \hat{λ} ( m - 1 ) , 1 \leq m \leq 5.\end{matrix} \qquad \text{(3.3-1)}$$

where,

$$\{ {l}_{L\_S \_m}^{*} ,$$

0≦m<6} are the scalar quantizer indices for the first 6 LSFs, {\hat{λ}(m),0≦m<6} are the first 6 decoded LSFs of the current frame and {\hat{λ}ₚᵣₑᵥ(m),0≦m≦10} are the decoded LSFs of the previous frame. {S_{L,m}(l),0≦m<6,0≦l≦15} are the 16 level scalar quantizer tables for the first 6 LSFs.

The last 4 LSFs are inverse quantized based on the predetermined mean values λ_{dc}(m) and the received vector quantizer index for the current frame:

$$\hat{λ} ( m ) = {V}_{L} ( {l}_{L\_V}^{*} , m - 6 ) + {λ}_{d c} ( m ) + 0.5 ( {\hat{λ}}_{prev} ( m ) - {λ}_{d c} ( m ) ) , 6 \leq m \leq 9. \qquad ( 3.3 \text{-} 2 )$$

where,

$${l}_{L\_V}^{*}$$

is the vector quantizer index for the last 4 LSFs, {\hat{λ}(m),0≦m<6} and {V_{L}(l,m),0≦l≦255,0≦m<3} is the 256 level, 4-dimensional codebook for the last 4 LSFs. The stability of the inverse quantized LSFs is checked by ensuring that the LSFs are monotonically increasing and are separated by preferably a minimum value of 0.005. If this property is not satisfied, stability is enforced by reordering the LSFs in a monotonically increasing order. If a minimum separation is not achieved, the most recent stable LSF vector from a previous frame is substituted for the unstable LSF vector.

In the case of frames that are either lost or contain errors, the decoded LSF of the previous frame is used for the current frame. In the case of the first good frame after one or more lost frames, the average of the decoded LSF and the decoded LSF of the previous frame is used as the LSF vector for the current frame.

When the received frame is inactive, the decoded LSF's are used to update an estimate for background LSF's using the following recursive relationship:

λ_{bgn}(m)=0.95λ_{bgn}(m)+0.05\hat{λ}(m), 0≦m≦9. (3.3.-3)

These LSFs are used for the generation of comfort noise in a discontinuous transmission (DTX) mode.

The inverse quantized LSFs are interpolated each subframe by linear interpolation between the current LSFs {\hat{λ}(m),0≦m≦10} and the previous LSFs {\hat{λ}ₚᵣₑᵥ(m),0≦m≦10}. The interpolated LSFs at each subframe are converted to LP parameters {\hat{α}ₘ(l),0≦m≦10,1≦l≦8}. Inverse quantization of the PW subband correlation and the voicing measure is a table lookup operation. If l*_{R} is the index of the composite correlation and the voicing measure, the decoded PW subband correlation is

^₁(i)=V_{R}(l*_{R},i), 1≦i≦5. (3.4-1)

where, {V_{R}(l,m), 0≦l≦31,1≦m≦6} is the 32 level, 6-dimensional codebook used for the vector quantization of the composite nonstationarity measure vector. The decoded voicing measure is

\hat{ν}=V_{R}(l*_{R},6). (3.4-2)

A voicing measure flag is also created based on l*_{R} as follows:

$${\hat{v}}_{flag} = \{ \begin{matrix}0 & {l}_{R}^{*} > 7 \\ 1 & {l}_{R}^{*} \leq 7.\end{matrix} \qquad ( 3.4 \text{-} 3 )$$

This flag determines the mode of inverse quantization used for PW magnitude.

In the case of frames that are either lost or contain errors, the decoding of PW Subband Correlation and voicing measure is modified to minimize degradation and error propagation. The index l*_{R} is modified as follows:

$${l}_{R}^{*} ⇐ \{ \begin{matrix}MAX ( 0 , MIN ( {l}_{R\_PREV}^{*} , 8 ) - 1 ) & if {\hat{g}}_{avg} < 1.1 {Gavg}_{u v} \\ MAX ( {l}_{R\_PREV}^{*} , 8 ) & if {\hat{g}}_{avg} > 1.4 {Gavg}_{u v} . \\ {l}_{R\_PREV}^{*} & Otherwise .\end{matrix} \qquad ( 3.4 .1 \text{-} 1 )$$

In other words, if the gain of the preceding frame is below the gain threshold for unvoiced frames, the index is forced to lie within the unvoiced range. If it is well above the gain threshold for unvoiced frames, the index is forced to lie within the voiced range. Otherwise, the index of the previous frame,

$${l}_{R\_PREV}^{*}$$

is used to replace l*_{R}. The modifed index is then used to decode the PW Subband Correlation and voicing measure.

The gain vector is inverse quantized by a table look-up operation followed by the addition of the predicted average gain component. If l*_{R} is the gain index, the gain values for the even indexed subframes are obtained by

$${\hat{g}}_{pw}^{′} ( 2 m ) = {V}_{g} ( {l}_{g}^{*} , m ) + {α}_{g} {\hat{g}}_{d c} , 1 \leq m \leq 4. \qquad ( 3.5 \text{-} 1 )$$

where, {V_{g}(l,m), 0≦l≦255,1≦m≦4} is the 256 level, 4-dimensional gain codebook. α_{g} is the gain prediction coefficient, whose typical value is 0.75. ĝ_{dc} is a predicted average gain value for the frame, computed based on the quantized gain vector of the preceding frame,

$$\{ {g}_{pw , prev}^{″} ( m ) , m = 2 , 4 , 6 , 8 \} ,$$

as follows:

$${\hat{g}}_{d c} = \frac{1}{4} {\sum }_{i = 1}^{4} {\hat{g}}_{pw , prev}^{″} ( 2 i ) . \qquad ( 3.5 \text{-} 2 )$$

The inverse quantized gain vector components are limited to the range 0.0 dB-4.5 dB, as was the encoder gain vector:

$${\hat{g}}_{pw}^{′′} ( 2 m ) = \{ \begin{matrix}MAX ( {\hat{g}}_{pw}^{′} ( 2 m ) , 0.0 ) \\ MIN ( {\hat{g}}_{pw}^{′} ( 2 m ) , 4.5 )\end{matrix} 1 \leq m \leq 4. \qquad ( 3.5 \text{-} 3 )$$

The gain values for the odd indexed subframes are obtained by linearly interpolating between the even indexed values:

$$\begin{matrix}{\hat{g}}_{pw}^{″} ( 2 m - 1 ) = 0.5 ( {\hat{g}}_{pw}^{″} ( 2 m - 2 ) + {\hat{g}}_{pw}^{″} ( 2 m ) ) , & 1 \leq m \leq 4.\end{matrix} \qquad ( 3.5 \text{-} 4 )$$

The gain values are now expressed in logarithmic units. They are converted to linear units by

$$\begin{matrix}{\hat{g}}_{pw} ( m ) = {10}^{{\hat{g}}_{pw}^{″} ( m )} , & 1 \leq m \leq 8.\end{matrix} \qquad ( 3.5 \text{-} 5 )$$

This gain vector is used to restore the level of the PW vector during the generation of the excitation signal.

In the case of frames that are erased or contain errors (as indicated by a cyclic redundancy check (CRC) mechanism, the inverse quantization of the gain vector is modified to reduce the propagation of the error induced distortion in to future frames. For such a frame, the inverse quantization of equation 3.5-1 is modified to:

$$\begin{matrix}{\hat{g}}_{pw}^{′} ( 2 m ) = {α}_{g}^{′} {\hat{g}}_{dc} , & 1 \leq m \leq 4.\end{matrix} \qquad ( 3.5 \text{-} 6 )$$

Thus, the received gain index is ignored and the gain vector is computed based on the predicted average gain alone. The value of the modified gain prediction coefficient α′_{g} is typically 0.98. This forces the inverse quantized gain vector to decay to lower values until a good frame is received.

Based on the decoded gain vector in the log domain, long term average gain values for inactive frames and active unvoiced frames are computed. These gain averages are useful in identifying inactive frames that were marked as active by the VAD. This can occur due to the hangover employed in the VAD or in the case of certain background noise conditions such as babble or cafeteria noise. By identifying such frames, it is possible to improve the performance of the codec 100 for background noise conditions. This process is based on an average gain computed for the entire frame:

$${\hat{g}}_{avg} = \frac{1}{8} {\sum }_{m = 1}^{8} {\hat{g}}_{pw}^{″} ( m ) . \qquad ( 3.5 \text{-} 7 )$$

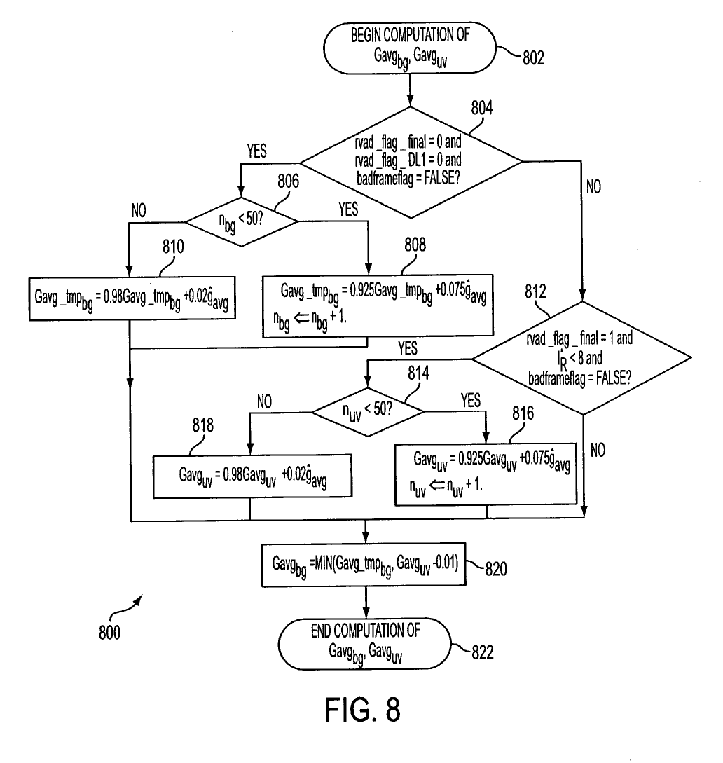

This is used to update long term average gains for inactive frames which represent the background signal and unvoiced frames, according to the flowchart 800 in FIG. 8.

FIG. 8 is a flowchart illustrating an example of steps for computing gain averages in accordance with an embodiment of the present invention. The method 800 is performed at the decoder 100B in module 706 prior to processing in module 708. and is initiated at 802 where computation of Gavg_{bg} and Gavgᵤᵥ begins. The method 800 then proceeds to step 804 where a determination is made as to whether rvad_flag_final, a measure of voice activity that is discussed later, and rvad_flag_DL1, the current frame's VAD flag, equal zero and the bad frame indicator badframeflag is false is met. If the determination is negative, the method proceeds to step 812.

At step 812 a determination is made as to whether rvad_flag_final equals a one and l_{R} is less than 8 and badframeflag equals false, if the determination is negative the method proceeds to step 820. If the determination is affirmative, the method proceeds to step 814.

At step 814 a determination is made as to whether nᵤᵥ is less than 50. If the determination is answered negatively then the method proceeds to step 816 where Gavgᵤᵥ is calculated using a first equation. If the method is answered negatively, the method proceeds to step 818 where a second equation is used to calculate Gavgᵤᵥ.

If the determination at step 804 is negative, the method proceeds to step 806 where a determination of whether n_{bg} is less than 50 is determined. If the determination is answered negatively, the method proceeds to step 810 where Gavg-tmp_{bg} is calculated using a first equation. If the determination is answered affirmatively, the method proceeds to step 808 where Gavg-tmp_{bg} is calculated using a second equation.

The steps 810, 808, 818, and 816 proceed to step 820 where Gavg_{bg} is calculated. The method then proceeds to step 822 where the computation ends for Gavg_{bg} and Gavgᵤᵥ.

FIG. 8 will now be discussed in more detail. The decoded voicing measure flag determines the mode of inverse quantization of the PW magnitude vector. If \hat{ν}_{flag} is 0, voiced mode is used. If \hat{ν}_{flag} is 1, unvoiced mode is used.

In the voiced mode, PW mean is preferably transmitted once per frame for subframe 8 and the PW deviation is preferably transmitted twice per frame for subframes 4 and 8. In the unvoiced mode, both mean and deviation components are preferably transmitted twice per frame for subframes 4 and 8. Interframe predictive quantization is used for both voiced and unvoiced modes for the mean as well as deviation quantization, with higher prediction coefficients used for the voiced case.

In the unvoiced mode, the VAD flag is explicitly encoded using a binary index

$${l}_{VAD\_UV}^{*} .$$

In this mode, VAD flag is decoded by

$$RVAD\_FLAG = \{ \begin{matrix}0 & {l}_{VAD\_UV}^{*} = 0 \\ 1 & {l}_{VAD\_UV}^{*} = 1.\end{matrix} \qquad ( 3.6 .1 \text{-} 1 )$$

In the voiced mode, it is implicitly assumed that the frame is active speech. Consequently, it is not necessary to explicitly encode the VAD information. VAD flag is set to 1 indicating active speech in the voiced mode:

RVAD_FLAG=1. (3.6.1-2)

Note that RVAD_FLAG is the VAD flag corresponding to the look-ahead frame.

In the case of frames that are either lost or contain errors, the decoding of VAD flag is modified to minimize degradation and error propagation. The following equations specify the computation of RVAD_FLAG for bad frames:

$$RVAD\_FLAG = \{ \begin{matrix}0 & if RVAD\_FLAG \_DL1 = 1 and {\hat{g}}_{avg} < 0.4 {Gavg}_{uv} + 0.6 {Gavg}_{bg} \\ 0 & if RVAD\_FLAG \_DL1 \neq 1 and {\hat{g}}_{avg} < 0.6 {Gavg}_{uv} + 0.4 {Gavg}_{bg} . \\ 1 & Otherwise .\end{matrix} \qquad ( 3.6 .2 \text{-} 1 )$$

RVAD_FLAG_DL1 is the VAD flag of the current frame, as described next.

Let RVAD_FLAG, RVAD_FLAG_DL1, RVAD_FLAG_DL2 denote the VAD flags of the look-ahead frame, current frame and the previous frame respectively. A composite VAD value, RVAD_FLAG_FINAL, is determined for the current frame, based on the above VAD flags, according to the following Table 2:

TABLE 2

| RVAD_FLAG_DL2 | RVAD_FLAG_DL1 | RVAD_FLAG | RVAD_FLAG_FINAL | |
|---|---|---|---|---|
| 0 | 0 | 0 | 0 | (3.6.3-1) |
| 0 | 0 | 1 | 1 | |
| 0 | 1 | 0 | 0 | |
| 0 | 1 | 1 | 2 | |
| 1 | 0 | 0 | 1 | |
| 1 | 0 | 1 | 3 | |
| 1 | 1 | 0 | 2 | |
| 1 | 1 | 1 | 3 | |

The RVAD_FLAG_FINAL is 0 for frames in inactive regions, 3 in active regions, 1 prior to onsets and 2 prior to offsets. Isolated active frames are treated as inactive frames and vice versa.

In the unvoiced mode, the mean vectors for subframes 4 and 8 are inverse quantized ad follows:

$$\begin{matrix}{\hat{D}}_{m} ( i ) = MAX ( 0.1 , {α}_{uv} ( i ) ( {\hat{D}}_{m - 4} ( i ) - {P}_{DC\_UV} ( i ) ) + {P}_{DC\_UV} ( i ) + {V}_{PWM\_UV} ( {l}_{PWM\_UV \_m}^{*} , i ) ) \\ 0 \leq i \leq 6 , m = 4 , 8.\end{matrix} \qquad ( 3.6 .4 \text{-} 1 )$$

where, {\hat{D}₄(i),0≦i≦6} and {\hat{D}₈(i),0≦i≦6} are the inverse quantized 7-band subband PW mean vectors, {V_{PWM}_{_{—}}_{UV}(l,i),0≦l≦127,0≦i≦6} is the 7-dimensional, 128 level unvoiced mean codebook.

$${l}_{PWM\_UV \_ 4}^{*} and {l}_{PWM\_UV \_ 8}^{*}$$

are the indices for mean vectors for the 4^{th} and 8^{th} subframes. {P_{DC}_{_{—}}_{UV}(i),0≦i≦6} is the predetermined DC vector and {αᵤᵥ(i),0≦i≦6} is the predetermined vector predictor for the 7 bands. Both of these vectors are identical to those employed at the encoder 100A. Since the mean vector is an average of PW magnitudes, it should be nonnegative. This is enforced by the maximization operation in the above equation.

In the case of frames that are either lost or contain errors, the above is modified ad follows:

\hat{D}ₘ(i)=MAX(0.1,0.5(\hat{D}ₘ₋₄(i)−P_{DC}_{_{—}}_{UV}(i))+P_{DC}_{_{—}}_{UV}(i)) 0≦i≦6,m=4,8. (3.6.4-2)

i.e., the reconstruction is based purely on the previous reconstructed vector.

The deviation vectors for subframes 4 and 8 are inverse quantized by a summation of the optimal codevectors and the prediction using the preceding quantized deviations vector \tilde{F}ₘ₋₄:

$$\begin{matrix}{\hat{F}}_{m} ( {μ}_{m} ( k ) ) = {β}_{uv} {\hat{F}}_{m - 4} ( {μ}_{m} ( k ) ) + {V}_{PWD\_UV} ( {l}_{PWD\_UV \_m}^{*} , k ) & 1 \leq k \leq 10 , m = 4 , 8.\end{matrix} \qquad ( 3.6 .4 \text{-} 3 )$$

This reconstructs the deviations for the selected harmonics. A prediction coeffient of βᵤᵥ=0.10 is used as at the encoder 100A. The sorting arrays {μₘ} are computed as in the case of encoder 100A, based on the LPC power spectral estimates. Since these sorting arrays are based on quantized LPC parameters, the selected harmonics are identical to those used at the encoder 100A, assuming no channel errors. The remaining unselected harmonics are reconstructed as if the code vector is zero valued:

\hat{F}ₘ(k)=βᵤᵥ\hat{F}ₘ₋₄(k) k∉μₘ(k),0≦k≦\hat{K}ₘ,m=4,8. (3.6.4-4)

where, {\hat{F}ₘ(k),1≦k≦Kₘ,m=4,8} are the inverse quantized PW deviation vectors. It should be noted that, as in the case of the encoder 100A, it is necessary to equalize the dimensions of the preceding and current deviations vectors. {V_{PWD}_{_{—}}_{UV}(l,k),0≦l≦63,1≦k≦10} is the 10-dimensional, 64 level unvoiced deviations codebook.

$${l}_{PWD\_UV - 4}^{*} and {l}_{PWD\_UV - 8}^{*}$$

are the received indices for deviations vectors for the 4^{th} and 8^{th} subframes.

In the case of frames that are either lost or contain errors, the inverse quantization in eqn. 3.6.4-3 is modified to include only the preceding quantized deviations vector \tilde{F}ₘ₋₄:

\hat{F}ₘ(μₘ(k))=βᵤᵥ\hat{F}ₘ₋₄(μₘ(k)) 1≦k≦10,m=4,8. (3.6.4-5)

The unselected harmonics are reconstructed as before.

The subband mean vectors are converted to fullband vectors by a piecewise constant approximation across frequency. This requires that the subband edges in Hz are translated to subband edges in terms of harmonic indices. Let the band edges in Hz be defined by the array

B_{pw}=[1 400 800 1200 1600 2000 2400 3000]. (3.6.4-6)

The band edges can be computed by

$${\hat{κ}}_{m} ( i ) = \{ \begin{matrix} 2 + ⌊ \frac{{B}_{pw} ( i ) {\hat{K}}_{m}}{4000} ⌋ & \{ 1 + ⌊ \frac{{B}_{pw} ( i ) {\hat{K}}_{m}}{4000} ⌋ \} < \frac{{B}_{pw} ( i ) π}{4000 {\hat{ω}}_{m}} , \\ ⌊ \frac{{B}_{pw} ( i ) {\hat{K}}_{m}}{4000} ⌋ & ⌊ \frac{{B}_{pw} ( i ) {\hat{K}}_{m}}{4000} ⌋ > \frac{{B}_{pw} ( i ) π}{4000 {\hat{ω}}_{m}} , \\ 1 + ⌊ \frac{{B}_{pw} ( i ) {\hat{K}}_{m}}{4000} ⌋ & otherwise .\end{matrix} \} , 0 \leq i \leq 7 , m = 4 , 8. \qquad \text{(3.6.4-7)}$$

The full band PW mean vectors are constructed at subframes 4 and 8 by

$${\hat{S}}_{m} ( k ) = \{ \begin{matrix} 0 & {\hat{κ}}_{m} ( 0 ) > k , m = 4 , 8 , \\ {\hat{ D}}_{m} ( i ) , & {\hat{κ}}_{m} ( i ) \leq k < {\hat{κ}}_{m} ( i + 1 ) , 0 \leq i \leq 6 , m = 4 , 8 , \\ 0 & {\hat{ κ}}_{m} ( 7 ) \leq k \leq {\hat{K}}_{m} , m = 4 , 8.\end{matrix} \qquad \text{(3.6.4-8)}$$

The PW magnitude vector can then be reconstructed for subframes 4 and 8 by adding the full band PW mean vector to the deviations vector. In the unvoiced mode, the deviations vector is decoded as if the code vector is zero at the unselected harmonic indices.

$${\hat{P}}_{m} ( k ) = \{ \begin{matrix} 0 & k = 0 , & \\ MAX ( 0.15 {\hat{S}}_{m} ( {μ}_{m} ( k ) ) , {\hat{S}}_{m} ( {μ}_{m} ( k ) ) + {\hat{F}}_{m} ( {μ}_{m} ( k ) ) ) , & 1 \leq k \leq 10 , m = 4 , 8 , & \\ MAX ( 0.15 {\hat{S}}_{m} ( k ) , {\hat{S}}_{m} ( k ) + {\hat{F}}_{m} ( k ) ) , & k ∉ {μ}_{m} , 1 \leq k \leq {\hat{K}}_{m} , & \\ 0 & {\hat{ K}}_{m} < k \leq 60 , & \end{matrix} \qquad ( 3.6 .4 - 9 )$$

The PW magnitude vector is reconstructed for the remaining subframes by linearly interpolating between subframes 0 and 4 for subframes 1, 2 and 3 and between subframes 4 and 8 for subframes 5, 6 and 7:

$${\hat{P}}_{m} ( k ) = \{ \begin{matrix}\frac{( 4 - m ) {\hat{P}}_{0} ( k ) + m {\hat{P}}_{4} ( k )}{4} , & 0 \leq k \leq {\hat{K}}_{m} , m = 1 , 2 , 3 , \\ \frac{( 8 - m ) {\hat{P}}_{4} ( k ) + ( m - 4 ) {\hat{P}}_{8} ( k )}{4} , & 0 \leq k \leq {\hat{K}}_{m} , m = 5 , 6 , 7.\end{matrix} \qquad \text{(3.6.4-10)}$$

It should be noted that {\hat{P}₀(k),0≦k≦\hat{K}₀} is the decoded PW magnitude vector from subframe 8 of the previous frame.

In the voiced mode, the mean vector for subframe 8 is inverse quantized based on interframe prediction:

$${\hat{D}}_{8} ( i ) = MAX ( 0.1 , {P}_{DC\_V} ( i ) + {α}_{v} ( i ) ( {\hat{D}}_{0} ( i ) - {P}_{DC\_V} ( i ) ) + {V}_{PWM\_V} ( {l}_{PWM\_V}^{*} , i ) ) 0 \leq i \leq 6. \qquad \text{(3.6.5-1)}$$

where, {\hat{D}₈(i),0≦i≦6} is the 7-band subband PW mean vector, {V_{PWM}_{_{—}}_{V}(l,i),0≦l≦127,0≦i≦6} is the 7-dimensional, 128 level voiced mean codebook, l*_{PWM}_{_{—}}_{V} is the index for mean vector 8^{th} subframe. {P_{DC}_{_{—}}_{V}(i),0≦i≦6} is the predetermined DC vector and {αᵥ(i),0≦i≦6} is the vector predictor. Both of these vectors are identical to those used at the encoder 100A. Since the mean vector is an average of PW magnitudes, the mean vector should be nonnegative. This is enforced by the maximization operation in the above equation.

A subband mean vector is constructed for subframe 4 by linearly interpolating between subframes 0 and 8:

\hat{D}₄(i)=0.5(\hat{D}₀(i)+\hat{D}₈(i)), 0≦i≦6. (3.6.5-2)

The full band PW mean vectors are constructed at subframes 4 and 8 by

$${\hat{S}}_{m} ( k ) = \{ \begin{matrix} 0 & {\hat{κ}}_{m} ( 0 ) > k , m = 4 , 8 , \\ {\hat{ D}}_{m} ( i ) , & {\hat{κ}}_{m} ( i ) \leq k < {\hat{κ}}_{m} ( i + 1 ) , 0 \leq i \leq 6 , m = 4 , 8 , \\ 0 & {\hat{ κ}}_{m} ( 7 ) \leq k \leq {\hat{K}}_{m} , m = 4 , 8.\end{matrix} \qquad \text{(3.6.5-3)}$$

The harmonic band edges {\hat{κ}ₘ(i),0≦i≦7} are computed as in the case of the unvoiced mode.

In the case of frames that are either lost or contain errors, the PW mean vector at subframe 8 is reconstructed as follows:

\hat{D}₈(i)=MAX(0.1,0.9(\hat{D}₀(i)−P_{DC}_{_{—}}_{V}(i))+P_{DC}_{_{—}}_{V}(i)) 0≦i≦6. (3.6.5-4)

i.e., the reconstruction is based purely on the previous reconstructed vector.

The voiced deviation vectors for subframes 4 and 8 are predictively quantized by a multistage vector quantizer with 2 stages. The deviations vectors are reconstructed by adding the contributions of the 2 codebooks to the prediction from the preceding reconstructed deviations vector:

$${\hat{F}}_{m} ( {μ}_{m} ( k ) ) = {β}_{v} {\hat{F}}_{m - 4} ( {μ}_{m} ( k ) ) + {V}_{PWD\_V1} ( {l}_{PWD\_V1 \_m}^{*} , k ) + {V}_{PWD\_V2} ( {l}_{PWD\_V2 \_m} , k ) , 1 \leq i \leq 10 , m = 4 , 8. \qquad \text{(3.6.5-5)}$$

A prediction coeffient of β_{ν}=0.56 is used at the encoder 100A. {V_{PWD}_{_{—}}_{V1}(l,k),0≦l≦63,1≦k≦10} is the 10-dimensional, 64 level voiced deviations codebook for the 1^{st} stage. {V_{PWD}_{_{—}}_{V2}(l,k),0≦l≦15,1≦k≦10} is the 10-dimensional, 16 level voiced deviations codebook for the 2^{nd} stage.

$${l}_{PWD\_V1 \_ 4}^{*} and {l}_{PWD\_V2 \_ 4}^{*}$$

are the 1^{st} and 2^{nd} stage indices for the deviations vector for the 4^{th} subframe.

$${l}_{PWD\_V1 \_ 8}^{*} and {l}_{PWD\_V2 \_ 8}^{*}$$

are the 1^{st} and 2^{nd} stage indices for the deviations vector for the 8^{th} subframe.

The remaining unselected harmonics are reconstructed as if the code vector is zero valued:

\hat{F}ₘ(k)=β_{ν}\hat{F}ₘ₋₄(k) k∉μₘ(k),0≦k≦\hat{K}ₘ,m=4,8. (3.6.5-6)

where, {\hat{F}ₘ(k),1≦k≦Kₘ,m=4,8} are the inverse quantized PW deviation vectors. It should be noted that, as in the case of the encoder, it is necessary to equalize the dimensions of the preceding and current deviations vectors.

In the case of frames that are either lost or contain errors, the inverse quantization in eqn. 3.6.5-5 is modified to include only the preceding quantized deviations vector \tilde{F}ₘ₋₄:

\hat{F}ₘ(μₘ(k))=β_{ν}\hat{F}ₘ₋₄(μₘ(k)), 1≦i≦10,m=4,8. (3.6.5-7)

The unselected harmonics are reconstructed as before.

The PW magnitude vector can then be reconstructed for subframes 4 and 8 by adding the full band PW mean vector to the deviations vector. In the voiced mode, the deviations vector is decoded as if the codebook vector is zero at the unselected harmonic indices.

$${\hat{P}}_{m} ( k ) = \{ \begin{matrix}0 & k = 0 , \\ MAX ( 0.10 {\hat{S}}_{m} ( {μ}_{m} ( k ) ) , {\hat{S}}_{m} ( {μ}_{m} ( k ) ) + {\hat{F}}_{m} ( {μ}_{m} ( k ) ) ) , & 1 \leq k \leq 10 , \\ MAX ( 0.10 {\hat{S}}_{m} ( k ) , {\hat{S}}_{m} ( k ) + {\hat{F}}_{m} ( k ) ) , & k ∉ {μ}_{m} , 1 \leq k \leq {\hat{K}}_{m} , \\ 0 & {\hat{K}}_{m} < k < 60 ,\end{matrix} m = 4 , 8 , \qquad ( 3.6 .5 \text{-} 8 )$$

The PW magnitude vector is reconstructed for the remaining subframes by linearly interpolating between subframes 0 and 4 for subframes 1, 2 and 3 and between subframes 4 and 8 for subframes 5, 6 and 7:

$${\hat{P}}_{m} ( k ) = \{ \begin{matrix}\frac{( 4 - m ) {\hat{P}}_{0} ( k ) + m {\hat{P}}_{4} ( k )}{4} , & 0 \leq k \leq {\hat{K}}_{m} , m = 1 , 2 , 3 , \\ \frac{( 8 - m ) {\hat{P}}_{4} ( k ) + ( m - 4 ) {\hat{P}}_{8} ( k )}{4} , & 0 \leq k \leq {\hat{K}}_{m} , m = 5 , 6 , 7.\end{matrix} \qquad ( 3.6 .5 \text{-} 9 )$$

Note that {\hat{P}₀(k),0≦k≦\hat{K}₀} is the decoded PW magnitude vector from subframe 8 of the previous frame.

In the FDI codec 100, there is no explicit coding of PW phase. The salient characteristics related to the phase, such as the degree of correlation between adjacent PW i.e., pitch cycle stationarity of the time domain residual and the variation of the PW correlation as a function of frequency are encoded in the form of the quantized voicing measure \hat{ν} and the PW subband correlation vector respectively. A PW phase vector is constructed for each subframe based on this information.

The PW subband correlation vector is transmitted once per frame. During steady state voiced frames i.e., when both the preceding and current frames have \hat{v}_{flag}=0, linear interpolation across the frame is used to construct the correlation vector for the subframes within the current frame. Interpolation serves to smooth out abrupt changes in the correlation vector. During voicing onsets, i.e., \hat{ν}_{flag}=0 and \hat{ν}_{flag}_{_{—}}ₚᵣₑᵥ=1, the interpolation is restricted to the 1^{st} half of the frame, so that onsets are not smeared across the frame. For unvoiced frames, no interpolation is performed. The computation of the interpolated PW subband correlation vector can be specified as follows:

$${{\sim}^{}}_{m} ( l ) = \{ \begin{matrix}{\hat{}}^{} ( l ) , & 1 \leq m \leq 8 , & if {\hat{v}}_{flag} = 1 , \\ \frac{( 8 - m ) {{\hat{}}^{}}_{prev} ( l ) + m {\hat{}}^{} ( l )}{8} , & 1 \leq m \leq 8 , & if {\hat{v}}_{flag} = 0 , {\hat{v}}_{flag\_prev} = 0 , 0 \leq l \leq 5. \\ \{ \begin{matrix}\frac{( 4 - m ) {{\hat{}}^{}}_{prev} ( l ) + m {\hat{}}^{} ( l )}{4} , \\ {\hat{}}^{} ( l ) ,\end{matrix} & \begin{matrix}1 \leq m \leq 4 , \\ 5 \leq m \leq 8.\end{matrix} & if {\hat{v}}_{flag} = 0 , {\hat{v}}_{flag\_prev} = 1 ,\end{matrix} \qquad ( 3.7 .1 \text{-} 1 )$$

The subband correlation vector is converted into a full band i.e., harmonic by harmonic correlation vector by a piecewise constant construction. This requires that the subband edges in Hz are translated to subband edges in terms of harmonic indices. Let the bandedges in Hz be defined by the array

B_{pwr}=[1 400 800 1200 2000 3000]. (3.7.2-1)

The subband edges in Hz can be translated to subband edges in terms of harmonic indices such that the i^{th} subband contains harmonics with indices {\hat{η}ₘ(i−1)≦k<\hat{η}ₘ(i),1≦i≦5,1≦m≦8} as follows:

$${\hat{η}}_{m} ( i ) = \{ \begin{matrix}2 + ⌊ \frac{{B}_{pwr} ( i ) {\hat{K}}_{m}}{4000} ⌋ & \{ 1 + ⌊ \frac{{B}_{pwr} ( i ) {\hat{K}}_{m}}{4000} ⌋ \} < \frac{{B}_{pwr} ( i ) π}{4000 {\hat{ω}}_{m}} , \\ ⌊ \frac{{B}_{pwr} ( i ) {\hat{K}}_{m}}{4000} ⌋ & ⌊ \frac{{B}_{pwr} ( i ) {\hat{K}}_{m}}{4000} ⌋ > \frac{{B}_{pwr} ( i ) π}{4000 {\hat{ω}}_{m}} , \\ 1 + ⌊ \frac{{B}_{pwr} ( i ) {\hat{K}}_{m}}{4000} ⌋ & otherwise .\end{matrix} \} , 0 \leq i \leq 5 , 1 \leq m \leq 8. \qquad ( 3.7 .2 \text{-} 2 )$$

The full band correlation vector is constructed by

$${m\_fb}_{} ( k ) = \{ \begin{matrix}\begin{matrix}{m}_{} ( 0 ) \\ {m}_{} ( i ) ,\end{matrix} \\ {m}_{} ( 4 )\end{matrix} \begin{matrix}k < {\hat{η}}_{m} ( 0 ) , & \\ {\hat{η}}_{m} ( i ) \leq k < {\hat{η}}_{m} ( i + 1 ) , 0 \leq i \leq 4 , 1 \leq m \leq 8. & \\ {\hat{η}}_{m} ( 5 ) \leq k < {\hat{K}}_{m} , & \end{matrix} \qquad ( 3.7 .2 \text{-} 3 )$$

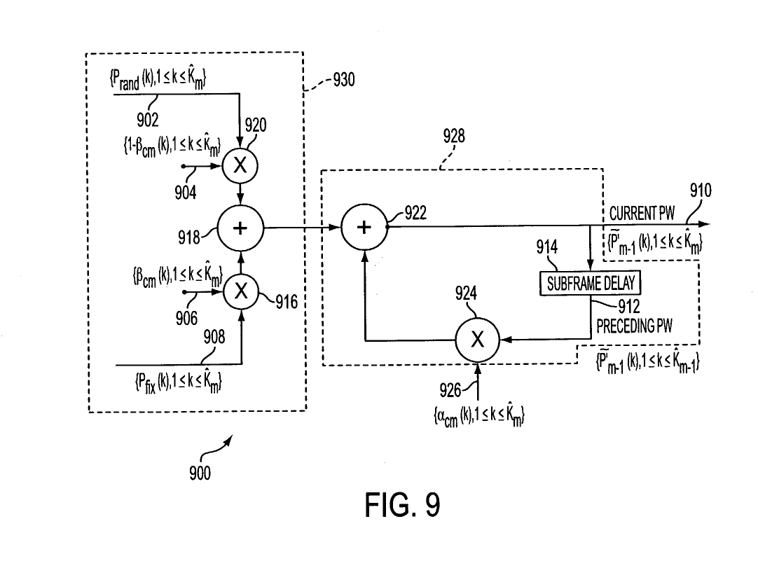

For each subframe, the full band correlation vector is used to create a sequence of PW vectors that possess an adjacent vector correlation that approximates the correlation specified by the full band correlation vector. This is achieved by a 1^{st} order vector autoregressive model as shown in diagram 900 of FIG. 9.

FIG. 9 is a diagram illustrating a process 900 of an example of a model for construction of a PW Phase in accordance with an embodiment of the present invention. Specifically, the information in PW correlation is used to provide a sequence of PWs that have the correlation characteristics of the PWs at the encoder 100A. An autoregressive (AR) model 928 comprises a current PW 910, a preceding PW 912, a subframe delay 914, a correlation coefficient 926, a multiplier 924, and an adder 922. Inputs to AR model 930 comprise a random phase component 902, a first weighting coefficient 904, a fixed phase component 908, a second weighting coefficient 906, a multiplier 916, an adder 918, and a multiplier 920. The preceding PW 912 is multiplied by the correlation coefficient 926. The product is added to the weighted sum of the fixed phase component 908 and the random phase component 902 to generate the current PW 910. The weights used are weighting coefficients 906 and 904 respectively.

The fixed phase of 908 is derived from a predetermined voice pitch pulse. The phase of the pitch pulse is over-sampled. If there is a change in pitch frequency across the frame, it can potentially introduce phase discontinuities into the fixed phase 908. By using over-sampling, the discontinuities are reduced to a point where they are no longer noticeable.

The random phase of 902 is derived by selecting random numbers between 0 to 2π. The random numbers are then used as phase values to derive the random phase component 902. The weights 904 and 906 are a function of frequency and they depend on the PW correlation, the voicing measure, the pitch period, and the frequency itself. For voiced frames, the weight for the fixed phase component is the decoded PW correlation for that frequency clamped between limits that are controlled by the voicing measure, pitch period and frequency. For unvoiced frames, only an upper limit is used.

The subframe delay 914 ensures that the preceding PW 912 that was generated for the previous subframe is multiplied by the correlation coefficient 926 and adding it to the next subframe. The correlation coefficient 926 provides the degree of similarity between the preceding PW 912 and the current PW 910. The current PW phase vector is subsequently combined with the PW magnitude and scaled by the PW gain in order to reconstruct the PW vector for that subframe.

The phase synthesis procedure will now be described in greater detail. The phase synthesis model has primarily two parts. One is an autoregressive (AR) model 928 and the second part is the source generation model 930 that will be the input for the AR model. The source generation model 930 is a weighted sum of a vector with a fixed phase 908 and a vector with random phase 902.

A vector based on a fixed phase spectrum is one component of the source generation 930. The fixed phase spectrum is obtained from the prediction residual corresponding to a typical voiced pitch pulse waveform. In order to smooth the phase variations across adjacent subframes, the phase spectrum is oversampled. Let {φ_{fix}(k),0≦k≦60Nₒₛ} represent the oversampled fixed phase vector, where Nₒₛ is the oversampling factor. It is found that a satisfactory value of the oversampling factor is Nₒₛ=5. It should be appreciated by those skilled in the art that values other than Nₒₛ=5 can be used without departing from the scope of the present invention. The fixed phase vector is then given by:

Pₘ_{_{—}}_{fix}(k)=cos(φ_{fix}(iₒₛ(k)))+j sin(φ_{fix}(iₒₛ(k))), 0≦k≦\hat{K}ₘ,1≦m≦8. (3.7.3-1)

where

$${i}_{os} ( k ) = ⟨ k \frac{( {N}_{os} 61 - 1 ) {\hat{ω}}_{m}}{π} ⟩ 0 \leq k < {\hat{K}}_{m} . \qquad ( 3.7 .3 \text{-} 2 )$$

and represents rounding to the nearest integer.

The weight attached to the fixed phase vector is determined based on the PW fullband correlation vector, subject to an upper and lower limit which depend on the voicing measure. The upper limit is controlled by a parameter that is dependent on the pitch period:

$${u}_{0} = 0.6 + 0.3 \frac{( {\hat{p}}_{8} - PITCHMIN )}{( PITCHMAX - PITCHMIN )} \qquad ( 3.7 .3 \text{-} 3 )$$

where \hat{p}₈ is the decoded pitch period for the current frame, PITCHMAX and PITCHMIN are the maximum and minimum allowable pitch periods. Typical values are PITCHMAX=120 and PITCHMIN=20. The upper limit parameter is proportional to the pitch period. This permits slower variations i.e, increased fixed phase component from subframe to subframe for larger pitch periods. This is preferable since larger pitch periods span a larger number of subframes, and to achieve a given degree of pitch cycle variation, the variation per subframe should preferably be reduced.

The upper limit parameter is modified based on a sigmoidal transformation of the voicing measure:

$${u}_{0}^{′} = {u}_{0} ( 1 - \frac{1}{1 + {ⅇ}^{- 8 ( \hat{v} - {v}_{2} )}} ) \qquad ( 3.7 .3 \text{-} 4 )$$

where \hat{ν} is the decoded voicing measure ν₂ is a voicing measure threshold obtained from the PW subband correlation—voicing measure codebook, as

ν₂=V_{R}(7,6). (3.7.3-5)

In other words, it is the lowest voicing measure for unvoiced frames. This allows the fixed phase component to be higher for frames with a lower voicing measure. With increasing voicing measure, especially for unvoiced frames, the sigmoidal transformation rapidly reduces the upper limit, thereby reducing the fixed phase component during unvoiced frames to negligible levels. This is important to prevent “buzzyness” during unvoiced and background noise frames.

The upper limit parameter is used to derive a frequency dependent upper limit function as follows:

$$u l ( k ) = \{ \begin{matrix}{u}_{0}^{′} , & 0 \leq k \leq ⟨ 0.5 {\hat{K}}_{m} ⟩ , \\ {u}_{0}^{′} [ 1 - 0.6 \frac{k - ⟨ 0.5 {\hat{K}}_{m} ⟩ - 1}{0.5 {\hat{K}}_{m}} ] , & ⟨ 0.5 {\hat{K}}_{m} ⟩ + 1 \leq k \leq {\hat{K}}_{m} .\end{matrix} \qquad ( 3.7 .3 \text{-} 6 )$$

This function is constant at u′₀ up to about 2 kHz. From 2 kHz to 4 kHz it decreases linearly to 0.4u′₀. This reduces the fixed phase component at higher frequencies, so that these frequencies are reproduced with reduced periodicity when compared to low frequencies. This is consistent with the characteristics of voice signals. During voiced frames, it is also desirable to ensure that the weight for the fixed phase vector does not fall below a lower limit value. The lower limit is derived from the upper limit function and the voicing measure as follows:

$$l l ( k ) = \{ \begin{matrix}0 , & \hat{v} > {v}_{1} , \\ ( u l ( k ) - 0.3 ) \frac{{v}_{1} - \hat{v}}{{v}_{1} - {v}_{0}} , & \hat{v} \leq {v}_{1} ,\end{matrix} 0 \leq k \leq {\hat{K}}_{m} . \qquad ( 3.7 .3 \text{-} 7 )$$

where the voicing measure thresholds ν₀ and ν₁ are respectively the lowest and the highest voicing measures for voiced frames, obtained from the PW subband correlation—voicing measure codebook:

ν₀=V_{R}(31,6). (3.7.3-8)

ν₁=V_{R}(8,6). (3.7.3-9)

Thus for the most periodic frames, the lower limit is 0.3 below the upper limit. As the periodicity is reduced, the lower limit reduces to 0. With the lower and upper limits computed as above, the weight for the fixed phase component can be computed as follows:

$${β}_{c m} ( k ) \{ \begin{matrix}MIN ( MAX ( {\tilde{ℛ}}_{m\_fb} ( k ) , ll ( k ) ) , ul ( k ) ) & \hat{v} \leq {v}_{1} ( voiced ) \\ MIN ( {\tilde{ℛ}}_{m\_fb} ( k ) , ul ( k ) ) & \hat{v} > {v}_{1} ( unvoiced )\end{matrix} 0 \leq k \leq {\hat{K}}_{m} \qquad ( 3.7 .3 \text{-} 10 )$$

The random phase vector provides a method of introducing a controlled degree of variation in the evolution of the PW vector. When the correlation of the PW vectors is low, a higher level of the random phase vector can be used. A higher degree of PW correlation can be achieved by reducing the level of the random phase vector. The random phase vector is obtained based on random phase values from a uniform distribution in the interval [0-2π]. Let {φ_{rand}(k),0≦k≦60} represent the random phases obtained in this manner. The random phase vector is then given by:

Pₘ_{_{—}}_{rand}(k)=cos(φ_{rand}(k))+j sin(φ_{rand}(k)), 0≦k≦\hat{K}ₘ,1≦m≦8. (3.7.3-11)

The weight of the random vector is {1−β_{cm}(k)}, so that the sum of the weights of the fixed and random component weights is unity.

Based on the fixed and random phase vectors, the corresponding weights and the full band correlation vector, the autoregressive model in FIG. 9 is used to generate a sequence of complex PW vectors. This operation is described by

\tilde{P}ₘ(k)=β_{cm}(k)Pₘ_{_{—}}_{fix}(k)+(1−β_{cm}(k))Pₘ_{_{—}}_{rand}(k)+α_{cm}(k)\tilde{P}ₘ₋₁(k), 0≦k≦\hat{K}ₘ,1≦m≦8. (3.7.3-12)

Here, {α_{cm}(k)} is derived from the interpolated full band correlation vector as follows:

$${α}_{c m} ( k ) = \{ \begin{matrix}{\tilde{ℛ}}_{m\_fb} ( k ) & \hat{v} \leq {v}_{1} ( voiced ) \\ MIN ( {\tilde{ℛ}}_{m\_fb} ( k ) , 0.4 ) & \hat{v} > {v}_{1} ( unvoiced )\end{matrix} 0 \leq k \leq {\hat{K}}_{m} . \qquad ( 3.7 .3 \text{-} 13 )$$

In other words, it {α_{cm}(k)} is identical to the correlation coefficient vector for voiced frames. For unvoiced frames it is the correlation coefficient vector subject to a minimum value. This ensures that the unvoiced frames are not reproduced with excessive periodicity.

The sequence of PW vectors constructed in the above manner will have the desired phase characteristics, but will not provide the decoded PW magnitude. To obtain a complex PW vector with the decoded PW magnitude and the desired phase, it is necessary to normalize the above vector to unity magnitude and multiply it with the decoded magnitude vector:

$${\hat{V}}_{m}^{″} ( k ) = \frac{{\tilde{P}}_{m}^{′} ( k )}{\vert {\tilde{P}}_{m}^{′} ( k ) \vert} {\hat{P}}_{m} ( k ) , 0 \leq k \leq {\hat{K}}_{m} , 1 \leq m \leq 8. \qquad ( 3.7 .3 \text{-} 14 )$$

This vector is the reconstructed normalized PW magnitude vector for subframe m.

The inverse quantized PW vector may have high valued components outside the band of interest. Such components can deteriorate the quality of the reconstructed signal and should be attenuated. At the high frequency end, harmonics above an adaptively determined upper frequency are attenuated. At the low frequency end, only the components below 1 Hz i.e., only the 0 Hz component is attenuated. The attenuation characteristic is linear from 1 at the band edges to 0 at 4000 Hz. The lower and upper band edges are computed based on the pitch frequency and the number of harmonics as follows:

$${k}_{L\_PW} = ⌊ \frac{1}{4000} {\hat{K}}_{m} ⌋$$

$${k}_{U\_PW} = ⌊ \frac{{α}_{fatt} 3000}{4000} {\hat{K}}_{m} ⌋$$

$${k}_{U\_PW} ⟸ {k}_{U\_PW} + 1 if \frac{{k}_{U\_PW} {\hat{ω}}_{m} 4000}{π} \leq {α}_{fatt} 3000$$

$${k}_{U\_PW} ⟸ {k}_{U\_PW} + 1 if \frac{{k}_{U\_PW} {\hat{ω}}_{m} 4000}{π} \leq {α}_{fatt} 3000$$

(3.8.1-1)

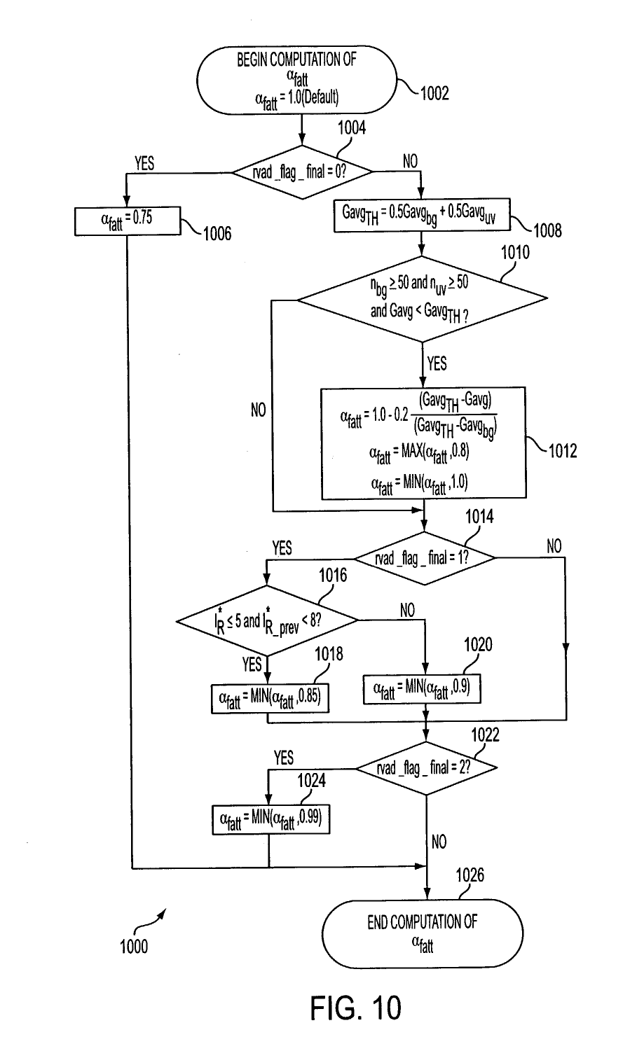

Here the factor α_{fatt} is computed according to the flow chart in FIG. 10 α_{fatt} is used to adaptively determine the upper frequency limit. During active speech intervals, α_{fatt}=1, resulting in an upper frequency limit of 3000 Hz. During inactive speech intervals, α_{fatt}=0.75, resulting in an upper frequency limit of 2250 Hz. Low level active frames or frames during transitions receive intermediate values of α_{fatt}.

The out-of-band attenuation process can be specified by the following equations:

$${\hat{V}}_{m}^{′″} ( k ) = \{ \begin{matrix}{\hat{V}}_{m}^{″} ( k ) \frac{k {\hat{ω}}_{m} 4000}{π} & 0 \leq k \leq {k}_{L\_PW} . \\ {{\hat{V}}_{m}^{″} ( k ) [ \frac{4000 ( π - k {\hat{ω}}_{m} )}{4000 π - {α}_{fatt} 3000 π} ]}^{2} & {k}_{U\_PW} \leq k \leq {\hat{K}}_{m} .\end{matrix} \qquad ( 3.8 .1 \text{-} 2 )$$

Certain types of background noise can result in LP parameters that correspond to sharp spectral peaks. Examples of such noise are babble noise, cafeteria noise and noise due to an interfering talker. Peaky spectra during background noise is undesirable since it leads to a highly dynamic reconstructed noise that interferes with the speech signal. This can be mitigated by a mild degree of bandwidth broadening that is adapted based on the PW subband correlation index and the RVAD_FLAG_FINAL computed according to Table 2. The adaptation factor α_{fatt} computed previously is based on this information and works well for determining the degree of bandwidth broadening. In general, bandwidth expansion increases as the frame becomes more unvoiced. Onset and offset frames have a lower degree of bandwidth broadening compared to frames during voice inactivity. Bandwidth expansion is applied to interpolated LPC parameters as follows:

\hat{α}′ₘ(j)=\hat{α}ₘ(j)α_{fatt}^{m} 0≦m≦10, 1≦j≦8. (3.8.2-1)

FIG. 10 is a flowchart illustrating an example of steps for computing parameters for out of band attenuation and bandwidth broadening in accordance with an embodiment of the present invention. Method 1000 is initiated at step 1002 where the attenuation frequency factor α_{fatt} is initialized to one. For this value of α_{fatt}, attenuation is applied to all harmonics above 3000 Hz. The method 1000 proceeds to step 1004.

At step 1004, a measure of voice inactivity is determined. That is, a determination is made as to whether the current frame, the lookahead frame and the previous frame are inactive. If the determination is answered affirmatively, the method at step 1004 proceeds to step 1006 where α_{fatt} is set to be 0.75. That is attenuation begins at 0.75 multiplied by 3000 or 2250 Hz. If the determination is answered negatively, the method at step 1004 proceeds to step 1008 where a threshold value is calculated as the average of Gavg_{bg}, the background noise level estimate, and Gavgᵤᵥ, the unvoiced speech level estimate.

At step 1010, a determination is made as to whether the average value of the gain in the current frame less than this threshold and whether n_{bg} and nᵤᵥ are both greater than or equal to 50. Here, the number of background noise frames for which the Gavg_{bg} has been computed equals n_{bg} and the number of frames for which the Gavgᵤᵥ equals nᵤᵥ. If n_{bg} and nᵤᵥ are small, the estimates of Gavg_{bg} and Gavgᵤᵥ are unreliable. Therefore, to provide reliability, there is a prerequisite that n_{bg} and nᵤᵥ are greater than 50. If this prerequisite is met and the average gain of the frame is less than the threshold value, inactivity is indicated. If the determination at step 1010 is answered negatively, the method proceeds to step 1014. If the determination at step 1010 is answered affirmatively, the method proceeds to step 1012.

At step 1012, the method goes through a series of functions where α_{fatt} is computed and α_{fatt} is clamped between a floor of 0.8 and a ceiling of 1. The method 1000 proceeds to step 1014.

At step 1014, a determination is made as to whether the inactivity measure rvad_flag_final is set to 1. This indicates that one of the frames either the past, lookahead and current is active. If the determination is answered negatively, the method proceeds to step 1022. If the method is answered affirmatively, the method proceeds to step 1016.

At step 1016, a determination is made as to whether the previous and current frames are both unvoiced. Specifically, a determination is made as to whether the current frame's voicing and correlation measure index is preferably less than or equal to five and the previous frame's voicing and correlation measure index is preferably less than eight. The lower the number, the greater the likelihood of the frame being unvoiced. Hence, the current frame has a stricter requirement than the previous frame. If the determination is answered affirmatively, then both frames are unvoiced. The method at step 1016 proceeds to step 1018 where α_{fatt} is clamped below a ceiling of 0.85. If the determination at step 1016 is answered affirmatively, the method at step 1016 proceeds to step 1020 where α_{fatt} is clamped below a higher ceiling of 0.9.

At step 1022, a determination is made as to whether the measure of inactivity rvad_flag_final is 2. This indicates that two of the frames from the past, lookahead and current frames are active. If the determination is answered affirmatively, the method proceeds to step 1024 where α_{fatt} is clamped below a ceiling of 0.99. The method proceeds to step 1026. If the method at step 1022 is answered negatively, the method proceeds to step 1026 where the computations for α_{fatt} end.

The level of the PW vector is restored to the RMS value represented by the decoded PW gain. Due to the quantization process, the RMS value of the decoded PW vector is not guarenteed to be unity. To ensure that the right level is achieved, it is necessary to first normalize the PW by its RMS value and then scale it by the PW gain. The RMS value is computed by

$${g}_{r m s} ( m ) = \sqrt{\frac{1}{2 {\hat{K}}_{m} + 2} {\sum }_{k = 0}^{{\hat{K}}_{m}} {\vert {\hat{V}}_{m}^{′″} ( k ) \vert}^{2}} 1 \leq m \leq 8. \qquad ( 3.8 .3 \text{-} 1 )$$

The PW vector sequence is scaled by the ratio of the PW gain and the RMS value for each subframe:

$${\hat{V}}_{m} ( k ) = \frac{{\hat{g}}_{pw} ( m )}{{g}_{r m s} ( m )} {\hat{V}}_{m}^{′″} ( k ) 0 \leq k \leq {\hat{K}}_{m} , 1 \leq m \leq 8. \qquad ( 3.8 .3 \text{-} 2 )$$

The excitation signal is constructed from the PW using an interpolative frequency domain synthesis process. This process is equivalent to linearly interpolating the PW vectors bordering each subframe to obtain a PW vector for each sample instant, and performing a pitch cycle inverse DFT of the interpolated PW to compute a single time-domain excitation sample at that sample instant.

The interpolated PW represents an aligned pitch cycle waveform. This waveform is to be evaluated at a point in the pitch cycle i.e., pitch cycle phase, advanced from the phase of the previous sample by the radian pitch frequency. The pitch cycle phase of the excitation signal at the sample instant determines the time sample to be evaluated by the inverse DFT. Phases of successive excitation samples advance within the pitch cycle by phase increments determined by the linearized pitch frequency contour.

The computation of the n^{th} sample of the excitation signal in the m^{th} sub-frame of the current frame can be conceptually represented by

$$\hat{e} ( 20 ( m - 1 ) + n ) = \frac{1}{20 ( {\hat{K}}_{m} + 1 )} {\sum }_{k = 0}^{{\hat{K}}_{m}} [ ( 20 - n ) {\hat{V}}_{m - 1} ( k ) + n {\hat{V}}_{m} ( k ) ] {ⅇ}^{j θ ( 20 ( m - 1 ) + n ) k} , 0 \leq n < 20 , 0 < m \leq 8 , 0 \leq k \leq {\hat{K}}_{m} \qquad ( 3.8 .4 \text{-} 1 )$$

Here, θ(20(m−1)+n) is the pitch cycle phase at the n^{th} sample of the excitation in the m^{th} sub-frame. It is recursively computed as the sum of the pitch cycle phase at the previous sample instant and the pitch frequency at the current sample instant:

θ(20(m−1)+n)=θ(20(m−1)+n−1)+\hat{ω}(20(m−1)+n), 0≦n<20 (3.8.4-2)

This is essentially a numerical integration of the sample-by-sample pitch frequency track to obtain the sample-by-sample pitch cycle phase. It is also possible to use trapezoidal integration of the pitch frequency track to get a more accurate and smoother phase track by

θ(20(m−1)+n)=θ(20(m−1)+n−1)+0.5[\hat{ω}(20(m−1)+n−1)+\hat{ω}(20(m−1)+n)] 0≦n<20 (3.8.4-3)

In either case, the first term circularly shifts the pitch cycle so that the desired pitch cycle phase occurs at the current sample instant. The second term results in the exponential basis functions for the pitch cycle inverse DFT.

The above is a conceptual description of the excitation synthesis operation. Direct implementation of this approach is possible, but is highly computation intensive. The process can be simplified by using radix-2 FFT to compute over sampled pitch cycle and by performing interpolations in the time domain. These techniques have been employed to achieve a computation efficient implementation.

The resulting excitation signal {ê(n),0≦n<160} is processed by an all-pole LP synthesis filter, constructed using the decoded and interpolated LP parameters. The first half of each sub-frame is synthesized using the LP parameters at the left edge of the sub-frame and the second half by the LP parameters at the right edge of the sub-frame. This ensures that locally optimal LP parameters are used to reconstruct the speech signal. The transfer function of the LP synthesis filter for the first half of the m^{th} subframe is given by

$${H}_{LPm1} ( z ) = \frac{1}{{\sum }_{l = 0}^{10} {a}_{l}^{′} ( m - 1 ) {z}^{- 1}} \qquad ( 3.8 .5 \text{-} 1 )$$

and for the second half

$${H}_{LPm2} ( z ) = \frac{1}{{\sum }_{l = 0}^{10} {a}_{l}^{′} ( m ) {z}^{- 1}} \qquad ( 3.8 .5 \text{-} 2 )$$

The signal reconstruction is expressed

$$by \hat{s} ( 20 m - 20 + n ) = \{ \begin{matrix}\hat{e} ( 20 m - 20 + n ) - {\sum }_{l = 1}^{10} {a}_{1}^{′} ( m - 1 ) \hat{s} ( 20 m - 20 + n - l ) , 0 \leq n < 10 , 0 < m \leq 8 \\ \hat{e} ( 20 m - 20 + n ) - {\sum }_{l = 1}^{10} {a}_{l}^{′} ( m ) \hat{s} ( 20 m - 20 + n - l ) , 10 \leq n < 20 , 0 < m \leq 8. \end{matrix} \qquad ( 3.8 .5 \text{-} 3 )$$

The resulting signal {ŝ(n),0≦n<160} is the reconstructed speech signal.

The reconstructed speech signal is processed by an adaptive postfilter to reduce the audibility of the effects of modeling and quantization. A pole-zero postfilter with an adaptive tilt correction reference 12 is employed. The postfilter emphasizes the formant regions and attenuates the valleys between formants. As during speech reconstruction, the first half of the sub-frame is postfiltered by parameters derived from the LPC parameters at the left edge of the sub-frame. The second half of the sub-frame is postfiltered by the parameters derived from the LPC parameters at the right edge of the sub-frame. For the m^{th} sub-frame, these two postfilter transfer functions are specified respectively by

$$\begin{matrix}{H}_{pf1} ( z ) = \frac{{\sum }_{l = 0}^{10} {a}_{l}^{′} ( m - 1 ) {β}_{pf}^{1} {z}^{- 1}}{{\sum }_{l = 0}^{10} {a}_{l}^{′} ( m - 1 ) {α}_{pf}^{l} {z}^{- 1}} \\ and & ( 3.8 .6 \text{-} 1 ) \\ {H}_{pf2} ( z ) = \frac{{\sum }_{l = 0}^{10} {a}_{l}^{′} ( m ) {β}_{pf}^{l} {z}^{- 1}}{{\sum }_{l = 0}^{10} {a}_{l}^{′} ( m ) {α}_{pf}^{l} {z}^{- 1}} & ( 3.8 .6 \text{-} 2 )\end{matrix}$$

The pole-zero postfiltering operation for the first half of the sub-frame is represented by

$${\hat{s}}_{pf1} ( 20 ( m - 1 ) + n ) = {\sum }_{l = 1}^{10} {a}_{l}^{′} ( m - 1 ) {β}_{pf}^{1} \hat{s} ( 20 ( m - 1 ) + n - l ) - {\sum }_{l = 1}^{10} {a}_{l}^{′} ( m - 1 ) {α}_{pf}^{l} {\hat{s}}_{pf1} ( 20 ( m - 1 ) + n - l ) , 0 \leq n < 10 , 0 < m \leq 8. \qquad ( 3.8 .6 \text{-} 3 )$$

The pole-zero postfiltering operation for the second half of the sub-frame is represented by

$${\hat{s}}_{pf1} ( 20 ( m - 1 ) + n ) = {\sum }_{l = 1}^{10} {a}_{l}^{′} ( m ) {β}_{pf}^{1} \hat{s} ( 20 ( m - 1 ) + n - l ) - {\sum }_{l = 1}^{10} {a}_{l}^{′} ( m ) {α}_{pf}^{l} {\hat{s}}_{pf1} ( 20 ( m - 1 ) + n - l ) , 10 \leq n < 20 , 0 < m \leq 8. \qquad ( 3.8 .6 \text{-} 4 )$$

where, α_{pf} and β_{pf} are the postfilter parameters. These parameters satisfy the constraint 0≦β_{pf}<α_{pf}≦1. A typical choice for these parameters is α_{pf}=0.875 and β_{pf}=0.6.

The postfilter introduces a frequency tilt with a mild low pass characteristic to the spectrum of the filtered speech, which leads to a muffling of postfiltered speech. This is corrected by a tilt-correction mechanism, which estimates the spectral tilt introduced by the postfilter and compensates for it by a high frequency emphasis. A tilt correction factor is estimated as the first normalized autocorrelation lag of the impulse response of the postfilter. Let v_{pf1} and v_{pf2} be the two tilt correction factors computed for the two postfilters in equations (3.8.6-1) and (3.8.6-2) respectively. Then the tilt correction operation for the two half sub-frames are as follows:

$${\hat{s}}_{pf} ( 20 ( m - 1 ) + n ) = \{ \begin{matrix}{\hat{s}}_{pf1} ( 20 ( m - 1 ) + n ) - 0.8 {v}_{pf1} {\hat{s}}_{pf1} ( 20 ( m - 1 ) + n - 1 ) , 0 \leq n < 10 , 0 < m \leq 8 \\ {\hat{s}}_{pf1} ( 20 ( m - 1 ) + n ) - 0.8 {v}_{pf2} {\hat{s}}_{pf1} ( 20 ( m - 1 ) + n - 1 ) , 10 \leq n < 20 , 0 < m \leq 8\end{matrix} \qquad ( 3.8 .6 \text{-} 5 )$$

The postfilter alters the energy of the speech signal. Hence it is desirable to restore the RMS value of the speech signal at the postfilter output to the RMS value of the speech signal at the postfilter input. The RMS value of the postfilter input speech for the m^{th} sub-frame is computed by:

$${σ}_{prepf} ( m ) = \sqrt{\frac{1}{20} {\sum }_{n = 0}^{19} {\hat{s}}^{2} ( 20 ( m - 1 ) + n )} 0 < m \leq 8 \qquad ( 3.8 .6 \text{-} 6 )$$

The RMS value of the postfilter output speech for the m^{th} sub-frame is computed by:

$${σ}_{pf} ( m ) = \sqrt{\frac{1}{20} {\sum }_{n = 0}^{19} {\hat{s}}_{pf}^{2} ( 20 ( m - 1 ) + n )} 0 < m \leq 8 \qquad ( 3.8 .6 \text{-} 7 )$$

An adaptive gain factor is computed by low pass filtering the ratio of the RMS value at the post filter input to the RMS value at the post filter output:

$${g}_{pf} ( 20 ( m - 1 ) + n ) = 0.96 {g}_{pf} ( 20 ( m - 1 ) + n - 1 ) + 0.04 ( \frac{{σ}_{prepf1} ( m )}{{σ}_{pf1} ( m )} ) , 0 \leq n < 20 , 1 \leq m \leq 8. \qquad ( 3.8 .6 \text{-} 8 )$$

The postfiltered speech is scaled by the gain factor as follows:

sₒᵤₜ(20(m−1)+n)=g_{pf}(20(m−1)+n)ŝ_{pf}(20(m−1)+n), 0≦n<20, 0<m≦8. (3.8.6-9)

The resulting scaled postfiltered speech signal {sₒᵤₜ(n),0≦n<160} constitutes one frame e.g., 20 ms of output speech of the decoder 100B corresponding to the received 80 bit packet.

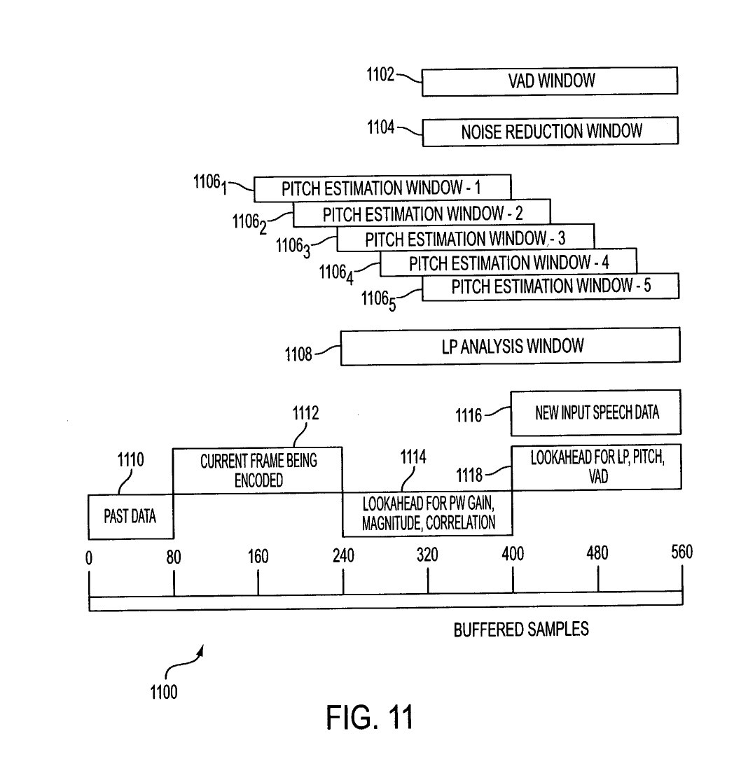

Next, a description of how the codec 100 can be adapted to operate at a lower rate of 2.4 Kbps is provided. In an embodiment of this invention the codec 100 is a 2.4 Kbps codec whose linear prediction (LP) parameters and pitch are extracted in the same manner as for a 4.0 Kbps FDI codec. However, the prototype waveform (PW) parameters such as gain, correlation, voicing measure and spectral magnitude are extracted 1 frame later in time. This extra delay of 20 ms is introduced to smooth the PW parameters which enables the PW parameters to be coded with fewer bits. The smoothing is done using a parabolic window centered around the time of interest. FIG. 11 illustrates the relationship between these various windows and the samples used to compute different characteristics. For both correlation and spectral magnitude, this time instant corresponds to the frame edge of the current frame that is being encoded. For gain, this corresponds to every 2.5 ms subframe edge. The smoothing procedure used for a voicing measure for a 2.4 Kbps codec is slightly different. It averages the voicing measures of 2 adjacent frames, i.e., a current frame that is being encoded and the look ahead frame for PW gain, correlation, and magnitude. However, the averaging is a weighted one. The voicing measure of the frame having a higher frame energy is weighted more if its frame energy is several times that of the frame energy of the other frame.

FIG. 11 is a diagram illustrating an example of a frame structure for various encoder functions in accordance with an embodiment of the present invention. The buffer spans 560 samples which is about 70 ms. The current frame being encoded 1112 is about 160 samples which is about 20 ms in duration and requires the past data 1110 which is of 10 ms duration, the lookahead for PW gain magnitude and correlation 1114 which is 20 ms in duration, and the lookahead for LP, pitch and VAD 1118 which is also 20 ms in duration.

The new input speech data 1116 corresponds to the latest 20 ms of speech. The LP analysis window corresponds to the latest 40 ms of speech. Each of the pitch estimation windows from window 1 to window 5 1106₁ to 1106₅ respectively, are each 30 ms in duration and slide by about 5 ms from adjacent windows. The VAD window 1102 and the noise reduction window 1104 each correspond to the latest 30 ms of speech.

In accordance with an embodiment of the present invention, the current frame being encoded 1112 uses two lookahead buffers, lookahead for PW gain, magnitude, correlation 1114 and lookahead for LP pitch, VAD 1118.

The bit allocation of the 2.4 Kbps codec 100 among its various parameters in each 20 ms frame is given below in Table 3:

TABLE 3

| | Parameter | #bits/20 ms frame |
|---|---|---|
| 1. | LP parameters - LSFs | 21 |
| 2. | Pitch | 7 |
| 3. | PW gain | 7 |
| 4. | Voicing measure | 5 |
| 5. | PW magnitude | 7 |
| 6. | Voice Activity Flag | 1 |
| | TOTAL | 48 |

The LP parameters are quantized in the line spectral frequency (LSF) domain using a 3 stage vector quantizer (VQ) with a fixed backward prediction of 0.5. Each stage preferably uses 7 bits. The search procedure employs a combination of weighted LSF distance and cepstral distance measures. The PW gain vector parameter is quantized after smoothing and decimation by preferably 2. This quantization process uses a fixed backward predictor of 0.75 on the average quantized DC value of the PW gain. The quantization of the composite vector of PW correlations and voicing measure takes place in the same manner as for the 4.0 Kbps codec using a 5 bit codebook after these parameters have been extracted and smoothed. The PW magnitude is encoded only at the current frame edge for both voiced and unvoiced frames and is preferably modeled by a 7-band mean approximation and quantized using a backward predictive VQ technique substantially similar to the 4.0 Kbps codec. The only difference between the voiced and unvoiced PW magnitude quantization is the fixed backward predictor value, the VQ codebooks, and the DC value. Finally, the voice activity flag is sent to the decoder 100B for all frames. It should be noted that in the DTX mode, this procedure would be redundant.

The synthesis procedures utilized for the codec 100 for 2.4 Kbps FDI codec are substantially similar to those used for the 4.0 Kbps FDI codec. However, the bad frame masking and noise enhancement procedures are altered so as to exploit the quantization techniques employed and the fact that the LP parameters, pitch and VAD flag received in each compressed packet correspond to the next synthesis frame.

The LSF quantization used for codec 100 differs between 2.4 kbps and 4 kbps. For example, the 10 LSF's are quantized using a 3 stage backward predictive VQ. A set of predetermined mean values {λ_{dc}(m),0≦m<9} are used to remove the DC bias in the LSFs prior to quantization. These LSFs are estimated based on the mean removed quantized LSFs of the previous frame:

\tilde{λ}(l1,l2,l3,m)=V_{L1}(l1,m)+V_{L2}(l2,m)+V_{L3}(l3,m)+λ_{dc}(m)+0.5(\hat{λ}ₚᵣₑᵥ(m)−λ_{dc}(m)), 0≦l1,l2,l3,≦127,0≦m≦9. (A 3.1-1)

where, V_{L1}(l1,m),V_{L2}(l2,m),V_{L3}(l3,m) are the 128 level, 10-dimensional codebook for the 3 stages of the multi-stage codebook. A brute force search is not computationally feasible and so an alternative efficient search procedures as outlined in reference 10 is used. The process entails searching the first codebook to provide 8 best candidates. For the second codebook, the 8 best candidates are obtained for each of the preceding 8 solutions of the first codebook. The combined 8×8 solutions are pruned to obtain the best 8. The third codebook is searched similarly to yield 8 final solutions. All these searches are carried out using weighted LSF distance measure. However the selection of the final and optimal solution is carried out by using the cepstral distortion measure for the 8 pruned solutions at the end of the 3^{rd} stage. If l1*,l2*,l3* are the final set of codebook indices obtained at the end of the quantization procedure, the quantized LSF vector is given by:

\hat{λ}(m)=V_{L1}(l1*,m)+V_{L2}(l2*,m)+V_{L3}(l3*,m)+λ_{dc}(m)+0.5(\hat{λ}ₚᵣₑᵥ(m)−λ_{dc}(m)),0≦m≦9. (A 3.1-2)

As in the case for a 4 Kbps codec, the stability of the quantized LSFs is checked by ensuring that the LSFs are monotonically increasing and are separated by a minimum value of 0.005. If this property is not satisfied, stability is enforced by reordering the LSFs in a monotonically increasing order. If a minimum separation is not achieved, the most recent stable quantized LSF vector from a previous frame is substituted for the unstable LSF vector. The 3 7-bit VQ indices {l1*,l2*,l3*) are transmitted to the decoder. Thus the LSFs are encoded preferably using a total of 21 bits.

As in the case of the 4 Kbps codec, the inverse quantized LSFs are interpolated each subframe by linear interpolation between the current LSFs {\hat{λ}(m),0≦m≦10} and the previous LSFs {\hat{λ}ₚᵣₑᵥ(m),0≦m≦10}. The interpolated LSFs at each subframe are converted to LP parameters {\hat{α}ₘ(l),0≦m≦10,1≦l≦8}.

For the 4 Kbps codec, the PW gain sequence is smoothed to eliminate excessive variations across the frame. The smoothing operation is performed in the logarithmic gain domain and is represented by equation 2.3.4-1, i.e.,

$${g}_{pw}^{′} ( m ) = 0.3 {log}_{10} {g}_{pw} ( m - 1 ) + 0.4 {log}_{10} {g}_{pw} ( m ) + 0.3 {log}_{10} {g}_{pw} ( m + 1 ) 1 \leq m \leq 8. \qquad ( A3 .2 \text{-} 1 )$$

For the 2.4 Kbps codec 100, additional smoothing is obtained by taking advantage of the 20 ms look ahead available for the PW parameters. This additional smoothing permits quantization of PW parameters using fewer bits. This smoothing is also performed in the logarithmic domain using a parabolic window centered around each time instant with a span of preferably 8 subframes on either side of the time instant, i.e.,

$${g}_{pw}^{′} ( m ) = \frac{{\sum }_{n = - 8}^{n = 8} w ( \vert n \vert ) {log}_{10} {g}_{pw} ( m + n )}{{\sum }_{n = - 8}^{n = 8} w ( \vert n \vert )} , 1 \leq m \leq 8 \\ w ( n ) = {( 1 - n / 8 )}^{2} , 0 \leq n \leq 8 \qquad ( A3 .2 \text{-} 2 )$$

From here on, the quantization of the PW gain is similar to the quantization for the 4 Kbps codec. First the smoothed gain values are limited to the range 0.0 dB-4.5 dB by the following operations:

$${g}_{pw}^{″} ( m ) = \{ \begin{matrix}MAX ( {g}_{pw}^{′} ( m ) , 0.0 ) \\ MIN ( {g}_{pw}^{′} ( m ) , 4.5 )\end{matrix} 1 \leq m \leq 8. \qquad \text{(A 3.2-3)}$$

The smoothed gains are decimated preferably by a factor of 2, requiring that only the even indexed values, i.e.,

$$\{ {g}_{pw}^{″} ( 2 ) , {g}_{pw}^{″} ( 4 ) , {g}_{pw}^{″} ( 6 ) , {g}_{pw}^{″} ( 8 ) \} ,$$

are quantized. The quantization is carried out using a 128 level, 4 dimensional predictive quantizer whose design and search procedure is identical except for the VQ size to that used in the 4 Kbps codec. The 7-bit index of the optimal code vector l*_{g} is transmitted to the decoder 100B as the PW gain index.

At the decoder 100B, the even indexed PW gain values are obtained by inverse quantization of the PW gain index. The odd indexed values are then obtained by linearly interpolating between the inverse quantized even indexed values.

For the 2.4 Kbps codec, the PW subband correlation vector and voicing measure are computed for a 20 ms window centred around the current frame edge. This is in contrast to the 4 Kbps codec for which this window coincides with the current encoded frame itself. This is done to take advantage of the additional 20 ms look ahead for encoding the PW parameters.

The PW correlation values at each harmonic frequency is now given by:

$${r}_{pw} ( k ) = \frac{{\sum }_{m = 5}^{12} Re [ {P}_{m} ( k ) ] Re [ {P}_{m - 1} ( k ) ]}{{Re [ {P}_{m} ( k ) ]}^{2}} 0 \leq k \leq {K}_{max} . \qquad \text{(A 3.2-1)}$$

The subband correlation vector { (l),1≦l≦5} is computed, as in the 4 Kbps, by averaging the correlation vector components within each of the subbands:

$$( l ) = \frac{1}{η ( l ) - η ( l - 1 )} {\sum }_{k = η ( l - 1 )}^{η ( l ) - 1} {r}_{pw} ( k ) 1 \leq l \leq 5 \qquad \text{(A 3.2-2)}$$

The voicing measure at the current frame edge is smoothed by first computing the voicing measure for the current frame v_{curr} and the voicing measure of the PW parameter look ahead frame v_{lookahead} separately and then combining them as follows:

$$\begin{matrix}v = {v}_{lookahead} & , {E}_{sig}^{curr} \leq 0.01 {E}_{sig}^{lookahead} \\ = 0.75 {v}_{lookahead} + 0.25 {v}_{curr} & , {E}_{sig}^{curr} \leq 0.1 {E}_{sig}^{lookahead} \\ = 0.25 {v}_{lookahead} + 0.75 {v}_{curr} & , {E}_{sig}^{curr} \geq 10 {E}_{sig}^{lookahead} \\ = {v}_{curr} & , {E}_{sig}^{curr} \geq 100 {E}_{sig}^{lookahead} \\ = 0.5 {v}_{lookahead} + 0.5 {v}_{curr} & , else \end{matrix} \qquad \text{(A 3.2-3)}$$

Here,

$${E}_{sig}^{lookahead} and {E}_{sig}^{curr}$$

are the logarithmic average energy per sample in the look ahead frame and current frame respectively. Their computations are identical to Equation 2.3.5-16.

From this point on, the quantization and search procedure and inverse quantization of the composite subband correlation vector and voicing measure is identical to that used in the 4 Kbps codec. Even the size of the quantization VQ codebook is the same, i.e., number of bits used to encode is 5.

The PW magnitude vectors are encoded only at subframe 8 for the 2.4 Kbps codec. In order to encode it efficiently with few bits, the weighted PW subband mean for each of the subframes both in the current 20 ms frame as well as in the look ahead 20 ms frame are computed as follows:

$${\overline{P}}_{m}^{′} ( i ) = \sqrt{\frac{{\sum }_{k = {κ}_{m} ( i )}^{k = {κ}_{m} ( i + 1 ) - 1} {W}_{m} ( k ) {\vert {P}_{m} ( k ) \vert}^{2}}{{\sum }_{k = {κ}_{m} ( i )}^{k = {κ}_{m} ( i + 1 ) - 1} {W}_{m} ( k )}} , 0 \leq i \leq 6 , 1 \leq m \leq 16. \qquad \text{(A 3.3-1)}$$

Here, the spectral weights Wₘ(k) are computed by first computing them according to equation 2.3.7-5 for subframe 16. For all intermediate subframes from m=9 to 16, the spectral weights Wₘ(k) are computed by interpolation between W₈(k) and W₁₆(k). Note that the spectral weights Wₘ(k) for m=1 to 8 were already computed in the previous 20 ms frame.

The weighted subband mean approximation is smoothed using a parabolic window centered around the edge of the current frame, i.e.,

$${\overline{P}}_{m}^{′} ( i ) = \sqrt{\frac{{\sum }_{n = - 8}^{n = 8} w ( \vert n \vert ) {\overline{P}}_{m + n}^{′} ( i )}{{\sum }_{n = - 8}^{n = 8} w ( \vert n \vert )}} , 0 \leq i \leq 6 , m = 8 \\ w ( n ) = {( 1 - n / 8 )}^{2} , 0 \leq n \leq 8 \qquad \text{(A 3.3-2)}$$

Once the smoothed weighted subband mean approximation is computed, its quantization is carried out in exactly the same way using a backward predictive VQ as in the 4 Kbps codec for the PW subband mean. Preferably a 7 bit VQ is used for this purpose for both unvoiced and voiced modes. The difference between the two modes is the use of different predictor coefficients and different VQ codebooks.

Unlike the 4 Kbps, the PW harmonic deviations from the fullband reconstruction of the quantized PW mean vector is not encoded. So, at the decoder this fullband reconstruction of the quantized PW mean vector is taken to be the PW magnitude spectra at the current frame edge. For all other subframes, the PW mean vector is obtained by interpolation of the PW mean vectors at the edge of the current frame and the previous frame.

All aspects of the decoder 100B are substantially similar to that used in the 4 Kbps codec except in the manner of decoding the LSF parameters and the VAD flag.

For a normal good frame, the LSFs are reconstructed from the received VQ indices l1*,l2*,l3* as follows:

\hat{λ}(m)=V_{L1}(l1*,m)+V_{L2}(l2*,m)+V_{L3}(l3*,m)+λ_{dc}(m)+0.5(\hat{λ}ₚᵣₑᵥ(m)−λ_{dc}(m)),0≦m≦9. (A3.3-1)

In the case of a bad frame, the previous set of quantized LSFs are repeated. For the first good frame following one or more bad frames, a bad frame recovery procedure similar to what was used in U.S. Pat. No. 6,418,408 section 9.13.2 which is incorporated by reference in its entirety is employed.

In the case of 2.4 Kbps, the received VAD contains information about the activity of the look ahead frame for LP, pitch, and VAD windows. This information is available for both voiced and unvoiced modes. Denoting the received VAD flag by RVAD_FLAG and its previous values by RVAD_FLAG_DL1, RVAD_FLAG_DL2, RVAD_FLAG_DL3 respectively, the procedure for determining the composite VAD value RVAD_FLAG_FINAL is given by the following Table 4:

TABLE 4

| RVAD_FLAG | RVAD_FLAG_DL3 | RVAD_FLAG_DL2 | RVAD_FLAG_DL1 | RVAD_FLAG_FINAL |
|---|---|---|---|---|
| x | 0 | 0 | 0 | 0 |
| 0 | 0 | 0 | 1 | 0 |
| 1 | 0 | 0 | 1 | 1 |
| 0 | 0 | 1 | 0 | 0 |
| 1 | 0 | 1 | 0 | 2 |
| x | 0 | 1 | 1 | 2 |
| x | 1 | 0 | 0 | 1 |
| 0 | 1 | 0 | 1 | 2 |
| 1 | 1 | 0 | 1 | 3 |
| 0 | 1 | 1 | 0 | 2 |
| 1 | 1 | 1 | 0 | 3 |
| x | 1 | 1 | 1 | 3 |

The composite VAD value is now used in the same way as in the 4 Kbps codec for noise enhancement.

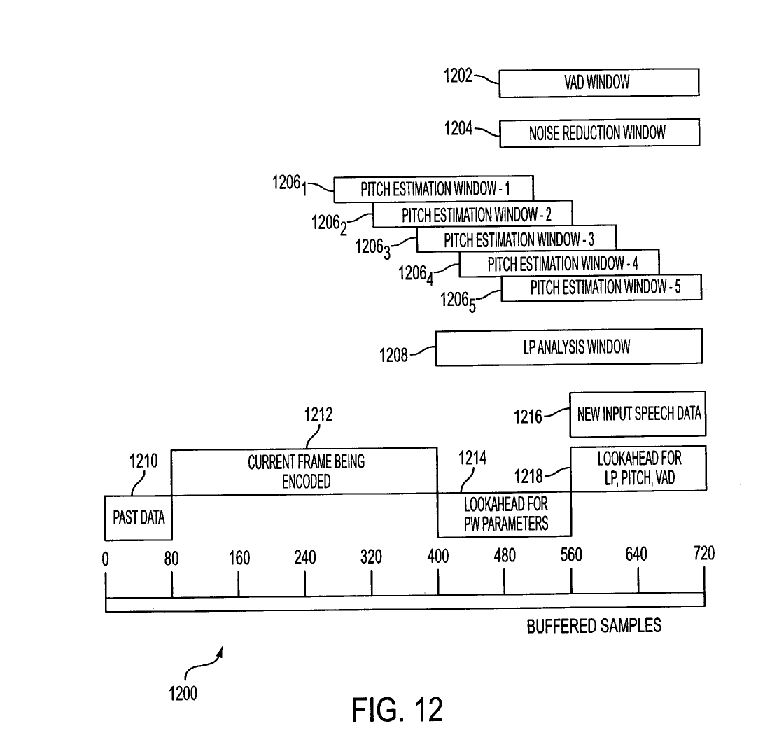

In the 1.2 Kbps codec, the same design is employed as in the 2.4 Kbps codec except that the frame size employed is 40 ms. FIG. 12 illustrates the relationship between the various windows used for extracting LP, pitch, VAD, and PW parameters. The allocation of the bits among the various parameters in every 40 ms frame is given below in Table 5.

TABLE 5

| | Parameter | #bits/40 ms frame |
|---|---|---|
| 1. | LP parameters - LSFs | 21 |
| 2. | Pitch | 7 |
| 3. | PW gain | 7 |
| 4. | Voicing measure & PW correlations | 5 |
| 5. | PW magnitude | 7 |
| 6. | Voice Activity Flag | 1 |
| | TOTAL | 48 |

FIG. 12 is a diagram illustrating another example of a frame structure for various encoder functions in accordance with an embodiment of the present invention. A key difference between the frame structure 1100 and frame structure 1200 is that in the case of the latter, the buffer has 720 samples which are about 90 ms in duration. Also, the current frame being encoded 1212 is 40 ms in duration. The past data 1210 is about 10 ms. The lookahead for PW parameters 1214, and the lookahead for LP, pitch, VAD 1218 are both 20 ms. The new input speech data 1216 corresponds to the latest 20 ms of speech. LP analysis window 1208, pitch estimation windows 1206₁ to 1206₅, noise reduction window 1204, VAD window 1202 are similar in duration is corresponds to their counterparts in frame structure 1100.

The linear prediction (LP) parameters are derived, bandwidth broadened and quantized every 40 ms. The LP analysis window 1208 is centered at 20 ms ahead of the current 40 ms frame edge. The quantization is identical to that used in 2.4 Kbps except that the backward prediction is based on the quantized LSFs obtained 40 ms ago. The open loop pitch is extracted in the same way as in the 2.4 and 4.0 Kbps FDI codec. However, it is sent only once every 40 ms and the transmitted pitch value corresponds to 20 ms ahead of the current 40 ms frame edge. The open loop pitch contour is obtained by interpolating between the transmitted pitch values every 40 ms. The VAD flag is also extracted every 20 ms in exactly the same way as in the 2.4 and 4.0 Kbps codecs. But, just like the open loop pitch parameter, the VAD flag is transmitted only every 40 ms. The transmitted VAD flag is obtained by combining the VAD flags corresponding to the VAD windows centered at 5 ms and 25 ms from the current 40 ms frame edge. The received VAD flag is treated as if it came from a single VAD window centered at 15 ms from the current frame edge.

The prototype waveform (PW) parameters such as gain, correlation, voicing measure and spectral magnitude are extracted for the current 40 ms frame in a manner similar to that used in the 2.4 Kbps codec. Again, the extra delay of 20 ms helps to smooth the PW parameters thereby enabling them to be coded with fewer bits.

For the PW gain, the smoothing is done using a parabolic window centred around the time of interest with a span of 20 ms on either side just as in the 2.4 Kbps codec. The smoothed PW gains are preferably decimated by a factor of 4 so that only PW gains every 10 ms are retained. They are then quantized using a 4-dimensional backward predictive 7-bit VQ similar to what is used in the 2.4 and 4.0 Kbps codecs. At the decoder, the PW gains at multiples of 10 ms are obtained by inverse quantization. The intermediate PW gains are subsequently obtained by interpolation.

For the PW correlations, that are calculated only at the current 40 ms frame edge, the smoothing is done using an asymmetric parabolic window centred around the frame edge. This window spans the entire 40 ms frame on one side and 20 ms of PW parameter look ahead frame on the other side. The smoothing procedure for the voicing measure is different. Here, the voicing measures for the second 20 ms portion of the current 40 ms frame and the 20 ms PW look ahead frame are computed independently. These are then combined as in the 2.4 Kbps codec to form an average voicing measure centered at the current 40 ms frame edge. The quantization and search procedure of the composite PW subband correlation vector and voicing measure using a 5 bit codebook is identical to the 2.4 and 4.0 Kbps codecs.

The PW spectral magnitude is encoded only at the current 40 ms frame edge for both voiced and unvoiced frames and is modeled by a 7-band smoothed mean approximation and quantized using a backward predictive VQ technique just as in the 4.0 Kbps codec. The only difference between the voiced and unvoiced PW magnitude quantization is the fixed backward predictor value, the VQ codebooks, and the DC value. The smoothing of the PW subband mean approximation at the frame edge is identical to what is used in the 2.4 Kbps codec.

The synthesis procedures utilized in the 1.2 Kbps codec is identical to the 2.4 Kbps FDI codec except in the decoding of the VAD flag since it is received once every 40 ms. The received VAD flag denotes the VAD activity around a window centered at 15 ms beyond the current 40 ms frame edge. This information is available for both voiced and unvoiced modes. Denoting the received VAD flag by RVAD_FLAG and its previous values by RVAD_FLAG_DL1, RVAD_FLAG_DL2 respectively, the procedure for determining the composite VAD value RVAD_FLAG_FINAL is given by the following Table 6:

TABLE 6

| RVAD_FLAG | RVAD_FLAG_DL2 | RVAD_FLAG_DL1 | RVAD_FLAG_FINAL |
|---|---|---|---|
| 0 | 0 | 0 | 0 |
| 0 | 0 | 1 | 1 |
| 0 | 1 | 0 | 0 |
| 0 | 1 | 1 | 2 |
| 1 | 0 | 0 | 1 |
| 1 | 0 | 1 | 3 |
| 1 | 1 | 0 | 2 |
| 1 | 1 | 1 | 3 |

The composite VAD value is now used in the same way as in the 2.4 and 4 Kbps code for noise enhancement.

Those skilled in the art can now appreciate from the foregoing description the the broad teachings of the present invention can be implemented in a variety of forms. Therefore, while this invention has been described in connection with particulars examples thereof, the true scope of the invention should not be so limited since other modifications will become apparent to the skilled practitioner upon a study of the drawings, specification and the following claims.

What is claimed is:

1. A coding system for a coder/decoder (codec) for providing adaptive bandwidth broadening to an encoder, comprising:
a linear prediction (LP) front end, adapted to process an input signal which provides LP parameters that are computed during a predetermined interval;
an open loop pitch estimator, adapted to perform pitch frequency estimation on said input signal for substantially all of said predetermined intervals;
an adaptive bandwidth broadening module, adapted to perform the following operations:
derive a spectrum sampling frequency for said predetermined interval as the pitch frequency or its integer submultiple depending on the pitch frequency;
determine a LP power spectrum at the harmonics of said spectrum sampling frequency for said input signal for said frame;
compute a peak to average ratio of said LP spectrum based on said spectrum sampling frequency of said frame; and
adaptively bandwidth broaden said LP filter coefficients based on said peak to average ratio of said LP spectrum for all harmonic multiples of said spectral sampling frequency.

2. A system as recited in claim 1, wherein said predetermined interval is preferably 20 ms in duration.

3. A system as recited in claim 1, wherein said codec comprises a frequency domain interpolative (FDI) codec.

4. A system as recited in claim 1, wherein said harmonic multiples of the spectrum sampling frequency are within 0 to 4 kHz.

5. A coding system for a codec, comprising:
A linear prediction front end adapted to process an input signal to provide LP parameters which are quantized and encoded over predetermined intervals and are used to compute a LP residual signal;
an open loop pitch estimator adapted to process the LP residual signal, pitch information, pitch interpolation information and provide a pitch contour within the predetermined intervals;
a prototype waveform extraction module, which is adapted in response to the LP residual signal and the pitch contour to extract a prototype waveform (PW) for a number of equal subintervals within the predetermined intervals and to extract an additional approximate PW in the subinterval immediately after the ending of a previous subinterval;
a PW gain computation module, adapted to compute a PW gain for substantially all the subintervals; and
a gain vector predictive vector quantization (VQ) module, adapted to quantize and encode the PW gains for substantially all the subintervals after they are filtered by a weighted window, decimated, and after subtracting from them a predicted average PW gain value for a current predetermined interval computed from the quantized PW gain values of a preceding predetermined interval.

6. A system as recited in claim 5, wherein said predetermined interval is preferably 20 ms in duration.

7. A system as recited in claim 5, wherein said weighted window comprises a 3 point window.

8. A system as recited in claim 5, wherein said decimation comprises a 2:1 decimation.

9. A system as recited in claim 5, wherein said gain vector predictive VQ module is further adapted to perform predictive vector quantization of the decimated and smoothed PW gains based on the predicted average PW gain estimate and a codebook indicating corrections to the estimated PW gains.

10. A system as recited in claim 5, further comprising:
a gain decoder interpolation module, adapted to decay the average PW gain value for the preceding predetermined interval in order to mitigate the effect of transmission errors on the PW gain parameter.

11. A frequency domain interpolative (FDI) coder/decoder (codec), comprising:
a PW normalization and alignment module, adapted to compute a sequence of aligned prototype waveform (PW) vectors for a frame via a low complexity alignment process; and
a PW subband correlation computation module, adapted to compute a PW correlation vector for all harmonics for the frame and average the PW correlation vector across the harmonics in five subbands in order to derive a PW subband correlation vector.

12. A system as recited in claim 11, further comprising:
a voicing measure computation module, adapted to provide a voicing measure that characterizes a degree of voicing.

13. A system as recited in claim 12, wherein said voicing measure is derived from input factors that are correlated to a degree of periodicity for the frame.

14. A system as recited in claim 11, wherein said PW correlation vector comprises the average correlation between successive PW vectors as a function of frequency.

15. A system as recited in claim 11, wherein said PW subband correlation vector comprises a degree of stationarity of successive pitch cycles of an input signal.

16. A system as recited in claim 12 further comprising:
a PW correlation and vector measure vector quantization (VQ) module, adapted to encode a composite vector derived from said PW subband correlation vector and the voicing measure based on spectrally weighted vector quantization.

17. A system as recited in claim 11, further comprising:
an autoregressive module, adapted to reconstruct a PW phase at the decoder substantially every sub-frame using the received voicing measure, PW subband correlation vector and pitch frequency contour information.

18. A system as recited in claim 17, wherein said autoregressive module is further adapted to compute a value for the input signal via a weighted combination of a first complex vector and a second complex vector.

19. A system as recited in claim 18, wherein said first complex vector is derived from a random phase vector and said second complex vector is derived from a fixed phasevector.

20. A system as recited in claim 19, wherein said second complex vector is obtained by oversampling a phase spectrum of a voiced pitch pulse.

21. A frequency domain interpolative (FDI) coder/decoder (codec), comprising:
a PW magnitude quantizer, adapted to perform the following:
directly quantize a prototype waveform (PW) in a magnitude domain for substantially every frame without said PW being decomposed into complex components;
hierarchically quantize a PW magnitude vector based on a voicing classification using a mean-deviations representation;
adaptively vector quantize the mean component of the representation in multiple subbands;
derive a variable dimension deviations vector as the difference of the input PW magnitude vector and the full band representation of the quantized PW subband mean vector for all harmonics;
select a fixed dimensional deviations subvector from the said variable dimensional deviations vector based on location of speech formant frequencies for a subframe; and
provide the said fixed dimensional deviations subvector for adaptive vector quantization.

22. A coding system for a coder/decoder (codec), comprising:
a linear prediction (LP) front end, adapted to process an input signal which provides LP parameters that are computed during a predetermined interval;
an open loop pitch estimator, adapted to perform pitch estimation on said input signal for substantially all of said predetermined intervals;
a voice activity detection module, that uses the LP parameters and pitch information;
a voicing measure computation module, adapted to provide a voicing measure that characterizes a degree of voicing and is derived from a plurality of input parameters that are correlated to the degree of periodicity of the input signal for substantially all predetermined intervals;
a prototype waveform (PW) subband correlation computation module, adapted to provide a PW subband correlation vector, said PW subband correlation vector characterizing a degree of correlation between successive PW vectors as a function of frequency and computed for substantially all predetermined intervals;
an adaptive bandwidth broadening module, adapted to reduce annoying artifacts due to spurious spectral peaks by performing the following:
compute a measure of VAD likelihood based on voice activity detection (VAD) flags for a preceding, a current and a next predetermined interval; and
compute average PW gain values for inactive predetermined intervals and active unvoiced predetermined intervals.

23. A system as recited in claim 22 wherein said adaptive bandwidth broadening module is further adapted to perform the following:
compute a parameter α_{fatt} to determine the degree of bandwidth broadening necessary for the interpolated LP synthesis filter coefficients using a VAD likelihood measure, PW gain averages and the PW subband correlation quantization index.

24. A system as recited in claim 22 wherein said adaptive bandwidth broadening module is further adapted to attenuate out-of-band components of a reconstructed PW vector by performing the perform the following:
compute a first corner frequency for a low frequency based on a pitch frequency;
compute a second corner frequency at a high frequency based on the pitch frequency and α_{fatt}; and
determine a rate of attenuation of high frequency components as a square law function, based on α_{fatt}.

25. A system as recited in claim 22, wherein said predetermined interval is preferably 20 ms in duration.

26. A system as recited in claim 22, wherein said predetermined interval comprises a frame.

27. A low bit rate coding system for a coder/decoder (codec), comprising:
a linear prediction (LP) front end, adapted to process an input signal which provides LP parameters that are computed during a predetermined interval;
an open loop pitch estimator, adapted to perform pitch estimation on said input signal for substantially all of said predetermined intervals;
a voice activity detection module, adapted to process and provide the LP parameters and pitch information to the decoder;
a prototype waveform (PW) encoder, adapted to provide a look ahead based on said predetermined interval in order to smooth PW parameters; and
a voicing measure computation module, adapted to provide a voicing measure, said voicing measure characterizing a degree of voicing derived from a plurality of input parameters that are correlated to the degree of periodicity of the input signal for substantially all predetermined intervals.

28. A system as recited in claim 27 wherein said PW parameters comprise at least one of gain, a voicing measure, subband correlations and spectral magnitude.

29. A system as recited in claim 27 further comprising:
a prototype waveform (PW) subband correlation computation module, adapted to provide a PW subband correlation vector, said PW subband correlation vector characterizing a degree of correlation between successive PW vectors as a function of frequency and computed for substantially all predetermined intervals to obtain PW vectors for a current predetermined interval and a look ahead predetermined interval.

30. A system as recited in claim 27 further comprising:
A PW gain computation module, adapted to compute a PW gain for substainally all sub-predetermined intervals including a current predetermined interval and a look ahead predetermined interval.

31. A system as recited in claim 27 further comprising:
a voicing measure smoothing module, adapted to smooth a voicing measure by combining a voicing measure associated with a current predetermined interval and a look ahead predetermined interval.

32. A system as recited in claim 27 further comprising:
a PW gain smoothing module, adapted to provide PW gain smoothing via a parabolic symmetric window for each predetermined interval and a 2:1 decimation, quantization and transmission to the decoder, said parabolic symmetric window is centered at a edge of the predetermined interval; and
a PW magnitude smoothing module, adapted to represent a PW spectral magnitude at a frame edge via a smoothed PW subband mean approximation.

33. A system as recited in claim 32 further comprising:
a PW magnitude quantization module, adapted to quantize and provide a smoothed PW subband mean approximation to the decoder.

34. A system as recited in claim 27 further comprising:
an adaptive bandwidth broadening module, adapted to reduce annoying artifacts due to spurious spectral peaks by performing the following:
compute a measure of VAD likelihood based on voice activity detection (VAD) flags for a preceding, a current and a next two predetermined intervals; and
compute average PW gain values for inactive predetermined intervals and active unvoiced predetermined intervals.

35. A system as recited in claim 27, wherein said codec operates at 2.4 kbps.

36. A low bit rate coding system for a coder/decoder (codec), comprising:
a linear prediction (LP) front end, adapted to process an input signal which provides LP parameters that are estimated, quantized and transmitted for substantially all frames of a first duration;
an open loop pitch estimator, adapted to perform pitch estimation on said input signal for substantially all of said frames of a first duration and quantize and transmit pitch information for substantially all frames of a second duration;
a voice activity detection module, adapted to combine voice activity detection (VAD) flags associated with two successive frames of a first duration based on processing the LP parameters and the pitch information every frame of a first duration and transmitting the VAD flags to the decoder substantially every frame of a second duration; and
a prototype waveform (PW) encoder, adapted to provide a look ahead frame based on said frame of a first duration in order to smooth PW parameters including at least one of PW gain, a voicing measure, subband correlations and spectral magnitude.

37. A system as recited in claim 36, wherein said codec operates at 1.2 kbps.

38. A system as recited in claim 36, wherein said frames of a first duration comprise 20 ms each, and frames of a second duration comprise 40 ms each.

39. A system as recited in claim 36 further comprising:
a voicing measure computation module, adapted to provide a voicing measure, said voicing measure characterizing a degree of voicing derived from a plurality of input parameters that are correlated to the degree of periodicity of the input signal for substantially all the frames of a first duration.

40. A system as recited in claim 36 further comprising:
a voicing measure smoothing module, adapted to combine a voicing measure associated with a second half of a current frame of a second duration and a voicing measure associated with a look ahead frame of a first duration based on their respective energies in order to smooth the voicing measures;
a prototype waveform (PW) subband correlation computation module, adapted to provide a PW subband correlation vector, said PW subband correlation vector characterizing a degree of correlation between successive PW vectors as a function of frequency and computed for a current frame of a first duration in order to provide PW vectors for a current frame of a second duration and a look ahead frame of a first duration;
a PW gain computation module, adapted to compute a PW gain for substainally all subframes for both the current frame of a second duration and the look ahead frame of a first duration; and
said prototype waveform (PW) subband correlation computation module being further adapted to quantize and transmit a composite PW subband correlation vector and voicing measure to the decoder;

41. A system as recited in claim 36 further comprising:
a PW gain smoothing module, adapted to provide PW gain smoothing via a parabolic symmetricwindow for each instant of time followed by a 4:1 decimation, quantization and transmission to the decoder for substantially all the frames of a second duration, said parabolic symmetric window is centered at a edge of the frame of a second duration; and
a PW magnitude smoothing module, adapted to represent a PW spectral magnitude at the frame edge of a second duration via a smoothed PW subband mean approximation.

42. A system as recited in claim 36 further comprising:
a PW magnitude quantization module, adapted to quantize and provide a smoothed PW subband mean approximation to the decoder.

43. A system as recited in claim 36 further comprising:
an adaptive bandwidth broadening module at the decoder, adapted to reduce annoying artifacts due to spurious spectral peaks in inactive noise frames by performing the following:
compute a measure of VAD likelihood based on the VAD flags for a preceding, a current and a next frame of a second duration; and
compute average PW gain values for the inactive noise frames and active unvoiced voice frames.

44. A method for providing adaptive bandwidth broadening to an encoder of a coder/decoder (codec), comprising:
processing an input signal which provides LP parameters that are computed during a predetermined interval;
performing pitch frequency estimation on said input signal for substantially all of said predetermined intervals;
deriving a spectrum sampling frequency for said predetermined interval as the pitch frequency or its integer submultiple depending on the pitch frequency;
determining a LP power spectrum at the harmonics of said spectrum sampling frequency for said input signal for said frame;
computing a peak to average ratio of said LP spectrum based on said spectrum sampling frequency of said frame; and
adaptively bandwidth broadening said LP filter coefficients based on said peak to average ratio of said LP spectrum for all harmonic multiples of said spectral sampling frequency.

45. A method of providing a coding system for a codec, comprising:
processing an input signal to provide LP parameters which are quantized and encoded over predetermined intervals and are used to compute a LP residual signal;
processing the LP residual signal, pitch information, pitch interpolation information and providing a pitch contour within the predetermined intervals;
extracting a prototype waveform (PW) for a number of equal subintervals within the predetermined intervals and extracting an additional approximate PW in the subinterval immediately after the ending of a previous subinterval in response to the LP residual signal and the pitch contour;
computing a PW gain for substantially all the subintervals; and
quantizing and encoding the PW gains for substantially all the subintervals after the subintervals are filtered by a weighted window, decimated, and subtracted from a predicted average PW gain value for a current predetermined interval which is computed from the quantized PW gain values of a preceding predetermined interval.

46. A method of providing a coding system for a coder/decoder (codec), comprising:
computing a sequence of aligned prototype waveform (PW) vectors for a frame via a low complexity alignment process; and
computing a PW correlation vector for all harmonics for the frame and averaging the PW correlation vector across the harmonics in five subbands in order to derive a PW subband correlation vector.

47. A method of providing a coding system for a frequency domain interpolative (FDI) coder/decoder (codec), comprising:
directly quantizing a prototype waveform (PW) in a magnitude domain for substantially every frame without said PW being decomposed into complex components;
hierarchically quantizing a PW magnitude vector based on a voicing classification using a mean-deviations representation;
adaptively vector quantizing the mean component of the representation in multiple subbands;
deriving a variable dimension deviations vector as the difference of the input PW magnitude vector and the full band representation of the quantized PW subband mean vector for all harmonics;
selecting a fixed dimensional deviations subvector from the said variable dimensional deviations vector based on a location of speech formant frequencies for a subframe; and
providing the said fixed dimensional deviations subvector for adaptive vector quantization.

48. A method of providing a coding system for a coder/decoder (codec), comprising:
processing an input signal which provides LP parameters that are computed during a predetermined interval;
performing a pitch estimation on said input signal for substantially all of said predetermined intervals;
processing the LP parameters and pitch information;
providing a voicing measure that characterizes a degree of voicing and is derived from a plurality of input parameters that are correlated to the degree of periodicity of the input signal for substantially all predetermined intervals;
providing a PW subband correlation vector, said PW subband correlation vector characterizing a degree of correlation between successive PW vectors as a function of frequency and computed for substantially all predetermined intervals;
reducing annoying artifacts due to spurious spectral peaks by performing the following:
computing a measure of VAD likelihood based on voice activity detection (VAD) flags for a preceding, a current and a next predetermined interval; and
computing average PW gain values for inactive predetermined intervals and active unvoiced predetermined intervals.

49. A method of providing a low bit rate coding system for a coder/decoder (codec), comprising:
processing an input signal which provides LP parameters that are computed during a predetermined interval;
performing pitch estimation on said input signal for substantially all of said predetermined intervals;
processing the LP parameters and pitch information to the decoder;
providing a look ahead based on said predetermined interval in order to smooth PW parameters; and
providing a voicing measure, said voicing measure characterizing a degree of voicing derived from a plurality of input parameters that are correlated to the degree of periodicity of the input signal for substantially all predetermined intervals.

50. A method of providing a low bit rate coding system for a coder/decoder (codec), comprising:
processing an input signal which provides LP parameters that are estimated, quantized and transmitted for substantially all frames of a first duration;
performing a pitch estimation on said input signal for substantially all of said frames of a first duration and quantizing and transmiting pitch information for substantially all frames of a second duration;
combining voice activity detection (VAD) flags associated with two successive frames of a first duration;
processing the LP parameters and the pitch information every frame of a first duration and transmitting the VAD flags to the decoder substantially every frame of a second duration; and
providing a look ahead frame based on said frame of a first duration in order to smooth PW parameters including at least one of PW gain, a voicing measure, subband correlations and a spectral magnitude.
